(19) United States
(12) Patent Application Publication
(10) Pub. No.: US 2025/0171038 A1
(43) Pub. Date: May 29, 2025

(54) VEHICULAR CONTROL METHOD AND APPARATUS

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Shoya ISHIDA, Nisshin-city (JP); Ge YU, Nisshin-city (JP); Shinichi HIRAOKA, Kariya-city (JP)

(21) Appl. No.: 18/959,123

(22) Filed: Nov. 25, 2024

(30) Foreign Application Priority Data
Nov. 27, 2023 (JP) 2023-199987

(51) Int. Cl. B60W 50/035; B60W 30/095; B60W 50/02; B60W 60/00

(52) U.S. Cl. CPC B60W 50/035; B60W 30/0953; B60W 50/0205; B60W 60/0015; B60W 2552/05

(57) ABSTRACT

In an apparatus, a recognizing unit recognizes at least one road marking line and at least a closer edge of a road located around an own vehicle. A detecting unit detects, based on the at least one road marking line and the closer edge of the road, an evacuation space at a location of the road where the own vehicle is parkable in an extending direction of the road. A first determining unit determines whether a detection result of the evacuation space is reliable. A second determining unit determines whether to perform limp-home control that causes the own vehicle to travel from a current location of the own vehicle to the evacuation space in response to determination of whether the detection result of the evacuation space is reliable.

### CROSS REFERENCE TO RELATED APPLICATION

This application is based on and claims the benefit of priority from Japanese Patent Application No. 2023-199987 filed on Nov. 27, 2023, the disclosure of which is incorporated in its entirety herein by reference.

### TECHNICAL FIELD

The present disclosure relates to vehicular control methods and apparatuses.

### BACKGROUND

Research and development for drive assist technologies and/or autonomous driving technologies has been proceeding actively. Various types of proposals related to the drive assist technologies and/or autonomous driving technologies have been carried out, one of which is disclosed in International Patent Publication WO 2019/202397. Drive assist technologies aim to reduce driver's load to enable drivers to drive vehicles comfortably and safely. These drive assist technologies include, for example, technologies related to following distance control, lane keeping assist control, lane-change assist control, parking assist control, obstacle warning, collision-avoidance assist control, or other vehicle-control technologies. These autonomous driving technologies aim to cause vehicles to automatically, i.e., autonomously, travel without the need of driver's driving operations. Various sensing devices, such as cameras and/or radar devices, are installed in a vehicle with such drive assist technologies and/or drive assist technologies. The various sensing devices are configured to detect surrounding situations around the vehicle. Autonomous control operations, such as autonomous steering, autonomous driving, and/or autonomous braking, of a traveling autonomous vehicle are carried out based on, for example, the surrounding situations detected by the sensing devices and/or map information indicative of a visual representation of a region around the current location of the autonomous vehicle. In particular, the autonomous control operations of a traveling autonomous vehicle can be carried out using high-accuracy map information including road data of each lane around the autonomous vehicle, making it possible to improve the safety and reliability of the autonomous control operations of the traveling autonomous vehicle.

### SUMMARY

Research and development for these autonomous driving technologies and drive assist technologies has been accelerating recently in view of accuracy improvement of object detection and/or object recognition by sensing devices and improvement of user's convenience. That is, a further improvement of these autonomous driving technologies and drive assist technologies enables the earlier and wider spread of advanced driving assistance vehicles and/or autonomous driving vehicles.

In view of the above circumstances, the present disclosure provides an apparatus for controlling an own vehicle traveling on a road. The apparatus includes a recognizing unit configured to recognize at least one road marking line and at least a closer edge of the road located around the own vehicle. The closer edge of the road is one of edges of the road being closer to the own vehicle than the other of the edges of the road is. The apparatus includes a detecting unit configured to detect, based on the at least one road marking line and the closer edge of the road, an evacuation space at a location of the road where the own vehicle is parkable in an extending direction of the road. The apparatus includes a first determining unit configured to determine whether a detection result of the evacuation space is reliable. The apparatus includes a second determining unit configured to determine whether to perform limp-home control that causes the own vehicle to travel from a current location of the own vehicle to the evacuation space in response to determination of whether the detection result of the evacuation space is reliable.

The present disclosure provides a method of controlling an own vehicle traveling on a road. The method includes:
(i) recognizing at least one road marking line and at least a closer edge of the road located around the own vehicle, the closer edge of the road being one of edges of the road being closer to the own vehicle than the other of the edges of the road is;
(ii) detecting, based on the at least one road marking line and the closer edge of the road, an evacuation space at a location of the road where the own vehicle is parkable in an extending direction of the road;
(iii) determining whether a detection result of the evacuation space is reliable; and
(iv) determining whether to perform limp-home control that causes the own vehicle to travel from a current location of the own vehicle to the evacuation space in response to determination of whether the detection result of the evacuation space is reliable.

The present disclosure provides a processor program product including a non-transitory storage medium readable by a processor for controlling a vehicle traveling on a road, and control program instructions stored in the non-transitory storage medium.

The control program instructions cause the processor to:
(i) recognize at least one road marking line and at least a closer edge of the road located around the own vehicle, the closer edge of the road being one of edges of the road being closer to the own vehicle than the other of the edges of the road is;
(ii) detect, based on the at least one road marking line and the closer edge of the road, an evacuation space at a location of the road where the own vehicle is parkable in an extending direction of the road;
(iii) determine whether a detection result of the evacuation space is reliable; and
(iv) determine whether to perform limp-home control that causes the own vehicle to travel from a current location of the own vehicle to the evacuation space in response to determination of whether the detection result of the evacuation space is reliable.

Note that each parenthesized reference character assigned to a corresponding element in the present disclosure merely represents an example of a relationship between the corresponding element and a corresponding specific element described in an exemplary embodiment described later, and therefore the present disclosure is not limited to the parenthesized reference characters.

### BRIEF DESCRIPTION OF THE DRAWINGS

Other aspects of the present disclosure will become apparent from the following description of embodiments with reference to the accompanying drawings in which:

FIG. 1 is a plan view schematically illustrating a vehicle in which a vehicular system including a driving ECU serving as a control apparatus according to an exemplary embodiment;

FIG. 2 is a schematic block diagram illustrating an overall structure of the vehicular system illustrated in FIG. 1;

FIG. 3 is a plan view schematically illustrating target-object detection using one of sonar sensors illustrated in FIG. 2;

FIG. 4 is a plan view schematically illustrating target-object detection using a pair of sonar sensors illustrated in FIG. 2;

FIG. 5 is a plan view schematically illustrating target-object detection using each sonar sensor illustrated in FIG. 2;

FIG. 6 is a plan view schematically illustrating parking-space detection using a first sonar sensor illustrated in FIG. 2;

FIG. 7 is a plan view schematically illustrating target-object detection using a radar sensor illustrated in FIG. 2;

FIG. 8 is a plan view schematically illustrating target-object detection using a laser-radar sensor illustrated in FIG. 2;

FIG. 9 is perspective view schematically illustrating a configuration and operations of the laser-radar sensor illustrated in FIG. 8;

FIG. 10 is a diagram schematically illustrating target-object detection using a camera illustrated in FIG. 2;

FIG. 11 is a diagram schematically illustrating target-object detection using a camera illustrated in FIG. 2;

FIG. 12 is a diagram schematically illustrating driver-state detection using a driver-state monitor illustrated in FIG. 2;

FIG. 13 is a diagram schematically illustrating driver-state detection using a driver-state monitor illustrated in FIG. 2;

FIG. 14 is a diagram illustrating a schematic configuration of a head-up display illustrated in FIG. 2;

FIG. 15 is a schematic diagram illustrating (i) a road surface in front of an own vehicle through a front windshield and (ii) a part of a dashboard when viewed from a driver illustrated in FIG. 14;

FIG. 16 is a block diagram illustrating a schematic functional configuration to be implemented by the driving ECU illustrated in FIG. 2;

FIG. 17 is a block diagram illustrating a schematic functional configuration to be implemented by an identifying unit illustrated in FIG. 16;

FIG. 18 is a schematic view illustrating a first example of target objects to be identified by the exemplary embodiment;

FIG. 19 is a schematic view illustrating a second example of target objects to be identified by the exemplary embodiment;

FIG. 20 is a schematic view illustrating a third example of target objects to be identified by the exemplary embodiment;

FIG. 21 is a schematic view illustrating a fourth example of target objects to be identified by the exemplary embodiment;

FIG. 22 is a schematic view illustrating a fifth example of target objects to be identified by the exemplary embodiment;

FIG. 23 is a schematic view illustrating a sixth example of target objects to be identified by the exemplary embodiment;

FIG. 24 is a schematic view illustrating a fifth example of a target object to be identified by the exemplary embodiment;

FIG. 25 is a schematic view illustrating a sixth example of a target object to be identified by the exemplary embodiment;

FIG. 26 is a schematic view illustrating a seventh example of a target object to be identified by the exemplary embodiment;

FIG. 27 is a diagram schematically illustrating traffic signs as an eight example of target objects;

FIG. 28 is a schematic diagram illustrating a first example indicative of how to use recognition results of target objects;

FIG. 29 is a schematic diagram illustrating a second example indicative of how to use recognition results of target objects;

FIG. 30A is a block diagram schematically illustrating a functional configuration of a limp-home controller according to the first embodiment;

FIG. 30B is a flowchart schematically illustrating a first limp-home control routine according to a first specific application of the first embodiment;

FIG. 31 is a view schematically illustrating a first situation included in time-series situations indicative of how an own vehicle traveling in a farthest-end traveling lane is controlled to travel in a limp-home mode based on the limp-home control;

FIG. 32 is a view schematically illustrating a second situation included in the time-series situations;

FIG. 33 is a view schematically illustrating a third situation included in the time-series situations;

FIG. 34 is a view schematically illustrating a fourth situation included in the time-series situations;

FIG. 35 is a view schematically illustrating limp-home control carried out by the limp-home controller illustrated in FIG. 30A;

FIG. 36 is a view schematically illustrating a case where there may be a false detection of the shape of a far-side end of the left edge of a road relative to an emergency zone, so that there may be a false detection of an evacuation space according to the first specific application of the first embodiment;

FIG. 37 is a view schematically illustrating a case where major correction of the location and/or size of an evacuation space, which has been detected once, is performed according to the first specific application of the first embodiment;

FIG. 38 is a view schematically illustrating an example situation where the limp-home control is carried out when the own vehicle is traveling in a section of a road, which has a road shoulder according to a second specific application of the first embodiment;

FIG. 39 is a view schematically illustrating a first example situation where the limp-home control is carried out when the own vehicle is traveling in a section of a road having a road shoulder with an emergency parking zone located in the middle thereof according to the second specific application of the second embodiment;

FIG. 40 is a view schematically illustrating a second example situation where the limp-home control is carried out when the own vehicle is traveling in the section of the road having the road shoulder with the emergency parking zone located in the middle thereof according to the second specific application of the second embodiment;

FIG. 41 is a view schematically illustrating a first situation included in time-series situations representing, in detail, the first example situation illustrated in FIG. 39 according to the second specific application of the second embodiment;

FIG. 42 is a view schematically illustrating a second situation included in the time-series situations representing, in detail, the first example situation illustrated in FIG. 39 according to the second specific application of the second embodiment;

FIG. 43 is a view schematically illustrating a third situation included in the time-series situations representing, in detail, the first example situation illustrated in FIG. 39 according to the second specific application of the second embodiment;

FIG. 44 is a view schematically illustrating a fourth situation included in the time-series situations representing, in detail, the first example situation illustrated in FIG. 39 according to the second specific application of the second embodiment;

FIG. 45 is a view schematically illustrating a first situation included in time-series situations representing, in detail, the second example situation illustrated in FIG. 40 according to the second specific application of the second embodiment;

FIG. 46 is a view schematically illustrating a second situation included in the time-series situations representing, in detail, the second example situation illustrated in FIG. 40 according to the second specific application of the second embodiment;

FIG. 47 is a view schematically illustrating a third situation included in the time-series situations representing, in detail, the second example situation illustrated in FIG. 40 according to the second specific application of the second embodiment;

FIG. 48 is a flowchart schematically illustrating a second limp-home control routine according to the second specific application of the second embodiment;

FIG. 49 is a view schematically illustrating a situation where a near-side evacuation space is detected but a far-side evacuation space is not detected for any reason according to the second specific application of the second embodiment;

FIG. 50 is a view schematically illustrating a situation, which is different from the situation illustrated in FIG. 49, where an emergency parking zone is likely to become a blind spot from the own vehicle, resulting in a detected far-side evacuation space in the emergency parking zone being likely to have a low level of reliability according to a modification of the second specific application;

FIG. 51 is a view schematically illustrating a situation, which is different from the situation illustrated in FIG. 49, where an emergency parking zone is likely to become a blind spot from the own vehicle, so that erroneous detection of the road edges may result in a far-side evacuation space being undetected according to the modification of the second specific application;

FIG. 52 is a flowchart schematically illustrating a modified second limp-home control routine according to the modification of the second specific application;

FIG. 53 is a view schematically illustrating an example situation where the limp-home control of the own vehicle to a sufficiently distant evacuation space is carried out when the own vehicle is traveling in a road shoulder having a width sufficiently wider than the width of the own vehicle according to a third specific application of the first embodiment;

FIG. 54 is a view schematically illustrating an example situation where the limp-home control of the own vehicle to an evacuation space detected in an emergency parking zone is carried out according to the third specific application of the first embodiment;

FIG. 55 is a view schematically illustrating an example situation where the location of an evacuation space is specified in an emergency parking zone to be closer to the own vehicle than that the evacuation space thereto illustrated in FIG. 54 according to the third specific application of the first embodiment;

FIG. 56 is a graph schematically illustrating an example of a relationship between the variable of a first level of reliability of the road edge and the variable of a detection-point interval between each adjacent pair of road-edge detection points according to a fourth specific application of the first embodiment;

FIG. 57 is a graph schematically illustrating an example of a relationship between the variable of a second level of reliability of the road edge and the variable of the number of the road-edge detection points according to the fourth specific application of the first embodiment;

FIG. 58 is a graph schematically illustrating an example of a relationship between the variable of a third level of reliability of the width of an evacuation space and the variable of a correction quantity of the width of the evacuation space in the road width direction according to the fourth specific application of the first embodiment;

FIG. 59 is a view schematically illustrating how the limp-home traveling control task of the own vehicle is carried out in a case where a detected evacuation space has a relatively distant location from the own vehicle according to a fifth specific application of the first embodiment;

FIG. 60 is a graph schematically illustrating an example of a relationship between a control gain and a speed of the own vehicle according to the fifth specific application of the first embodiment;

FIG. 61 is a graph schematically illustrating an example of a relationship between the control gain and a relative distance of a detected evacuation space relative to the own vehicle according to the fifth specific application of the first embodiment;

FIG. 62A is a view schematically illustrating a situation where recognition of a left edge of the road may be interrupted, so that a recognized road edge may include missing portions according to a sixth specific application of the first embodiment;

FIG. 62B is a flowchart schematically illustrating a modified first limp-home control routine according to the sixth specific application of the first embodiment;

FIG. 63 is a view schematically illustrating a first example situation where the size of a blind spot from the own vehicle changes depending on the traveling position of the own vehicle in the road width direction according to a seventh specific application of the first embodiment;

FIG. 64 is a view schematically illustrating a second example situation where the size of the blind spot from the own vehicle changes depending on the traveling position of the own vehicle in the road width direction according to the seventh specific application of the first embodiment;

FIG. 65 is a view schematically illustrating a first example situation where an evacuation route, which has, for example, two curved sections, changes depending on the traveling position of the own vehicle in the road width direction according to an eighth specific application of the first embodiment;

FIG. 66 is a view schematically illustrating a second example situation where an evacuation route, which has, for example, two curved sections, changes depending on the traveling position of the own vehicle in the road width direction according to the eighth specific application of the first embodiment;

FIG. 67 is a flowchart schematically illustrating a modified second limp-home control routine according to a ninth specific application of the first embodiment;

FIG. 68 is a block diagram schematically illustrating a functional configuration of a collision determination unit according to the second embodiment of the present disclosure;

FIG. 69 is a view schematically illustrating a collision determination task carried out by a collision determination unit illustrated in FIG. 68;

FIG. 70 is a view schematically illustrating the collision determination task carried out by a collision determination unit illustrated in FIG. 68;

FIG. 71 is a view schematically illustrating the collision determination task carried out by a collision determination unit illustrated in FIG. 68;

FIG. 72 is a view schematically illustrating the collision determination task carried out by a collision determination unit illustrated in FIG. 68;

FIG. 73 is a flowchart schematically illustrating a collision risk determination routine according to a first specific application of the second embodiment;

FIG. 74 is a view schematically illustrating a collision determination task carried out by the collision determination unit illustrated in FIG. 68 according to a second specific application of the second embodiment;

FIG. 75 is a view schematically illustrating a collision determination task carried out by the collision determination unit illustrated in FIG. 68 according to a third specific application of the second embodiment;

FIG. 76 is a view schematically illustrating a collision determination task carried out by the collision determination unit illustrated in FIG. 68 according to a fourth specific application of the second embodiment;

FIG. 77 is a view schematically illustrating a collision determination task carried out by the collision determination unit illustrated in FIG. 68 according to a fifth specific application of the second embodiment;

FIG. 78 is a flowchart schematically illustrating a collision determination subroutine carried out by the collision determination unit illustrated in FIG. 68 according to the fifth specific application of the second embodiment;

FIG. 79 is a view schematically illustrating a collision determination task carried out by the collision determination unit illustrated in FIG. 68 according to a sixth specific application of the second embodiment;

FIG. 80 is a flowchart schematically illustrating a collision determination routine carried out by the collision determination unit illustrated in FIG. 68 according to the sixth specific application of the second embodiment;

FIG. 81 is a view schematically illustrating an example where information on one or more obstacles detected or recognized around a scheduled traveling region has a higher level of certainty than a predetermined certainty threshold according to a seventh specific application of the second embodiment; and

FIG. 82 is a view schematically illustrating an example where information on one or more obstacles detected or recognized around the scheduled traveling region has a lower level of certainty than the predetermined certainty threshold according to the seventh specific application of the second embodiment.

### DETAILED DESCRIPTION OF EMBODIMENTS

The following describes a base embodiment and first and second embodiments of the present disclosure with reference to the accompanying drawings. Configurations, functions, and/or examples descried in the following embodiments can be freely modified. In the embodiments and their modifications, same reference characters are assigned to equivalent or same components between the embodiments, between each embodiment and its modifications, and between the modifications. Among the equivalent or same components, descriptions of the former component can be directly used to describe the later component(s) as long as (i) no technological contradictions arise and/or no additional descriptions.

### Overall Configuration of Vehicle

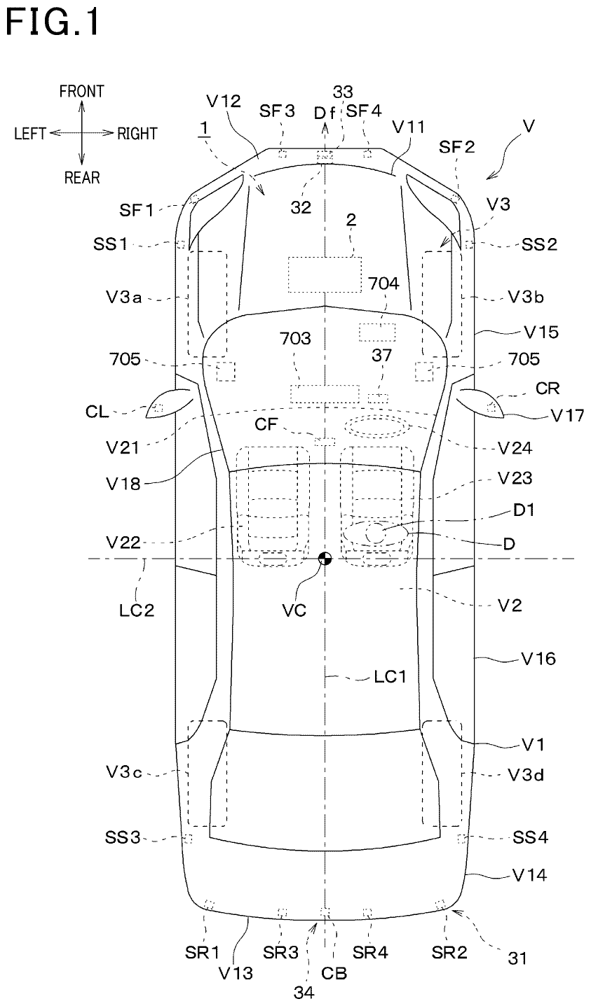

FIG. 1 illustrates a system-installed vehicle V according to the base embodiment to which the present disclosure is applied. The system-installed vehicle V is a four-wheel motor vehicle. The system-installed vehicle V has a body V1 having a substantially rectangular shape in plan view. The body, i.e., the vehicle body, V1 has a first center line LC1 defined as a virtual line that passes through a center point VC of the vehicle V and extends in the front-rear direction, i.e., the longitudinal direction, of the system-installed vehicle V. The system-installed vehicle V has a second center line LC2 defined as a virtual line that passes through the vehicle center point VC and extends in the left-right direction, i.e., the width direction, of the system-installed vehicle V. The center point VC of the system-installed vehicle V is defined as a three-dimensional center point of the vehicle body V1.

In FIG. 1, the width direction of the system-installed vehicle V, which will be referred to as a vehicle width direction, corresponds to the horizontal direction therein, a vehicle height direction is defined as a height direction of the system-installed vehicle V, and is parallel to the direction of gravity of the system-installed vehicle V while the system-installed vehicle V is mounted movably and stably on the plane of horizon. The longitudinal direction of the system-installed vehicle V, which will be referred to as a vehicle longitudinal direction, is defined to be perpendicular to both the vehicle width direction and the vehicle height direction.

In the system-installed vehicle V, a front direction, a rear direction, a left direction, and a right direction are defined as illustrated in FIG. 1. That is, the vehicle longitudinal direction is synonymous with the front-rear direction, and the vehicle width direction is synonymous with the left-right direction. The vehicle height direction may be not parallel to the direction of gravity of the system-installed vehicle V depending on the situation where the system-installed vehicle V is mounted on any road and/or the conditions in which the system-installed vehicle V is traveling. The vehicle height direction is usually parallel to the direction of gravity of the system-installed vehicle V.

The vehicle body V1 has defined thereinside an interior V2 serving as a compartment of one or more occupants including a driver of the system-installed vehicle V.

The body V1 has a front-end portion, a rear-end portion, a left-side portion, a right-side portion, a top portion, and four corners that include a front-left corner, a front-right corner, a rear-left corner, and a rear-right corner.

The vehicle V includes four wheels V3, i.e., four wheels V3a, V3b, V3c, and V3d, mounted to the respective four corners of the body V1. Specifically, the wheel V3a, i.e., the front-left wheel V3a, is mounted to the front-left corner of the body V1, the wheel V3b, i.e., the front-right vehicle V3b, is mounted to the front-right corner of the body V1, the wheel V3c, i.e., the rear-left wheel V3c, is mounted to the rear-left corner of the body V1, and the wheel V3d, i.e., the rear-right vehicle V3d, is mounted to the rear-right corner of the body V1. The system-installed vehicle V is not limited to such a four-wheel motor vehicle, and a three-wheel motor vehicle or a six- or an eight-wheel vehicle, such as a cargo truck, can be used as the system-installed vehicle V. The number of driving wheels in the wheels of the system-installed vehicle V can be freely determined, and each driving wheel can be freely located to the body V1 of the system-installed vehicle V.

The system-installed vehicle V includes a front bumper V12 mounted to the front end portion, i.e., a front side, V11 of the body V1. The system-installed vehicle V includes a rear bumper V14 mounted to the rear end portion, i.e., a rear side, V13 of the body V1. The body V1 of the system-installed vehicle V includes a body panel V15 arranged to constitute the left- and right-side portions and the top portion of the body V1. The body panel V15 includes door panels V16. In the base embodiment illustrated in FIG. 1, the body panel V15 includes a front pair of left and right door panels V16 and a rear pair of left and right door panels V16; the left door panels V16 of the front and right pairs are located at the left-side portion of the body V1, and the right door panels V16 of the front and right pairs are located at the right-side portion of the body V1. The system-installed vehicle V includes a pair of door mirrors V17 mounted to the respective left and right doors V16 of the front pair. The body V1 includes a front windshield V18 that covers a front side of the interior V2.

The front windshield V18 has a substantially plate-like shape, and is made of translucent glass or translucent synthetic resin. The front windshield V18 is attached to the body panel V15, and is inclined such that a bottom of the front windshield V18 is located to be closer to the front of the body V1 than a top of the front windshield V18 is when viewed in a side view in parallel to the vehicle width direction.

The system-installed vehicle V includes a dashboard V21 and a plurality of seats V22 that include a driver's seat V23 on which a driver D sits. The dashboard V21 is provided in a front portion of the interior V2, and the seats V22 are located at the rear of the dashboard V21. The system-installed vehicle V includes a steering wheel V24 located in front of the driver's seat V23. The driver D grasps the steering wheel V24 and steers the steering wheel V24 to thereby control the steering of the system-installed vehicle V. The steering wheel V24 typically has a substantially ring shape, a substantially ellipsoidal shape, or a substantially polygonal-ring shape, but can have a bar-like shape or a control-stick shape.

### Overall Configuration of Vehicular System

The system-installed vehicle V includes a vehicular system 1 installed therein. The vehicular system 1, which is installed in the system-installed vehicle V, is configured to serve as a driving automation system or an autonomous driving system in the system-installed vehicle V. The system-installed vehicle V will also be referred to as an own vehicle V. The autonomous driving system is configured to implement one of levels 1 to 5 included in all the six autonomous driving levels (0 to 5 levels) defined in SAE J2016 standard opened by SAE international; SAE is an abbreviation for “Society of Automotive Engineers”. Any level X in the autonomous driving levels 0 to 5 will also be referred to as an SOE level X. That is, the variable X can take any one of 0, 1, 2, 3, 4, and 5. The higher the SOE level X, the higher the driving automation level. In other words, the greater the number of dynamic driving tasks that the driving system carries out, the higher the autonomous driving level. When the autonomous driving level is changed to be higher, the autonomous driving level increases. In contrast, the lower the SOE level X, the lower the autonomous driving level. In other words, the smaller the number of dynamic driving tasks that the autonomous driving system carries out, the lower the autonomous driving level. When the autonomous driving level is changed to be lower, the autonomous driving level decreases.

### Definition of Driving Assist and Autonomous Driving

The SAE levels 0 to 5 will be specifically described below.

Hereinafter, the driver D is an occupant who manages and carries out dynamic driving tasks. The dynamic driving tasks show all operational functions and all maneuver functions that need be carried out in real time by the driver D when the driver D drives the own vehicle V in traffic roads except for strategical functions. Overall driving actions can be categorized into the operational functions, maneuver functions, and strategical functions.

The strategical functions may include functions of planning a travel schedule and selecting one or more places through the planned travel schedule. Specifically, the strategical functions may include functions of determining or selecting a travel schedule that shows (i) whether to go to a destination, (ii) when to go to the destination, and (iii) how to go to the destination.

The maneuver functions may include functions of determining, in various traffic situations, various maneuvers that may include, during the scheduled travel, (i) determining, during the scheduled travel, whether and when to overtake, (ii) determining whether and when to make a lane change, (iii) selectively setting a proper speed of the own vehicle V, and (iv) checking the mirrors.

The operational functions may include driver's instantaneous reactions, such as steering operations, braking operations, accelerating operations, and/or minor adjustments of these operations, in order to keep a position of the own vehicle V in a corresponding lane of a road and/or avoid at least one obstacle and/or at least one danger event on the path of the moving own vehicle V. OEDR is an abbreviation for “Object and Event Detection and Response”, and can be called “detection and response of objects and events”. OEDR includes the monitoring of driving environment around the own vehicle V. The monitoring of the driving environment around the own vehicle V may include detection, recognition, and classification of one or more objects and/or events. The monitoring of the driving environment around the own vehicle V may additionally include preparation of response for the one or more objects and/or events. Operational Design Domain (ODD) conditions, which will also be called “specific domain conditions”, represent specific conditions under which a given autonomous driving system or feature thereof is designed to function. The ODD conditions may include, for example, at least one of a plurality of limiting conditions including, for example, geographic conditions, environmental conditions, velocity conditions, and time conditions.

Level 0 represents No Autonomous driving, which represents that the driver D performs all the dynamic driving tasks.

Level 1 represents Driving Assistance, which represents that an autonomous driving system sustainably executes, under specific ODD conditions, either the lateral vehicle motion control subtasks or the longitudinal vehicle motion control subtasks of the dynamic driving tasks. The longitudinal vehicle motion control subtasks include, for example, forward/backward operation, acceleration/deceleration operation, and stop operation. The lateral vehicle motion control tasks include, for example, steering operation. In particular, the autonomous driving system is configured not to perform both the lateral vehicle motion control subtasks and the longitudinal vehicle motion control subtasks.

Level 2 represents Partial Autonomous driving or Advanced Driving assistance, which represents that an autonomous driving system sustainably executes, under specific ODD conditions, both the lateral vehicle motion control subtasks and the longitudinal vehicle motion control subtasks of the dynamic driving tasks with expectation that the driver D completes OEDR subtasks and supervises the autonomous driving system.

Level 3 represents Conditional Autonomous driving, which represents that a driving automatic system sustainably executes, under specific ODD conditions, all the dynamic driving tasks. Under the specific ODD conditions, the driver D is not required to perform one of the OEDR subtasks of monitoring the traffic environment around the own vehicle V, but, when the driving automatic system has a difficulty continuing at Level 3, the driving automatic system requests the driver D to control the own vehicle V with plenty of time, so that the driver D needs to smoothly respond to the request.

Level 4 represents High Automation, which represents that a driving automatic system sustainably executes, under specific ODD conditions, all the dynamic driving tasks. When the driving automatic system has a difficulty continuing at Level 4, the driving automatic system addresses the difficulty.

Level 5 represents Full Automation, which represents that a driving automatic system on the own vehicle V sustainably executes all the dynamic driving tasks without limitation in all the ODD conditions. When the driving automatic system has a difficulty continuing at Level 5, the driving automatic system addresses the difficulty without limitation in all the ODD conditions.

The vehicular system 1 is configured to perform various driving control tasks and various notifying tasks based on the various driving tasks during driving of the own vehicle V. Specifically, the vehicular system 1 is configured as an autonomous driving system that implements driving assistance for the own vehicle V and/or autonomous driving of the own vehicle V. The autonomous driving corresponds to each of the SAE levels 3 to 5. That is, the autonomous driving in each of the SAE levels 3 to 5 represents that the vehicular system 1 serves as the autonomous driving system to execute all the dynamic driving tasks in the corresponding one of the SAE levels 3 to 5. In contrast, the driving assistance corresponds to each of the SAE levels 1 and 2. That is, the autonomous driving in each of the SAE levels 1 and 2 represents that the vehicular system 1 serves as the autonomous driving system to execute a part of the dynamic driving tasks in the corresponding one of the SAE levels 1 and 2. That is, the driving assistance can include both the SAE level 1 of “Driver Assistance” and the SAE level 2 of “Partial Autonomous driving” or “Advanced Driving assistance” except that the expression “driving assistance of the SAE level 1” is used or the driving assistance is used to be distinguished from the partial autonomous driving of the SAE level 2.

The vehicular system 1 of the base embodiment can be configured to execute (i) the autonomous driving in each of the SAE levels 3 to 5, (ii) the partial autonomous driving, i.e., advanced driving assistance, in the SAE level 2, and the driving assistance in the SAE level 1. The driving assistance that can be carried out by the vehicular system 1 of the base embodiment may include hands-off driving. The hands-off driving enables the vehicular system 1 to automatically move the own vehicle V forward or backward, steer the own vehicle V, accelerate or decelerate the own vehicle V, make lane changes of the own vehicle V, and/or stop the own vehicle V as long as the driver D addresses appropriately an intervening request issued from the vehicular system 1.

The hands-off driving requests the driver D to monitor road conditions around the own vehicle V, traffic situations around the own vehicle V, and information about whether there are one or more obstacles around the own vehicle V without requesting the driver D to be in a hands-on state. The hands-on state represents a state of the driver D in which the driver D is ready to steer the own vehicle V, i.e., ready to intervene in the lateral vehicle motion control subtasks. The hands-on state typically represents a state of the driver D in which the driver D is sit on the driver's seat V23 with a posture enabling driving of the own vehicle V and is ready to operate the steering wheel V24 with his/her hands. The driver D being in the hands-on state grasps the steering wheel V24 with his/her hands. The state in which the driver D touches the steering wheel V24 with his/her hands while being ready to grasp the steering wheel V24 applies to the hands-on state. For example, the state in which the driver D is operating the steering wheel V24, i.e., the driver D is actively operating the steering wheel V24, applies to the hands-on state. The state in which the driver D holds the steering wheel V24 against the controlled steering of the steering wheel V24 by the vehicular system 1 applies to the hands-on state.

### Configuration of Vehicular System

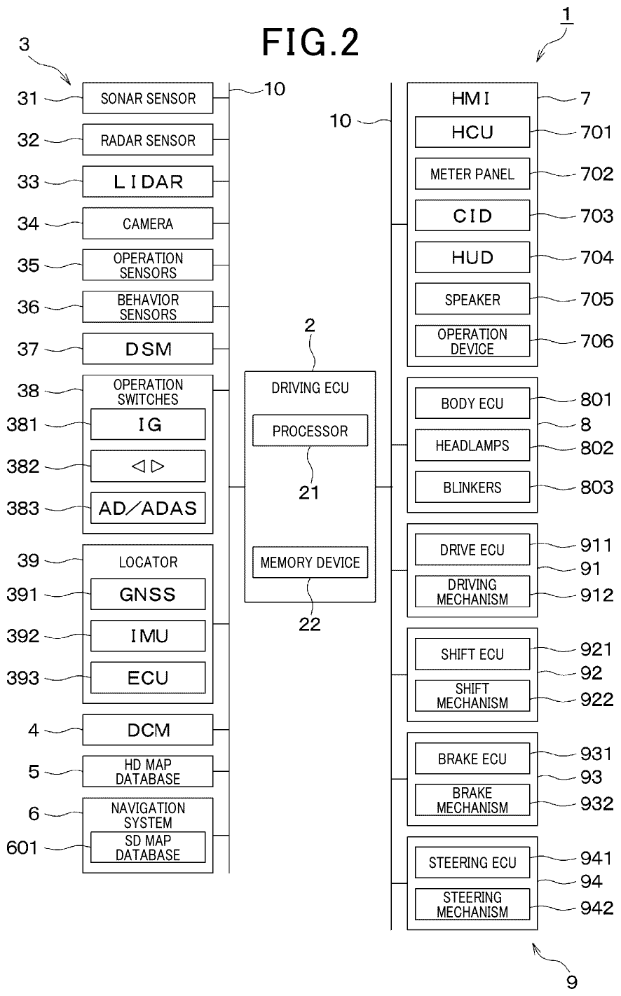

The following describes an overall configuration of the vehicular system 1 with reference to FIGS. 1 and 2.

The vehicular system 1 includes a driving electronic control unit (ECU) 2, a driving information input unit 3, a vehicular communication module, in other words, a data communication module (DCM), 4, a high-definition (HD) map database 5, a navigation system 6, a human machine interface (HMI) system 7, a lighting system 8, and a motion control system 9.

The vehicular system 1 is configured such that the driving ECU 2, the driving information input unit 3, the vehicular communication module 4, the HD map database 5, the navigation system 6, the HMI system 7, the lighting system 8, and the motion control system 9 are communicably connected to one another via vehicular communication network 10. The vehicular communication network 10 includes a main network that is in conformity with one of various communication standards, such as Controller Area Network® (INTERNATIONAL REGISTRATION NUMBER 1048262A). The vehicular communication network 10 may include, in addition to the main network being in conformity with CAN®, a subnetwork that is in conformity with Local Interconnect Network (LIN) or FlexRay.

### Driving ECU

The driving ECU 2 serves as a control apparatus according to the present disclosure, which is installed in the system-installed vehicle V, and is configured to control overall operations in the vehicular system 1. The driving ECU 2 is configured as an Autonomous Driving/Advanced Driver-Assistance Systems (AD/ADAS) ECU serving as both a driving assistance controller and an autonomous driving controller. Specifically, the driving ECU 2 includes at least one processor 21 and at least one memory device 22 communicably connected to the at least one processor 21.

The at least one processor 21, which will be simply referred to as a processor 21, is comprised of a Center Processing unit (CPU) or a Micro Processing Unit (MPU). The at least one memory device 22 may include, for example, at least a Read Only Memory (ROM) and a Random Access Memory (RAM) selected from various nonvolatile memory devices, such as ROMs, RAMS, and nonvolatile rewritable recording media. Such recording media can be referred to as storage media. These nonvolatile rewritable recording media, such as flash ROMs or EEPROMs, enable information stored therein to be rewritable while being power on, and hold information unwritable while being power off. EEPROM is an abbreviation for Electronically Erasable and Programmable ROM. The ROM or at least one of the nonvolatile rewritable memory devices included in the memory device 22 stores beforehand data and program instructions used for the processor 21. The driving ECU 2 is configured to read the program instructions stored in the memory device 22 and execute the readout program instructions to accordingly perform various tasks and operations, which include own-vehicle control operations and notification operations to the occupants.

### Driving Information Input Unit

The driving information input unit 3 is configured to input, to the driving ECU 2, information required for the driving ECU 2 to perform various operations and tasks. Specifically, the driving information input unit 3 may include at least one sonar sensor 31, a radar sensor 32, a laser-radar sensor (LIDAR) 33, at least one camera 34, operation sensors 35, behavior sensors 36, a driver-state monitor 37, operation switches 38, and a locator 39. The sonar sensor 31, radar sensor 32, LIDAR 33, and camera 34 will be collectively referred to as surrounding monitor sensors or ADAS sensors. The following sequentially describes the components of the driving information input unit 3.

### Sonar Sensor

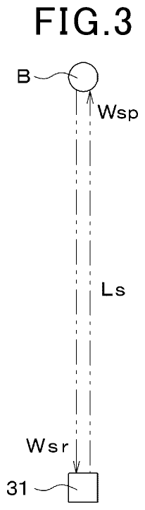

The at least one sonar sensor, which will be simply referred to as a sonar sensor, 31 is an ultrasonic range sensor mounted to the body V1. The sonar sensor 31 is an ultrasonic sensor, and is configured to, as illustrated in FIG. 3, emit sonar probing waves Wsp within an ultrasonic frequency band toward an external space outside the own vehicle V. The sonar sensor 31 is configured to receive sonar echoes Wsr resulting from reflection of the sonar probing waves Wsp by a target object B to accordingly detect various information about the target object B. In the specification, reference character B is assigned to any target object for the sake of convenience, but target objects to which the same reference character B are assigned may not necessarily represent the same target object.

Specifically, the sonar sensor 31 is configured to calculate a distance of the object B from the sonar sensor 31 based on Time of Flight (TOF) and the speed of sound. The TOF represents time defined from a time of emitting a sonar probing wave, i.e., pulse, Wsp to a time of receiving a sonar echo Wsr through a propagation path Ls of the pulses Wsp and Wsr; the TOF will also be therefore referred to as propagation time.

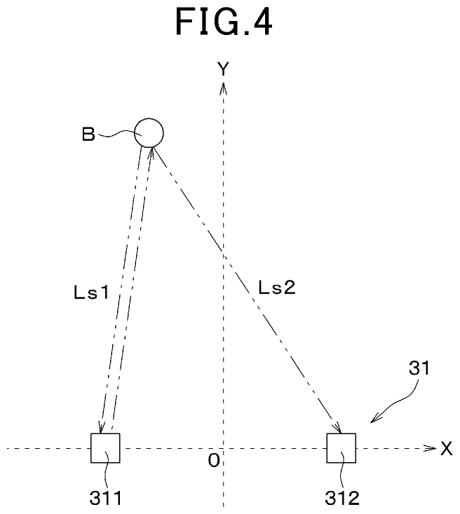

If the driving information input unit 3 includes a pair of sonar sensors 31, i.e., a pair of a first sonar sensor 311 and a second sonar sensor 312 (see FIG. 4), using a known triangulation method enables measurement of a relative distance of the target object B relative to the own vehicle V. In FIG. 4, an X axis is defined along a virtual line connecting between the first and second sonars 311 and 312, and a Y axis is defined to be perpendicular to the X axis. The X and Y axes extend along a reference horizontal plane that is perpendicular to the vehicle height direction.

The first sonar sensor 311 is configured to emit the sonar probing waves Wsp, and each of the first and second sonar sensors 311 and 312 is configured to receive the sonar echoes Wsr resulting from reflection of the sonar probing waves Wsp by the target object B. It is possible to calculate, based on a first TOF through a first propagation path Ls1 and a second TOF through a second propagation path Ls2, a position of the target object B in a two-dimensional XY coordinate system constituted by the X and Y axes. The first propagation path Ls1 is defined as a propagation path through which an ultrasonic wave (pulse) emitted as a sonar probing wave Wsp from the first sonar 311 is propagated through the target object B to be returned to the first sonar 311 as a sonar echo Wsr. Ultrasonic waves (pulses) propagated through the propagation path Ls1 will also be referred to as direct waves (pulses). The second propagation path Ls2 is defined as a propagation path through which an ultrasonic wave (pulse) emitted as a sonar probing wave Wsp from the first sonar 311 is propagated through the target object B to reach the second sonar 312 as a sonar echo Wsr. Ultrasonic waves (pulses) propagated through the propagation path Ls2 will also be referred to as indirect waves (pulses).

For example, the driving information input unit 3 according to the base embodiment includes a plurality of sonar sensors 31 mounted to the body V1 (see FIG. 1). Specifically, the sonar sensors 31 include first, second, third, and fourth front sonars SF1, SF2, SF3, and SF4 mounted to the front bumper V12. Similarly, the sonar sensors 31 include first, second, third, and fourth rear sonars SR1, SR2, SR3, and SR4 mounted to the rear bumper V14. Additionally, the sonar sensors 31 include first, second, third, and fourth side sonars SS1, SS2, SS3, and SS4. The first and third side sonars SS1 and SS3 are mounted to the left side portion of the body V1, and the second and fourth side sonars SS2 and SS4 are mounted to the right side portion of the body V1.

The first to fourth front sonars SF1 to SF4, the first to fourth rear sonars SR1 to SR4, and the first to fourth side sonars SS1 to SS4 will also be collectively referred to simply as a sonar sensor 31 or sonar sensors 31 if it is unnecessary to identify any of the sonars SF1 to SS4.

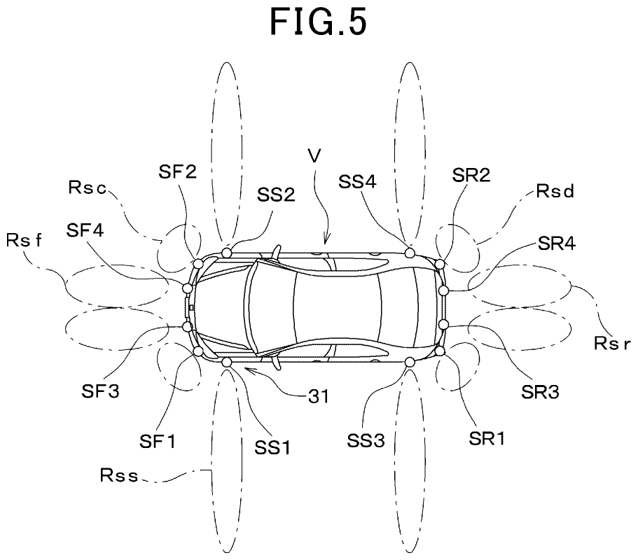

FIG. 5 illustrates a predetermined detection region, i.e., a predetermined sensing region, of each of the sonar sensors 31.

The following sequentially describes the sonar sensors 31 with reference to FIGS. 1 and 5.

The first front sonar SF1 is mounted to a portion of the front bumper V12, which is closer to the left edge of the front bumper V12 than the right edge thereof in the vehicle width direction, and is configured to emit the sonar probing waves Wsp diagonally forward left. The second front sonar SF2 is mounted to a portion of the front bumper V12, which is closer to the right edge of the front bumper V12 than the left edge thereof in the vehicle width direction, and is configured to emit the sonar probing waves Wsp diagonally forward right. The first and second front sonars SF1 and SF2 are arranged symmetrically with respect to the first center line LC1. Each of the first and second front sonars SF1 and SF2 has a predetermined detection region Rsc, and the detection region Rsc, which will also be referred to as a front-corner detection region Rsc, of each of the first and second front sonars SF1 and SF2 is designed such that a detection range of the front-corner detection region Rsc is set to, for example, 60 cm or thereabout. The detection range of a sonar sensor 31 represents a maximum measurable range (distance) of the sonar sensor 31.

The third and fourth front sonars SF3 and SF4 are mounted to a middle portion of the front bumper V12 to be aligned in the vehicle width direction. Specifically, the third front sonar SF3 is arranged between the first front sonar SF1 and the first center line LC1, and is configured to emit the sonar probing waves Wsp substantially forward, and the fourth front sonar SF4 is arranged between the second front sonar SF2 and the first center line LC1, and is configured to emit the sonar probing waves Wsp substantially forward. The third and fourth front sonars SF3 and SF4 are arranged symmetrically with respect to the first center line LC1. Each of the third and fourth front sonars SF3 and SF4 has a predetermined detection region Rsf, and the detection region Rsf, which will also be referred to as a front detection region Rsf, of each of the third and fourth front sonars SF3 and SF4 is designed such that the detection range of the front detection region Rsf is set to, for example, 1 m or thereabout.

The first and third front sonars SF1 and SF3, which are mounted to the left side of the front bumper V12 relative to the first center line LC1, are arranged at different positions in the vehicle width direction, i.e., the horizontal direction. The first and third front sonars SF1 and SF3, which are adjacent to one another in the vehicle width direction, are arranged to have a predetermined positional relationship that enables one of the first and third front sonars SF1 and SF3 to receive, as received echoes, sonar echoes resulting from reflection of the sonar probing waves Wsp emitted from the other of the first and third front sonars SF1 and SF3 by a target object.

Specifically, the first front sonar SF1 is arranged to receive both (i) direct echoes resulting from reflection of the sonar probing waves Wsp emitted from the first front sonar SF1 by a target object, and (ii) indirect echoes resulting from reflection of the sonar probing waves Wsp emitted from the third front sonar SF3 by the target object. Similarly, the third front sonar SF3 is arranged to receive both (i) direct echoes resulting from reflection of the sonar probing waves Wsp emitted from the third front sonar SF3 by a target object, and (ii) indirect echoes resulting from reflection of the sonar probing waves Wsp emitted from the first front sonar SF1 by the target object.

Similarly, the third and fourth front sonars SF3 and SF4, which are mounted to the middle portion of the front bumper V12 in the vehicle width direction, are arranged at different positions in the vehicle width direction, i.e., the horizontal direction. The third and fourth front sonars SF3 and SF4, which are adjacent to one another in the vehicle width direction, are arranged to have a predetermined positional relationship that enables one of the third and fourth front sonars SF3 and SF4 to receive, as received echoes, sonar echoes resulting from reflection of the sonar probing waves Wsp emitted from the other of the third and fourth front sonars SF3 and SF4 by a target object.

The second and fourth front sonars SF2 and SF4, which are mounted to the right side of the front bumper V12 relative to the first center line LC1, are arranged at different positions in the vehicle width direction, i.e., the horizontal direction. The second and fourth front sonars SF2 and SF4, which are adjacent to one another in the vehicle width direction, are arranged to have a predetermined positional relationship that enables one of the second and fourth front sonars SF2 and SF4 to receive, as received echoes, sonar echoes resulting from reflection of the sonar probing waves Wsp emitted from the other of the second and fourth front sonars SF2 and SF4 by a target object.

The first rear sonar SR1 is mounted to a portion of the rear bumper V14, which is closer to the left edge of the rear bumper V14 than the right edge thereof in the vehicle width direction, and is configured to emit the sonar probing waves Wsp diagonally rearward left. The second rear sonar SR2 is mounted to a portion of the rear bumper V14, which is closer to the right edge of the rear bumper V14 than the left edge thereof in the vehicle width direction, and is configured to emit the sonar probing waves Wsp diagonally rearward right. The first and second rear sonars SR1 and SR2 are arranged symmetrically with respect to the first center line LC1. Each of the first and second rear sonars SR1 and SR2 has a predetermined detection region Rsd, and the detection region Rsd, which will also be referred to as a rear-corner detection region Rsd, of each of the first and second rear sonars SR1 and SR2 is designed such that the detection range of the rear-corner detection region Rsd is set to, for example, 60 cm or thereabout.

The third and fourth rear sonars SR3 and SR4 are mounted to a middle portion of the rear bumper V14 to be aligned in the vehicle width direction. Specifically, the third rear sonar SR3 is arranged between the first rear sonar SR1 and the first center line LC1, and is configured to emit the sonar probing waves Wsp substantially rearward, and the fourth rear sonar SR4 is arranged between the second rear sonar SR2 and the first center line LC1, and is configured to emit the sonar probing waves Wsp substantially rearward. The third and fourth rear sonars SR3 and SR4 are arranged symmetrically with respect to the first center line LC1. Each of the third and fourth rear sonars SR3 and SR4 has a predetermined detection region Rsr, and the detection region Rsr, which will also be referred to as a rear detection region Rsr, of each of the third and fourth rear sonars SR3 and SR4 is designed such that the detection distance of the rear detection region Rsr is set to, for example, 1.5 m or thereabout.

The first and third rear sonars SR1 and SR3, which are mounted to the left side of the rear bumper V14 relative to the first center line LC1, are arranged at different positions in the vehicle width direction, i.e., the horizontal direction. The first and third rear sonars SR1 and SR3, which are adjacent to one another in the vehicle width direction, are arranged to have a predetermined positional relationship that enables one of the first and third rear sonars SR1 and SR3 to receive, as received echoes, sonar echoes resulting from reflection of the sonar probing waves Wsp emitted from the other of the first and third rear sonars SR1 and SR3 by a target object.

Specifically, the first rear sonar SR1 is arranged to receive both (i) direct echoes resulting from reflection of the sonar probing waves Wsp emitted from the first rear sonar SR1 by a target object, and (ii) indirect echoes resulting from reflection of the sonar probing waves Wsp emitted from the third rear sonar SR3 by the target object. Similarly, the third rear sonar SR3 is arranged to receive both (i) direct echoes resulting from reflection of the sonar probing waves Wsp emitted from the third rear sonar SR3 by a target object, and (ii) indirect echoes resulting from reflection of the sonar probing waves Wsp emitted from the first rear sonar SR1 by the target object.

Similarly, the third and fourth rear sonars SR3 and SRF4, which are mounted to the middle portion of the rear bumper V14 in the vehicle width direction, are arranged at different positions in the vehicle width direction, i.e., the horizontal direction. The third and fourth rear sonars SR3 and SR4, which are adjacent to one another in the vehicle width direction, are arranged to have a predetermined positional relationship that enables one of the third and fourth rear sonars SR3 and SR4 to receive, as received echoes, sonar echoes resulting from reflection of the sonar probing waves Wsp emitted from the other of the third and fourth rear sonars SR3 and SR4 by a target object.

The second and fourth rear sonars SR2 and SR4, which are mounted to the right side of the rear bumper V14 relative to the first center line LC1, are arranged at different positions in the vehicle width direction, i.e., the horizontal direction. The second and fourth rear sonars SR2 and SR4, which are adjacent to one another in the vehicle width direction, are arranged to have a predetermined positional relationship that enables one of the second and fourth rear sonars SR2 and SR4 to receive, as received echoes, sonar echoes resulting from reflection of the sonar probing waves Wsp emitted from the other of the second and fourth rear sonars SR2 and SR4 by a target object.

Each of the first side sonar SS1 and the third sonar SS3 is mounted to a portion of the left side portion of the body V1, and is configured to emit the sonar probing waves Wsp leftward relative to the own vehicle V. Similarly, each of the second side sonar SS2 and the fourth sonar SS4 is mounted to a portion of the right side portion of the body V1, and is configured to emit the sonar probing waves Wsp rightward relative to the own vehicle V. Each of the first, second, third, and fourth side sonars SS1, SS2, SS3, and SS4 is arranged to receive only direct echoes resulting from reflection of the sonar probing waves Wsp emitted from the corresponding one of the first, second, third, and fourth side sonars SS1, SS2, SS3, and SS4. Each of the first, second, third, and fourth side sonars SS1, SS2, SS3, and SS4 has a predetermined detection region Rss, and the detection region Rss, which will also be referred to as a side detection region Rss, of each of the first to fourth side sonars SS1 to SS4 is designed such that the detection distance of the side detection region Rss is set to be within, for example, a range from 2 to 3 m inclusive.

The first side sonar SS1 is arranged between the first front sonar SF1 and the door mirror V17 mounted to the left door panel V16 of the front pair, which will also be referred to as a left door mirror V17. The first side sonar SS1 is configured to emit the sonar probing waves Wsp leftward relative to the own vehicle V. The second side sonar SS2 is arranged between the second front sonar SF2 and the door mirror V17 mounted to the right door panel V16 of the front pair, which will also be referred to as a right door mirror V17. The second side sonar SS2 is configured to emit the sonar probing waves Wsp rightward relative to the own vehicle V. The first and second side sonars SS1 and SS2 are arranged symmetrically with respect to the first center line LC1. The first and second side sonars SS1 and SS2 can be mounted to the body panel V15 or mounted to portions of the respective left and right edges of the front bumper V12 in the vehicle width direction; the portion of each of the left and right edges of the front bumper V12 to which the corresponding one of the first and second side sonars SS1 and SS2 extends rearward in the vehicle longitudinal direction.

The third side sonar SS3 is arranged between the first rear sonar SR1 and the left door panel V16 of the rear pair. The third side sonar SS3 is configured to emit the sonar probing waves Wsp leftward relative to the own vehicle V. The fourth side sonar SS2 is arranged between the second rear sonar SR2 and the right door panel V16 of the rear pair. The fourth side sonar SS4 is configured to emit the sonar probing waves Wsp rightward relative to the own vehicle V. The third and fourth side sonars SS3 and SS4 are arranged symmetrically with respect to the first center line LC1. The third and fourth side sonars SS3 and SS4 can be mounted to the body panel V15 or mounted to portions of the respective left and right edges of the rear bumper V14 in the vehicle width direction; the portion of each of the left and right edges of the rear bumper V14 to which the corresponding one of the third and fourth side sonars SS3 and SS4 extends forward in the vehicle longitudinal direction.

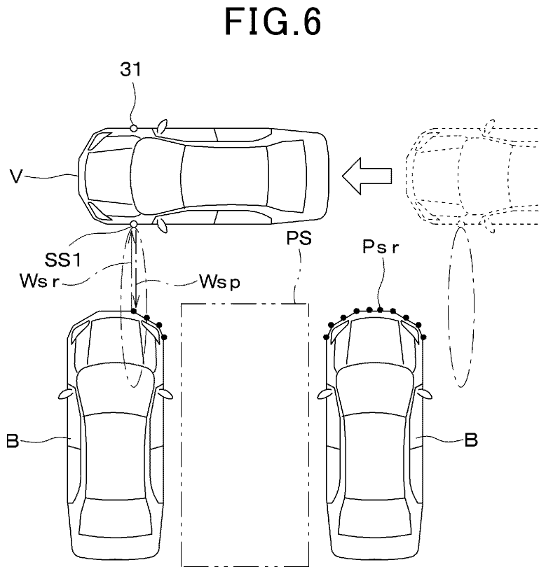

FIG. 6 schematically illustrates an example where the driving ECU 2 detects, using the first side sonar SS1, a parking space or a parking slot PS located left-sideward relative to the own vehicle V for performing side-by-side parking. The parking space PS is a rectangular frame-like area in plan view, and represents a space in which a vehicle can be parked. FIG. 6 illustrates sonar detection points Psr that are points by which the sonar probing waves Wsp emitted from any sonar sensor 31 are estimated to be reflected; the sonar detection points Psr can also be referred to as ranging points Psr. As illustrated in FIG. 6, the driving ECU 2 can detect the parking space PS based on a distribution of the sonar detection points Psr that are acquired based on sonar echoes Wsr from target objects B that are parked vehicles arranged side-by-side in the direction of the straight forward movement of the own vehicle V.

Specifically, when acquiring adjacent rows of the sonar detection points Psr arranged in the traveling direction of the own vehicle V when performing a side-by-side parking of the own vehicle V as illustrated in FIG. 6, the driving ECU 2 can determine whether the length of a space between each adjacent pair of rows of the sonar detection points Psr exceeds the entire width of the own vehicle V, and detect, in response to determination that the length of the space between at least one adjacent pair of rows of the sonar detection points Psr exceeds the entire width of the own vehicle V, the space between at least one adjacent pair of rows of the sonar detection points Psr as location of a parking space PS.

### Radar Sensor

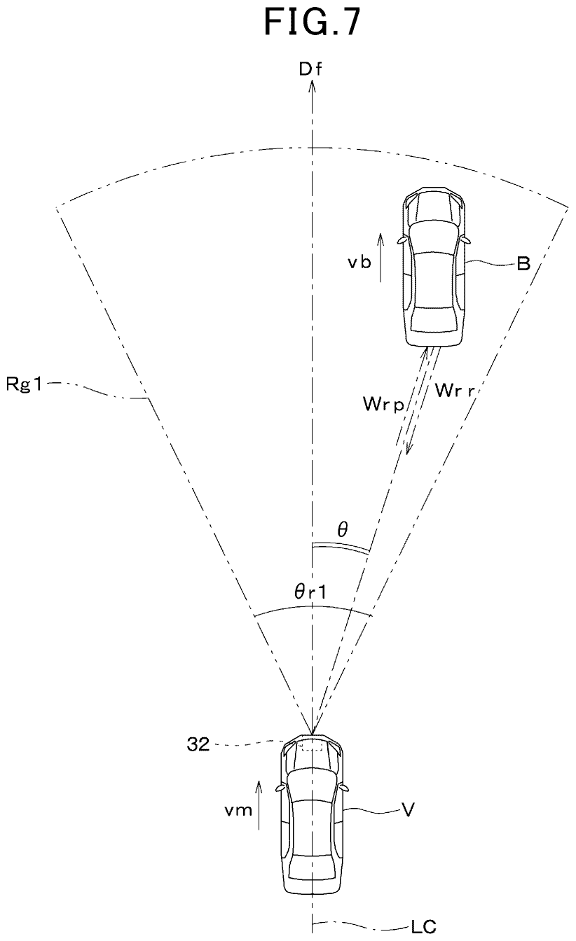

Referring to FIGS. 1 and 2, the radar sensor 32 is configured to transmit millimetric radar waves or sub-millimetric radar waves and receive reflected radar waves to accordingly detect a target object B. The radar sensor 32 of the base embodiment is mounted to the middle of a front portion V11 of the body V1 in the vehicle width direction. The radar sensor 32 is, as illustrated in FIG. 7, a long-range radar having a substantially fan-like radar detection region Rg1 in plan view. The fan-like radar detection region Rg1 has a predetermined detection range from 10 to 250 m inclusive and has a radar scan angle θr1 around a forward movement direction Df of the own vehicle V. The radar sensor 32 is configured as a phased-array radar sensor or a beam-forming radar sensor. The forward movement direction Df represents the direction of a virtual line extending forward from the first center line LC1, and represents the traveling direction of the own vehicle V with a current shift position of a shift lever being set to any position except for the reverse position. The forward movement direction Df of the own vehicle V matches the traveling direction of the own vehicle V when the own vehicle V is moving straight forward, and becomes the direction of a tangent to a travel path of the own vehicle V when the own vehicle V is traveling around a curve.

The radar sensor 32 is configured to emit radar probing waves Wrp, scan the emitted radar probing waves Wrp within the radar scan angle θr1, and receive radar waves Wrr resulting from reflection of the radar probing waves Wrp by a target object B located in the radar detection region Rg1.

Specifically, the radar sensor 32 is comprised of an FMCW radar device equipped with an array antenna, and is configured to detect, based on differences in frequency between the emitted millimeter waves and received millimeter waves and/or differences in phase between the emitted millimeter waves and received millimeter waves, (i) a distance to the target object B therefrom, (ii) an azimuth angle θa of the target object B, (iii) a relative speed of the target object B relative to the own vehicle V. The azimuth angle θa of the target object B is defined as an angle made by a first virtual line generated by extending the first center line LC1 forward the own object V and a second virtual line connecting between the radar sensor 32 and the target object B; the first center line CL1 represents the center line of the radar detection range Rg1.

The relative speed of the target object B relative to the own vehicle V is defined as a difference between a moving speed vb of the target object B and a traveling speed vm of the own vehicle V.

Specifically, the radar sensor 32 is configured to transmit radar probing waves Wrp generated based on a transmission signal having a predetermined modulated frequency, and receive radar waves Wrr resulting from reflection of the radar probing waves Wrp by the target object B to accordingly detect, based on the received radar waves Wrr, received signals that represent frequency characteristics of the received radar waves Wrr. Then, the radar sensor 32 is configured to calculate deviations between the modulated frequency of the transmission signal and the frequencies of the received signals to accordingly generate beat signals based on the respective frequency deviations. The radar sensor 32 is configured to perform first Fourier transform on the beat signals to accordingly calculate a frequency-power spectrum of each of the beat signals. Then, the radar sensor 32 is configured to analyze the frequency-power spectrum of each beat signal to accordingly obtain beat frequencies, and calculate, based on the beat frequencies, a distance of the target object B from the radar sensor 32 and the relative speed of the target object B relative to the own vehicle V.

In addition to the long-range radar sensor 32, a middle-range radar sensor or a short-range radar sensor can be installed in the vehicular system 1. Such a middle-range radar sensor has, for example, a predetermined detection range from 1 to 100 m inclusive, and such a short-range radar sensor has, for example, a predetermined detection range from 15 cm to 30 m.

### Laser-Radar Sensor

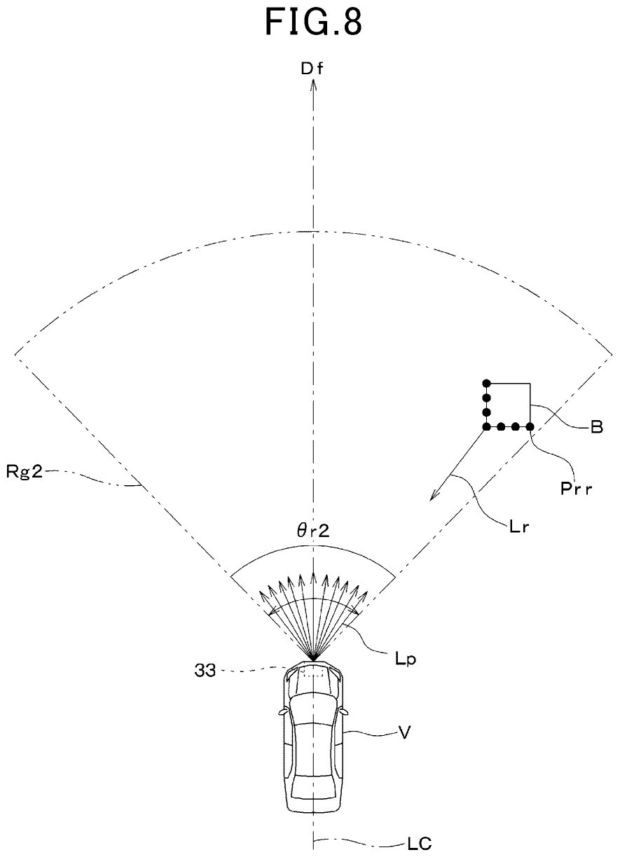

The laser-radar sensor 33 is configured to, as illustrated in FIG. 8, irradiate the outside of the own vehicle V with detection light Lp, i.e., laser light within an infrared frequency band, and receive reflected light Lr resulting from reflection of the detection light Lp by a target object B to accordingly detect the target object B. The laser-radar sensor 33 can also be called LIDAR, which is an abbreviation for Light Detection and Ranging or Laser Imaging Detection and Ranging. The vehicular system 1 of the base embodiment includes, as the laser-radar sensor 33, a long-range laser-radar sensor 33 including a scanning LIDAR. The laser-radar sensor 33 is mounted to, as illustrated in FIG. 1, the middle of the front portion V11 of the body V1 in the vehicle width direction.

The laser-radar sensor 33 has a substantially fan-like LIDAR detection region Rg2 in plan view. The fan-like radar detection region Rg2 has a predetermined radius of, for example, 200 m or more and has a LIDAR scan angle θr2 around the forward movement direction Df of the own vehicle V. The laser-radar sensor 33 is configured to horizontally scan the laser detection light Lp within the LIDAR scan angle θr2 to accordingly detect a target object B located in the LIDAR detection region Rg2.

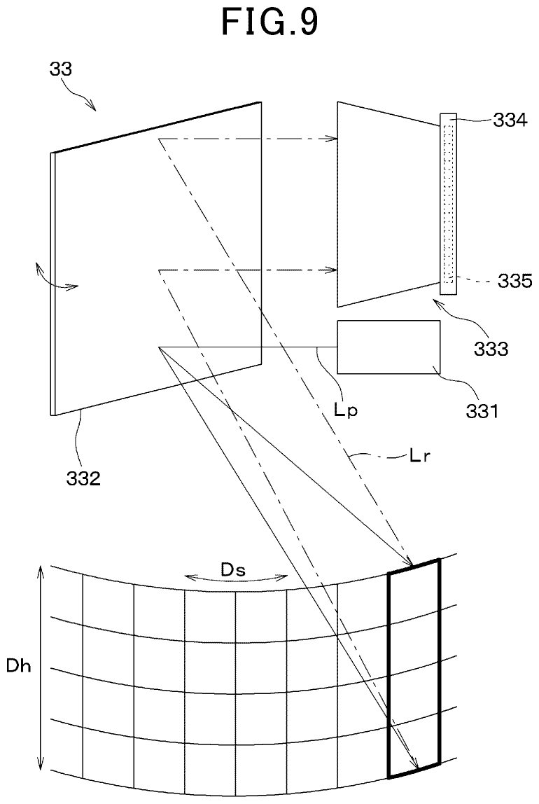

FIG. 9 illustrates a schematic configuration of the laser-radar sensor 33. The laser-radar 33 includes a light emitting unit 331, a scanning unit 332, and a light receiving unit 333.

The light emitting unit 331 is configured to emit the detection light Lp. The scanning unit 332 is comprised of a MEMS mirror unit that includes at least one reflection mirror located on a light pash of the detection light Lp emitted by the light emitting unit 331 and a MEMS mechanism that, for example, rotates the at least one reflection mirror to accordingly change a direction of light reflected by the at least one reflection mirror; MEMS is an abbreviation for Micro Electro Mechanical Systems. Specifically, the scanning unit 332 is configured to electrically control the MEMS mechanism so that the MEMS mechanism rotates the at least one reflection mirror, thus scanning the detection light Lp emitted by the light emitting unit 331 in both a horizontal scanning direction Ds and a vertical scanning direction Dh.

The light receiving unit 333 includes a light receiving sensor 334 that is a two-dimensional image sensor. Specifically, the light receiving sensor 334 is comprised of a plurality of light-receiving elements 335 two-dimensionally arranged in a horizontal direction corresponding to the horizontal scanning direction Ds and a vertical direction corresponding to the vertical scanning direction Dh. Each of the light-receiving elements 335, which is comprised of an Avalanche Photo Diode (APD) or a Single Photon Avalanche Diode (SPAD), is configured to detect a corresponding part of the reflected light Lr resulting from reflection of the detection light Lp by at least one target object B.

The laser-radar sensor 33 is configured to generate, based on the reflected light Lr received by the light receiving unit 333, at least one detection-point data cloud, and detect, based on the at least one detection-point data cloud, the at least one target object B.

The at least one detection-point data cloud represents, like an image, i.e., a frame image, a two-dimensional array of a plurality of LIDAR detection points Prr, which are close to one another, two-dimensionally arranged in the horizontal scanning direction Ds and the vertical scanning direction Dh (see FIG. 9). Each LIDAR detection point Prr, which is arranged to a corresponding light receiving element 335, represents a point of the at least one target object B that is estimated to reflect a part of the detection light Lp; a part of the reflected light Lr received by the corresponding light receiving element 335 corresponds to the part of the detection light Lp. This therefore results in the LIDAR detection points Prr two-dimensionally arranged in the horizontal scanning direction Ds and the vertical scanning direction Dh including positional information and range information on the two-dimensional array. This therefore enables the at least one detection-point data cloud to also be referred to as at least one range-point data cloud.

That is, the laser-radar sensor 33 is configured to detect the at least one detection-point data cloud comprised of the LIDAR detection points Prr two-dimensionally arranged, like a frame image, in the horizontal scanning direction Ds and the vertical scanning direction Dh. This therefore enables the laser-radar sensor 33 to also be referred to as a type of an image sensor.

That is, if there are target objects B, the laser-radar sensor 33 is configured to detect, for each of the target objects B, the detection-point data cloud comprised of the LIDAR detection points Prr two-dimensionally arranged, like a frame image, in the horizontal scanning direction Ds and the vertical scanning direction Dh.

### Camera

Referring to FIGS. 1 and 2, the at least one camera 34 serving as an image sensor is mounted to the own vehicle V. The at least one camera 34 is configured to capture images of a peripheral field of view around the own vehicle V while moving together with the own vehicle V. That is, the at least one camera 34 is configured to generate image information, which will also be referred to as image data, on each captured image around the own vehicle V.

The at least one camera 34 is configured as a digital camera device comprised of an image sensor, such as a Charge Coupled Device (CCD) image sensor or a Complementary Metal Oxide Semiconductor (CMOS) image sensor. The image sensor of the at least one camera 34 is comprised of a plurality of light-sensitive elements, such as photodiodes, which respectively correspond to a plurality of pixels, two-dimensionally arranged in both the vertical direction, i.e., the vehicle height direction, and the horizontal direction, i.e., the vehicle width direction, of the own vehicle V.

The driving information input unit 3 of the base embodiment includes a plurality of cameras, i.e., a front camera CF, a rear camera CB, a left-side camera CL, and a right-side camera CR mounted to the own vehicle V. The front camera CF, rear camera CR, left-side camera CL, and right-side camera CR will also be collectively referred to simply as a camera 34 or cameras 34 if it is unnecessary to identify any of the cameras CF, CR, CL, and CR.

The front camera CF is mounted to a substantially middle of an upper end of the front windshield V18 in the vehicle width direction in the top of the interior V2, and has a front field of view in front of the own vehicle V. That is, the front camera CF is located on the first center line LC1 in plan view. The front camera CF can be mounted to the front portion V11 of the body V1. The front camera CF is configured to capture an image of the front field of view to accordingly acquire information on the captured image of the front field of view.

The rear camera CB is mounted to a substantially middle of a rear end V13 of the body V1 in the vehicle width direction, and has a rear field of view located at the rear of the own vehicle V. The rear camera CR is configured to capture an image of the rear field of view to accordingly acquire information on the captured image of the rear field of view.

The left-side camera CL is mounted to the left door mirror V17, and has a left-side field of view located at the left side of the own vehicle V. The left-side camera CL is configured to capture an image of the left-side field of view to accordingly acquire information on the captured image of the left-side field of view.

The right-side camera CR is mounted to the right door mirror V17, and has a right-side field of view located at the right side of the own vehicle V. The right-side camera CR is configured to capture an image of the right-side field of view to accordingly acquire information on the captured image of the right-side field of view.

The image captured by each camera 34 is comprised of two-dimensionally arranged pixels respectively corresponding to the two-dimensionally arranged light-sensitive elements of the corresponding camera 34.

The driving ECU 2 can recognize a target object B based on the images captured by any camera 34, i.e., determine, based on the images captured by any camera 34, at least a location of a target object B and a type of the target object B.

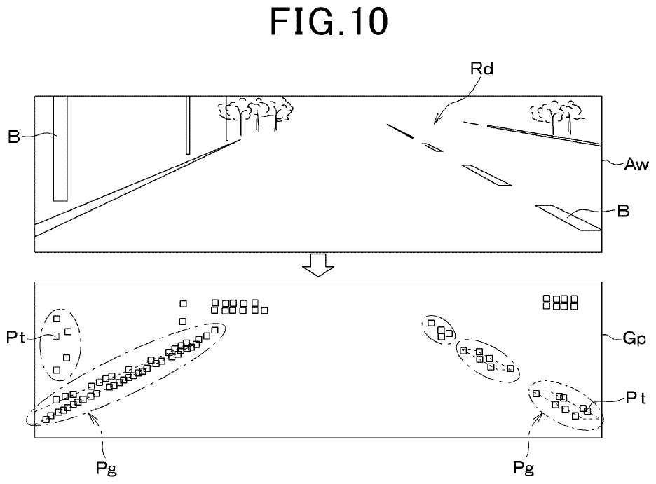

FIG. 10 illustrates an example of how the driving ECU 2 recognizes target objects B included in the front field of view in accordance with an image of the front field of view captured by the front camera CF; the front field of view includes a road Rd in front of the own vehicle V. In the specification, reference character Rd is assigned to any road for the sake of convenience, but roads to which the same reference character Rd are assigned may not necessarily represent the same road.

Specifically, the driving ECU 2 sets, in a captured image, a detection region Aw. The detection region Aw represents a part or a whole of an entire region of the captured image, i.e., an entire view-angle region of the front camera CF. Then, the driving ECU 2 acquires, based on pixel feature parameters of the image data included in the detection region Aw, a feature-point image Gp. The pixel feature parameters of the image data represent feature parameters of each pixel constituting the image data based on corresponding received light, and can include, for example, a luminance, a contrast, and a hue of each pixel of the image data. The luminance of each pixel can be referred to as the brightness of the corresponding pixel, and the hue of each pixel can be referred to as the chroma of the corresponding pixel.

The feature-point image Gp is comprised of feature points Pt two-dimensionally arranged in the horizontal direction and the vertical direction like a frame image; each of the feature points Pt is extracted from the image data included in the detection region Aw based on, for example, the difference and/or change gradient between a corresponding adjacent pair of the pixels of the image data. The feature points Pt characterize the shape of a target object B included in the detection region Aw of a captured image. In other words, the feature points Pt are characteristic points, i.e., characteristic pixels, of the image data included in the detection region Aw.

The driving ECU 2 performs a pattern matching task of matching one or more feature-point clouds Pg, each of which is an assembly of the corresponding feature points Pt, with predetermined patterns stored therein to accordingly identify, for each of the feature-point clouds Pg, the type of a corresponding one of the target objects B based on the corresponding one of the feature-point clouds Pg.

Various methods of extracting, from the image data included in the detection region Aw, the feature points Pt have been well known. For example, an extraction method using Sobel filter, an extraction method using Laplacian filter, an extraction method using a Canny algorithm can be used to extract, from the image data included in the detection region Aw, the feature points Pt. Therefore, detailed descriptions of one of the well-known extraction methods used in the specification are omitted. Extraction of the feature points Pt from the image data included in the detection region Aw can be expressed as detection of the feature points Pt from the image data included in the detection region Aw.

The driving ECU 2 can estimate a relative position of the recognized target object B relative to the own vehicle V and/or a distance, i.e., a range, of the recognized target object B relative to the own vehicle V.

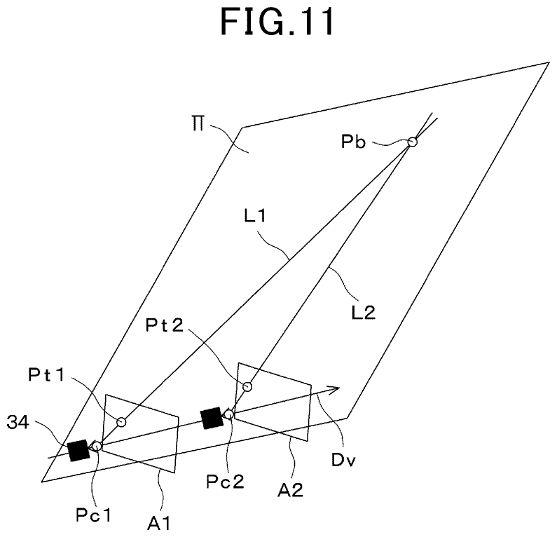

FIG. 11 illustrates an example where the driving ECU 2 calculates an estimated point Pb as an estimation result of three-dimensional positions of each feature point Pt corresponding to a target object B using, for example, a monocular motion stereo method, in other words, a Structure from Motion (SFM) method. The present disclosure can calculate the estimated point Pb as the estimation result of the three-dimensional positions of each feature point Pt corresponding to a target object B using a selected one of the other calculation methods. That is, each camera 34 can be configured as a compound-eye stereo camera.

Let us assume that, as illustrated in FIG. 11, the camera 34 is moving, together with the own vehicle V, toward the own-vehicle movement direction Dv of the own vehicle V. The position of the camera 34 at time t1 will be referred to as a first camera position Pc1, and the position of the camera 34 at time t2 after the time t1 will be referred to as a second camera position Pc2. A first captured image A1 is an image captured by the camera 34 at the first camera position Pc1, and a second captured image A2 is an image captured by the camera 34 at the second camera position Pc2.

A first feature point Pt1 is a feature point Pt extracted from the first captured image A1, and a second feature point Pt2, which is extracted from the second captured image A2, is estimated correspond to the first feature point Pt1 at the time t1. That is, the second feature point Pt2 is a point to which a point on the target object B corresponding to the first feature point Pt1 is estimated to have moved for an elapsed time (t2−t1) from the time t1 to the time t2. The driving ECU 2 can determine whether the first feature point Pt1 and the second feature point Pt1 are based on the same point on the target object B, i.e., the first feature point Pt1 on the target object B corresponds to the second feature point Pt2 thereon, using one of well-known methods, such as an optical-flow method. Then, the driving ECU 2 defines a first line L1 passing through the first camera position Pc1 and the first feature point Pt1 and a second line L2 passing through the second camera position Pc2 and the second feature point Pt2, and calculates a point of intersection of the first and second lines L1 and L2 as the estimated point Pb. The estimated point Pb represents, in a three-dimensional coordinate system defined relative to the own vehicle V, a point on the target object B, which corresponds to both the first feature point Pt1 and the second feature point Pt2. If the estimated point Pb is a stationary point, the estimated point Pb satisfies epipolar constraint. The epipolar constraint is an epipolar-geometric constraint that the first camera position Pc1, the second camera position Pc2, and the estimated point Pb lie on the same plane II at any time t1 or t2.

### Various Sensors

Referring to FIGS. 1 and 2, the operation sensors 35 are each provided in the own vehicle V for outputting a parameter indicative of a corresponding driver's operated state of the own vehicle V. The parameters to be outputted from the respective operation sensors 35, each of which represents the corresponding driver's operated state of the own vehicle V, may for example include (i) a driver's operated quantity of an accelerator pedal of the own vehicle V, (ii) a driver's operated quantity of a brake pedal of the own vehicle V, (iii) a driver's set current shift position of the shift lever, (iv) a driver's operated steering angle of the steering wheel V24, and (v) a driver's applied steering torque of the steering wheel V24. That is, the operation sensors 35 include known sensors including, for example an accelerator-pedal sensor, a brake-pedal sensor, a shift-position sensor, a steering-angle sensor, and a steering-torque sensor. That is, these known sensors are collectively referred to as the operation sensors 35 for the sake of simple illustration and simple descriptions. The operation sensors 35 can include a steering-wheel sensor for detecting information indicative of whether the driver D grasps the steering wheel V24.

The behavior sensors 36 are each provided in the own vehicle V for outputting a parameter indicative of a corresponding drive behavior of the own vehicle V. The parameters to be outputted from the respective behavior sensors 36, each of which represents the corresponding behavior of the own vehicle V, may for example include (i) a speed of the own vehicle V, (ii) a yaw rate of the own vehicle V, (iii) an acceleration of the own vehicle V in the longitudinal direction, and (iv) an acceleration of the own vehicle V in the vehicle width direction. That is, the behavior sensors 36 include known sensors including, for example a vehicle speed sensor, a yaw-rate sensor, and acceleration sensors. That is, these known sensors are collectively referred to as the behavior sensors 36 for the sake of simple illustration and simple descriptions.

### Driver-State Monitor

Referring to FIGS. 1, 2, 12, and 13, the driver-state monitor 37 is configured to sequentially capture images of the driver D, and sequentially detect driver's state parameters representing the driver's states based on the captured images of the driver D. The driver's conditions include, for example, information indicative of whether the driver D is in an awake state.

Specifically, the driver-state monitor 37 includes a driver monitor camera having a predetermined field of view; the driver monitor camera is located in the interior V2 such that at least the head D1 of the driver D2 who is sitting on the driver's seat V23 lies within the field of view of the driver monitor camera. This enables the driver monitor camera to capture, from the front, images of the face D2 of the driver D. The driver monitor camera can be configured as a near-infrared camera.

The driver-state monitor 37 includes an image processing unit configured to perform image-processing tasks on the images captured by the driver monitor camera to accordingly detect the driver's state parameters.

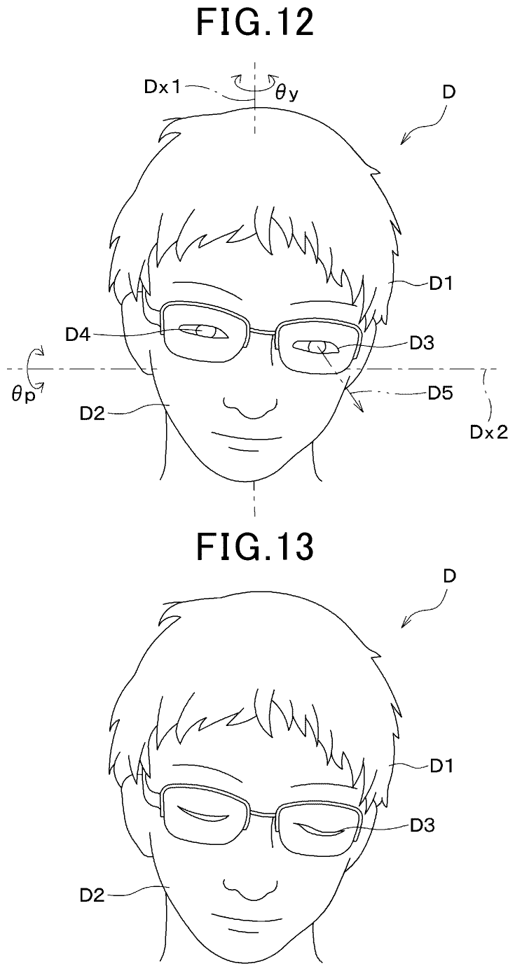

The driver's state parameters to be detected by the driver-state monitor 37 for example include, as illustrated in FIGS. 12 and 13, (i) the direction of the face D2 of the driver D, (ii) the degree of opening of each driver's eye D3, and (iii) the position of each pupil D4 of the driver D. The direction of the face D2 of the driver D is defined by a yaw angle θy and a pitch angle θp of the face D2 of the driver D. The yaw angle θy represents a rotational angle of the face D2 of the driver D around a vertical axis Dx1 extending vertically through the head D1 of the driver D. When the face D2 of the driver D faces the front, the yaw angle θy is 0°. That is, the yaw angle θy becomes a corresponding positive degree when the face D2 of the driver D faces to the left relative to the front, and becomes a corresponding negative degree when the face D2 of the driver D faces to the right relative to the front.

The pitch angle θp represents a rotational angle of the face D2 of the driver D around a horizontal axis Dx2 extending horizontally through the face D2 of the driver D. When the face D2 of the driver D faces the front, the pitch angle θp 0°. That is, the pitch angle θp becomes a corresponding positive degree when the face D2 of the driver D faces upward relative to the front, and becomes a corresponding negative degree when the face D2 of the driver D faces downward relative to the front.

FIG. 12 is an example of an image captured by the driver-state monitor 37 in which the driver D is in the awake state, and FIG. 13 is an example of an image captured by the driver-state monitor 37 in which the driver D is not in the awake state. FIGS. 12 and 13 show that the driver's state parameters of (i) the direction of the face D2 of the driver D, (ii) the degree of open of each driver's eye D3, and (iii) the position of each pupil D4 of the driver D enable the driving ECU 2 to detect the driver's states including, for example, (i) information about whether the driver D is in the awake state and (ii) information about the driver's line of sight D5.

### Operation Switches

Referring to FIGS. 1 and 2, the operation switches 38 are various switches that can be operated by the driver E when the driver E is driving the own vehicle E, and are provided at predetermined positions in the interior V2. Each of the operation switches 38 is a switch whose operated quantity and operated state are exempted from being detected by the operation sensors 35. Specifically, the operation switches 38 for example include an ignition switch 381, a blinker switch 382, and one or more AD/ADAS switches 383. The ignition switch 381, which can be called a start switch or a power switch, is a switch for activating or deactivating the system-installed vehicle V, i.e., the vehicular system 1. The blinker switch 382 is configured to detect a driver's operated state of a blinker lever of the own vehicle V. The AD/ADAS switches 383 are switches that enable the driver E, when operating them, to input, to the driving ECU 2, various instructions related to the driving assistance or the autonomous driving of the own vehicle V; the various instructions related to the driving assistance or the autonomous driving of the own vehicle V include, for example, a start instruction, a stop instruction, a level setting instruction, and a function selection instruction.

The locator 39 is configured to acquire highly accurate position information, which will also be referred to as complex position data, on the own vehicle V. Specifically, the locator 39 is configured as a complex positioning system for acquiring the complex position data of the own vehicle V, and is comprised of a GNSS receiver 391, an inertia detector 392, and a locator ECU 393.

The GNSS is an abbreviation for Global Navigation Satellite System, and the highly accurate position information on the own vehicle V is positional information on the own vehicle V, which has at least a position accuracy usable by the advanced driving assistance in the SAL level 2 or more, in other words, a position accuracy with an error of lower than or equal to 10 cm. As the locator 39, a commercially available positioning system, such as a POSLV system for land vehicles, in other words, a positioning azimuth system for land vehicles, manufactured by Applanix Corporation, can be used.

The GNSS receiver 391 can be configured to receive the navigation signals transmitted from at least one positioning satellite, that is, at least one artificial satellite. In particular, the GNSS receiver 391 is configured to be able to receive receiving the navigation signals from a positioning satellite included in at least one GNSS selected from the GPS, the QZSS, the GLONASS, the GLONASS, the Galileo, the IRNSS, and the Beidou Navigation Satellite System. GPS is an abbreviation for Global Positioning System, QZSS is an abbreviation for Quasi-Zenith Satellite System, GLONASS is an abbreviation for Global Navigation Satellite System, and IRNSS is an abbreviation for Indian Regional Navigation Satellite System.

The inertia detector 392 is configured to detect (i) linear accelerations acting on the own vehicle V in respective three axes corresponding to the vehicle longitudinal direction, the vehicle width direction, and the vehicle height direction, and (ii) angular velocities acting on the own vehicle V around the respective three axes. For example, the locator 39 has a substantially box-shaped housing, and an inertia detector 392 is comprised of a three-axis accelerometer and a three-axis gyro sensor installed in the housing.

The locator ECU 393 includes a vehicular microcomputer comprised of a CPU, a ROM, a RAM, an input/output (I/O) interface, and other peripheral devices. The locator ECU 393 is configured to sequentially determine the current position and/or the current azimuth of the own vehicle V in accordance with the navigation signals received by the GNSS receiver 391 and the linear accelerations and angular velocities detected by the inertia detector 392.

### Vehicular Communication Module

The vehicular communication module 4, which will also be referred to as a DCM 4, can be configured to communicate information with base stations located around the own vehicle V using wireless communications that are compliant with a predetermined communication standard, such as Long Term Evolution (LTE) or 5th Generation (5G).

Specifically, the vehicular communication module 4 is configured to acquire traffic information, such as traffic-jam information, from probe servers and/or predetermined databases in a cloud computing environment. The traffic-jam information includes, for example, the location and the length of at least one traffic-jam section. Specifically, the traffic-jam information includes, for example, various information items about at least one traffic-jam section, such as the head of the at least one traffic-jam section, the tail of the at least one traffic-jam section, an estimated length of the at least one traffic-jam section, and an estimated time for the at least one traffic-jam section. The traffic information will also be referred to as road traffic information.

Additionally, the vehicular communication module 4 is configured to retrieve, from at least one of the probe servers, latest HD map information, and store the HD map information in the HD map database 5.

### HD Map Database

The HD map database 5 is comprised of mainly one or more nonvolatile rewritable memories, and is configured to store the HD map information to be rewritable while holding the stored HD map information even if power supplied to the HD map database 5 is shut off. The HD map information will also be referred to as HD map data.

The HD map information includes higher-definition map information than map information stored in a standard (SD) map database 601 of the navigation system 6. That is, the higher-definition map information has a positional error lower than or equal to an error of approximately several meters of the map information stored in the SD map database 601.

Specifically, the HD map information database 5 stores, as the HD map information, for example, map information available by the advanced driving assistance or the autonomous driving, that includes, for example, (i) information about three-dimensional road shapes, (ii) information about the number of lanes in each road, and (iii) information about road traffic regulations. The HD map information is stored in the HD map information database 5 to be in conformity with a predetermined standard, such as ADASIS.

### Navigation System

The navigation system 6 is configured to calculate a scheduled travel route from the current position of the own vehicle V to a destination. The navigation system 6 of the base embodiment is configured to calculate the scheduled travel route based on (i) the destination inputted by, for example the driver D through, for example, the HMI system 7, (ii) the HD map information stored in the HD map database 5 or the SD map information stored in the SD map database 601, and (iii) the position information on the own vehicle V, such as the current position and the current azimuth of the own vehicle V. The navigation system 6 is additionally configured to provide various information including the scheduled travel route to one or more selected components of the vehicular system 1, such as the driving ECU 2 and/or the HMI system 7, through the vehicular communication network 10. That is, the navigation system 6 is capable of instructing the HMI system 7 to sequentially display navigation images that show, for example, maps on which the current position of the own vehicle V and the scheduled travel route respectively appear.

### HMI System

The HMI system 7 is designed as a vehicular HMI system, and is configured to implement information communications between the own vehicle V and one or more occupants including the driver D of the own vehicle V.

Specifically, the HMI system 7 is configured to provide, i.e., display, various information items at least visibly to the one or more occupants, and enable occupant's input on information input relative to the provided information items. The various information items to be provided to the one or more occupants include, for example, various guide information items, information items on input-operation guidance, notification of inputted information, and/or warnings.

The HMI system 7 is typically comprised of I/O components mounted to the steering wheel V24 or installed in the dashboard V21, which is so-called “dashboard HMI”. At least one of the I/O components of the HMI system 7 can be mounted to at least one portion in the interior V2 except for the dashboard V21, such as the cell in the interior V2 or a center console located between the driver's seat V23 and the passenger's seat V22 adjacent to the driver's seat V23.

The HMI system 7 includes an HMI control unit (HCU) 701, a meter panel 702, a main display device 703, a head-up display 704, a speaker 705, and operation devices 706.

The HCU 701 includes a vehicular microcomputer comprised of a CPU, a ROM, a RAM, an input/output (I/O) interface, and other peripheral devices. The HCU 701 is configured to perform overall control of display output and/or audible output through the HMI system 7. That is, the HCU 701 is configured to control operations of each of the meter panel 702, the main display device 703, the head-up display 704, and the speaker 705.

The meter panel 702 is installed in the dashboard V21 to be arranged to face the driver's seat V23. The meter panel 702 is configured to display metered values including, for example, the speed of the own vehicle V, the temperature of the coolant, and the fuel level. The meter panel 702 is additionally configured to display various information items including, for example, the current date and time, the outside temperature, the receivable radio broadcasts.

The main display device 703, which is also called a center information display (CID) device, is installed in the middle of the dashboard V21 in the vehicle width direction, which enables the one or more occupants to visibly recognize information displayed thereon.

The main display device 703 has a housing and a screen installed in the housing, and can be configured to successively display, on the screen, the navigation images generated by the navigation system 6, which show, for example, maps on which the current position of the own vehicle V and the scheduled travel route respectively appear. The main display device 703 can be additionally configured to display, on the screen, various information and contents different from the navigation images. For example, the main display device 703 can be configured to display a drive-mode setting image on which icons of plural driving modes are selectably displayed; the plural driving modes include a comfort drive mode, a normal driving mode, a sport driving mode, and a circuit drive mode. The main display mode 703 is moreover configured to display, on the screen, a second-task image on which icons of plural second tasks are selectably displayed; the second tasks, which are other than the driving tasks of the own vehicle V, are usable by the driver D during the autonomous driving of the own vehicle V. For example, the secondary tasks include (i) a task of reading digital books, (ii) a task of operating a mobile communication terminal, and (iii) a task of watching video contents, such as movies, concert videos, music videos, or television broadcasts. The second tasks can be called secondary activities or other tasks.

Referring to FIGS. 1, 2, 14, and 15, the head-up display 704 is configured to display a virtual image M including letters, figures, and/or characters in the driver's forward view. The head-up display 704 of the base embodiment is configured to project the virtual image M in front of the driver D using AR technologies to accordingly superimpose the virtual image M on the forward scenery including the road surface FR located on the traveling course of the own vehicle V; AR is abbreviated for Augmented Reality. The task of superimposing the virtual image M on the forward scenery can display information included in the virtual image M, which is related to at least one focusing target included in the forward scenery, to be positionally linked to the at least one focusing target.

For example, the task of superimposing the virtual image M on the forward scenery can display the information included in the virtual image M while superimposing the information on the at least one focusing target, or display the information included in the virtual image M while being adjacent to the at least one focusing target. The at least one focusing target is, for example, at least one target object on which the driver D driving the own vehicle V should focus, i.e., to which the driver D driving the own vehicle V should pay attention. The at least one focusing target includes, for example, a road-surface marking (a road marking), a road sign, a forward vehicle, and/or a pedestrian. For example, the head-up display 704 can be configured to superimpose the scheduled travel route, a traveling direction of the own vehicle V, traffic information, and other similar information on a forward road surface FR as the focusing target.

An area on the front windshield V18 on which the virtual image M is projected will be referred to as a projection area AP.

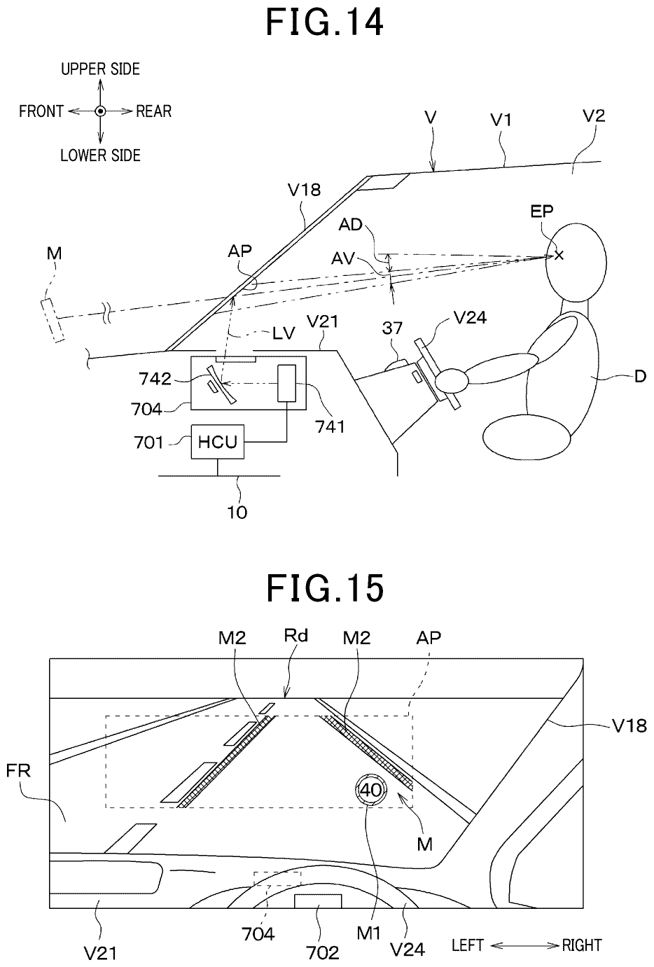

The head-up display 704 has, as illustrated in FIG. 14, a depression angle AD of, for example, a positive degree more than 0°. The depression angle AD of the head-up display 704 is defined, in for example side view illustrated in FIG. 14, as an angle formed between a virtual horizontal plane passing through the eyepoints EP of the driver D and a virtual plane passing through the eyepoints EP of the driver D and a top edge of the projection area AP. The depression angle AD becomes a positive value when the eyepoints EP look down the top edge of the projection area AP, or becomes a negative value when the eyepoints EP look up the top edge of the projection area AP.

The head-up display 704 has a vertical angle of view AV and a horizontal angle of view, and the vertical angle of view AV defines a vertical width of the projection area AP, and the horizontal angle of view defines a horizontal width of the projection area AP. The horizontal angle of view being set to be greater than the vertical angle of view AV results in the projection area AP having a substantially rectangular shape. The vertical angle of view AV can be defined, in for example left side view illustrated in FIG. 14, as an angle formed between the virtual line passing through the left eyepoint EP of the driver D and the top edge of the projection area AP and a virtual line passing through the left eyepoint EP of the driver D and a bottom edge of the projection area AP. That is, the virtual angle of view AV represents an angular range in the vertical direction within which the left eyepoint EP can view the virtual image M, which can be called a vertical view angle in the vertical direction.

The head-up display 704 includes, as illustrated in FIG. 14, a projector 741 and a magnifying optical system 742. The projector 741 is configured to generate, based on a display image signal generated by the HCU 701, a light-based image LV, and emit the light-based image to the magnifying optical system 742. The magnifying optical system 742 includes a plurality of optical components including a concave mirror, and an actuator configured to control the alignment of the optical components. The magnifying optical system 742 is configured to project, using the optical components, a magnified image of the light-based image LV onto the front windshield V18 while controlling, through the actuator, the alignment of the optical components based on the location of the eyepoints EP detected by the driver-state monitor 37 to accordingly adjust the projected state of the magnified image onto the front windshield V18. This results in the magnified image based on the light-based image LV being projected in the projection area AP of the front windshield V18. This enables the driver D to visibly recognize the virtual image M based on reflected light of the magnified image projected in the projection area AP of the front windshield V18.

FIG. 15 illustrates an example of the virtual image M. The virtual image M for example is comprised of a transparent base image, one or more information contents M1 contained in the transparent base image, and one or more graphic contents M2 contained in the transparent base image. The one or more information contents M1 are information contents displaying, for example, the maximum speed limit for a road Rd in which the own vehicle V is traveling, the current speed of the own vehicle V, the distance to the destination, an estimated arrival time to the destination, and the name of at least one building appearing in the forward scenery. The one or more graphic contents M2 are graphic contents indicative of lines and/or arrows, which are used to display information indicative of (i) the traveling direction of the own vehicle V and (ii) selection of lanes.

The head-up display 704 can be configured to display the virtual image M containing superimposed contents and non-superimposed contents. The superimposed contents are image contents linked to one or more specific focusing targets included in the forward scenery and superimposed on the one or more specific focusing targets. In contrast, the non-superimposed contents are image contents that are not linked to the one or more specific focusing targets included in the forward scenery and are not superimposed on the one or more specific focusing targets.

In the virtual image M illustrated as an example in FIG. 15, linear graphic contents, which are an example of the graphic contents M2, are superimposed on a lane on which the own vehicle V is traveling, and an information content indicative of the maximum speed limit for the current road of the own vehicle V, which is an example of the information contents M1, is located at a predetermined position of the virtual image M while being not superimposed on the graphic contents M2.

The HMI system 7 described above serves as a notifying unit for notifying information of the one or more occupants including the driver D in the own vehicle V.

Referring to FIGS. 1 and 2, the speaker 705 is configured to output voice related to information indicated by each of the meter panel 702, the main display device 703, and the head-up display 704. The speaker 705 can be configured to output voice, such as music and/or radio sound, which are not related to the information indicated by each of the meter panel 702, the main display device 703, and the head-up display 704.

The operation devices 706 are input devices that are not included in the operation switches 38, and operated quantities and operated states of the operation devices 706 are exempted from being detected by the operation sensors 35. Specifically, the operation devices 706 include, for example, switches mounted to the housing of the main display device 703 around the screen, and a transparent touch panel mounted to cover the screen of the main display device 703. The operation devices 703 may include switches mounted to a spoke of the steering wheel V24, and pointing devices, such as a touch panel, mounted to the center console.

The switches, pointing devices, and the touch panel of the operation devices 706 enable the one or more occupants, who are operating them, to enter various information items respectively corresponding to the switches, pointing devices, and touch panel.

The lighting system 8 includes a body ECU 801, headlamps 802, and blinkers 803.

The body ECU 801 includes a vehicular microcomputer comprised of a CPU, a ROM, a RAM, an input/output (I/O) interface, and other peripheral devices. The body ECU 801 is configured to control how the headlamps 802 light up in accordance with information inputted from the driving ECU 2 and/or the driving information input unit 3, and control how the blinkers 803 light up in accordance with information inputted from the driving ECU 2 and/or the driving information input unit 3, in particular information inputted from the blinker switch 382.

The motion control system 9 is configured to control motions of the own vehicle V, i.e., traveling behaviors of the own vehicle V, in accordance with information inputted by the driving ECU 2 and/or the driving information input unit 3.

Specifically, the motion control system 9 includes, for example, a drive system 91, a shift system 92, a brake system 93, and a steering system 94.

The drive system 91 includes a drive ECU 911 and a driving mechanism 912. The drive ECU 911 includes a vehicular microcomputer comprised of a CPU, a ROM, a RAM, an input/output (I/O) interface, and other peripheral devices. The drive ECU 911 is configured to receive, from the accelerator-pedal sensor or the driving ECU 2, an accelerator signal indicative of an acceleration request, and control operations of the drive mechanism 912 in accordance with the acceleration request. The drive mechanism 912 is configured to generate drive power that causes the system-installed vehicle V to travel. Specifically, the drive mechanism 912 includes an engine, i.e., an internal combustion engine, and one or more motors. That is, the system-installed vehicle V is any one of a gasoline-fueled vehicle, a diesel engine vehicle, a biofuel vehicle, a hydrogen engine vehicle, a hybrid vehicle, a battery electric vehicle (BEV), a fuel-cell vehicle, or other vehicles.

The shift system 92 includes a shift ECU 921 and a shift mechanism 922. The shift ECU 921 includes a vehicular microcomputer comprised of a CPU, a ROM, a RAM, an input/output (I/O) interface, and other peripheral devices. The shift ECU 921 is configured to receive, from the shift position sensor, a shift position signal indicative of the current shift position set by the shift lever or the driving ECU 2, and control operations of the shift mechanism 922 in accordance with the current shift position of the shift lever. The shift mechanism 922 is provided between the driving wheels of the wheels V3 and the drive mechanism 912 and includes an automatic transmission. Specifically, the shift ECU 921 is configured to control, in accordance with the shift position signal indicative of the current shift position set by the shift lever or the driving ECU 2, the shift mechanism 922 to perform (i) a first task of causing forward drive power generated by the drive mechanism 912 to transmit to the driving wheels for forward traveling of the own vehicle V, (ii) a second task of causing reverse drive power generated by the drive mechanism 912 to transmit to the driving wheels for rearward traveling of the own vehicle V, (iii) a third task of shutting off the drive power to the driving wheels to accordingly stop the own vehicle V, and/or (iv) a fourth task of changing a speed ratio between an input speed from the drive mechanism 912 to the shift mechanism 922 and an output speed outputted from the shift mechanism 922 to the driving wheels in forward movement of the own vehicle V. The shift system 92 can be configured as so-called shift-by-wire configuration.

The brake system 93 includes a brake ECU 931 and a brake mechanism 932. The brake ECU 931 includes a vehicular microcomputer comprised of a CPU, a ROM, a RAM, an input/output (I/O) interface, and other peripheral devices. The brake ECU 931 is configured to receive, from the brake-pedal sensor or the driving ECU 2, a braking signal indicative of a braking request, and control operations of the brake mechanism 932 in accordance with the braking request. The brake mechanism 932 includes a friction mechanism for each of the wheels V3. That is, the brake ECU 931 is configured to control, in accordance with the braking request, the friction mechanism for each wheel V3 to accordingly apply friction to each wheel V3, resulting in the own vehicle V being slowed down. The brake mechanism 932 can include a regenerative brake mechanism configured to rotate, by the kinetic energy of the own vehicle V, the driving wheels to accordingly slow down the own vehicle V due to load of the rotation of the driving wheels, and convert the kinetic energy of the own vehicle V into electrical power. The brake system 93 can be configured as so-called brake-by-wire configuration.

The steering system 94 includes a steering ECU 941 and a steering mechanism 942. The steering ECU 941 includes a vehicular microcomputer comprised of a CPU, a ROM, a RAM, an input/output (I/O) interface, and other peripheral devices. The steering ECU 941 is configured to receive, from the steering-angle sensor or the driving ECU 2, a steering signal indicative of a steering request, and control operations of the steering mechanism 942 in accordance with the steering request. That is, the steering ECU 941 is configured to control, in accordance with the steering request, the steering mechanism 942 to change the direction of each steered wheel, for example, each front wheel V3a, V3b, to accordingly change the traveling direction of the own vehicle V. The steering mechanism 942 can be configured to change the direction of each of the front and rear wheels V3a, V3b, V3c, and V3d. That is, the own vehicle V can be configured as a four-wheel steering vehicle. The steering system 94 can be configured as so-called steering-by-wire configuration.

### Driving Control Based on Identification Results of at Least One of the ADAS Sensors 31 to 34

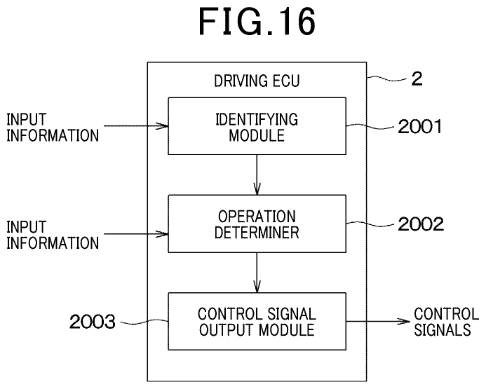

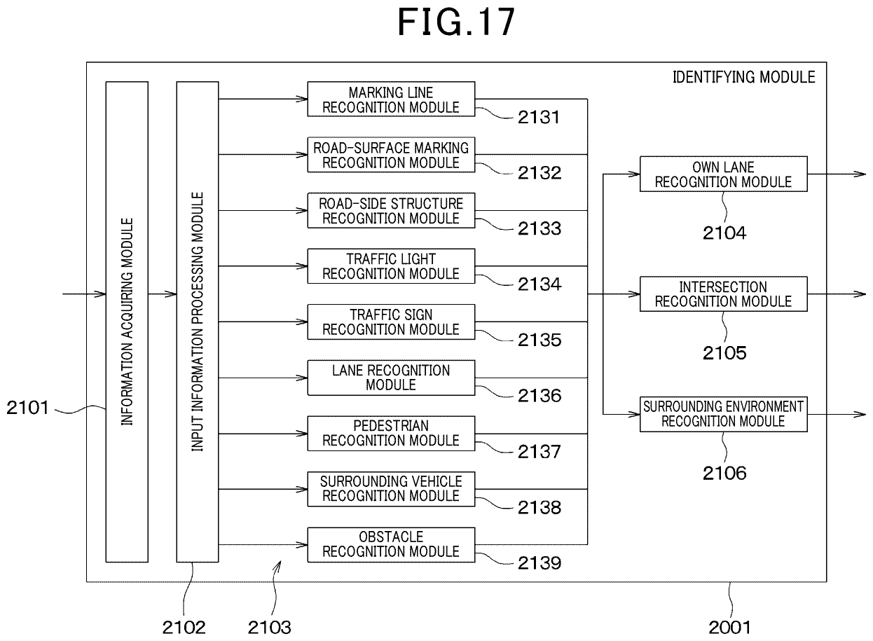

FIGS. 16 and 17 schematically illustrate an example of functions implemented by the driving ECU 2. That is, the processor 21 executes the program instructions stored in the memory device 22 to accordingly implement the functions illustrated in FIGS. 16 and 17.

The following describes a summary of the autonomous driving of the own vehicle V carried out by the driving ECU 2 based on identification results of at least one of the ADAS sensors 31 to 34 around the own vehicle V.

Note that, in the base embodiment, “identification” conceptually includes “detection”, “classification”, and “recognition” or “perception”. Detection is to find a target object B based on at least one detection-point data cloud and/or images captured by the cameras 34. Detection of a target object B is to determine that there is a target object B, and not to identify the shape and/or attribute of the target object B. Classification of a target object B is to classify the shape and/or the attribute of the detected target object B into one of various object types, such as “humans”, “vehicles”, “buildings”, and so on. In other words, a classified target object is a target object that has been detected and classified into one of the various object types. Recognition or perception of a target object B is to determine whether the detected and classified target object B should be considered in driving control of the own vehicle V.

Detection of an object can include sensing of an object. Detection can conceptually include classification and/or recognition (perception), classification can conceptually include detection and/or recognition (perception), and recognition can conceptually include detection and classification.

Referring to FIG. 16, the driving ECU 2 includes, as functional components implemented by the processor 21, an identifying module 2001, an operation determiner 2002, and a control signal output module 2003.

The identifying module 2001 is operative to perform an identifying task for one or more target objects B around the own vehicle V in accordance with information items inputted from the surrounding monitor sensors 31 to 34, the operation sensors 35, and the behavior sensors 36. The operation determiner 2002 is operative to determine, based on an identified result of the identifying module 2001 and the information items inputted from the operation sensors 35 and the behavior sensors 36, one or more control tasks that are required at present to control the own vehicle V. The one or more control tasks for example include a collision avoiding task, an emergency stop task, and a warning task for the driver D.

The control signal output module 2003 is operative to output control signals based on the determined control tasks to selected components of the vehicular system 1. The control signals include, for example, a signal indicative of the steering signal indicative of a steering amount, the braking signal indicative of the amount of braking, and a message code signal indicative of a warning message.

Referring to FIG. 17, the identifying module 2001 includes an input information acquiring module 2101, an input information processing module 2102, a target object recognition module 2103, an own lane recognition module 2104, an intersection recognition module 2105, and a surrounding environment recognition module 2106.

The information acquiring module 2101 acquires the information items inputted from the surrounding monitor sensors 31 to 34, the operation sensors 35, and the behavior sensors 36, and holds the acquired information items in a sequential order. The input information processing module 2102 applies one or more predetermined tasks, such as a noise removal task and/or a coordinate conversion task, to the information items held in the information acquiring module 2101.

The target object recognition module 2103 is operative to perform a target object recognition task in accordance with the information items subjected to the predetermined tasks.

Specifically, the target object recognition module 2103 includes, for example, a marking line recognition module 2131, a road-surface marking recognition module 2132, a road-side structure recognition module 2133, a traffic light recognition module 2134, a traffic sign recognition module 2135, a lane recognition module 2136, a pedestrian recognition module 2137, a surrounding vehicle recognition module 2138, and an obstacle recognition module 2139.

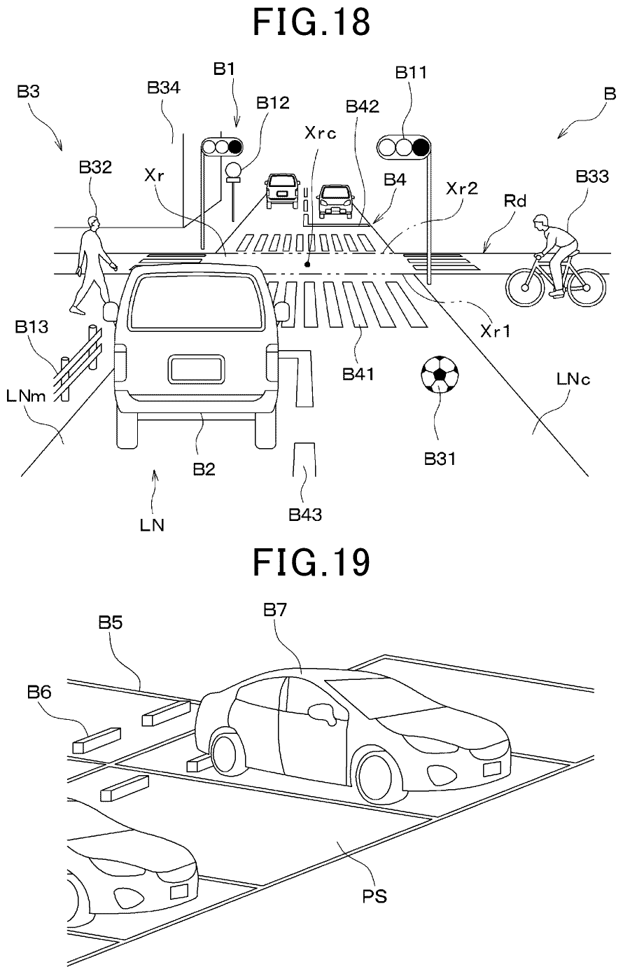

Target objects B to be recognized by the identifying module 2001 are illustrated as examples in FIG. 18 or FIG. 19.

Referring to FIG. 18, target objects B broadly include, for example, traffic-related three-dimensional objects B1, other vehicles B2, general three-dimensional objects B3, and road-surface markings B4. The target objects B to be recognized by the identifying module 2001 additionally include, as illustrated in FIG. 19, parking-slot segment lines B5, wheel stoppers B6, and parked vehicles B7, which are related to detection of the parking slots PS and/or execution of parking assistance. The parking-slot segment lines B5 are for example painted lines to define the shape and area of each parking slot PS. Each of the wheel stoppers B6 is a block-like solid installed in each parking space PS to stop wheels of a corresponding parked vehicle B7. Each of the parked vehicles B7 is a vehicle parked in the corresponding parking slot PS.

The traffic-related three-dimensional objects B1 are three-dimensional objects, such as traffic lights B11 and traffic signs B12, used for road-traffic safety. Each of the other vehicles B2 may become a target vehicle that the traveling own vehicle V tracks or an obstacle for the traveling own vehicle V, so that the parked vehicles B7 are excluded from the other vehicles B2. The general three-dimensional objects B3 are solid objects except for the traffic-related three-dimensional objects B1, the other vehicles B2, the wheel stoppers B6, and the parked vehicles V7, and may mainly constitute obstacles.

It is possible to recognize lanes LN in accordance with the recognized results of the target objects B that are acquired based on captured images. Specifically, although the parking slots PS or the lanes LN are different from the target objects B that are direct recognition targets by the ADAS sensors 31 to 34, these parking slots PS and the lanes LN can be indirect recognition targets based on the recognition results of the target objects B. The lanes LN as the indirect targets include, for example, an own lane LNm on which the own vehicle V is traveling and oncoming lanes LNc. The recognition targets to be recognized by the identifying module 2001 will be described in detail later.

The own lane recognition module 2104 is operative to recognize, based on the recognized results of the target objects B by the target object recognition module 2103, the location of the own vehicle V in a road in a width direction of the road; the road is a road in which the own vehicle V is traveling. The width direction of the road will be referred to as a road width direction, and a direction perpendicular to the road width direction will be referred to as a road extending direction. The road extending direction is a direction extending along the road, and can be referred to as a road extension direction or a road elongation direction. If the road Rd includes a plurality of lanes LN, the own lane recognition module 2104 is operative to recognize, as the own lane LNm, any one of the plural lanes LN arranged in the road width direction.

The intersection recognition module 2105 is operative to recognize, based on the recognized results of the target objects B by the target object recognition module 2103, an intersection Xr around the own vehicle V.

Specifically, the intersection recognition module 2105 is operative to recognize an intersection Xr that the own vehicle V is approaching in accordance with (i) whether there is a traffic light B11, (ii) which of color signal lights outputted from the traffic light B11 if it is determined that there is the traffic light B11, (iii) whether there is a stop line B42 as one of the road-surface markings B4, (iv) a location of an intersection entrance Xr1, (v) a location of an intersection exit Xr2, and (vi) traffic signs or marks, each of which indicates a corresponding traveling direction.

The surrounding environment recognition module 2106 is operative to recognize, based on the recognized results of the target objects B by the target object recognition module 2103, a surrounding environment around the own vehicle V, for example, how one or more obstacles are located around the own vehicle V.

These recognition results by the recognition modules 2103 to 2106 are used for the operation determiner 2002 that determines one or more control tasks that are required at present to control the own vehicle V.

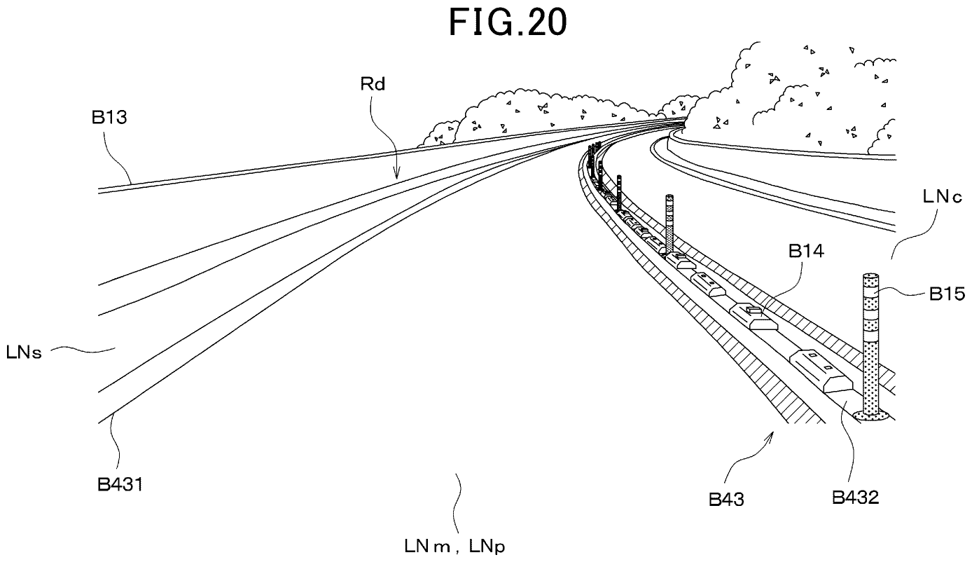

FIG. 18 is an example of forward scenery from the own vehicle V in a situation where the own vehicle V is approaching an intersection Xr that constitutes a crossroad and includes therein a signal light B11. An intersection Xr constituting a crossroad will be merely referred to as a cross intersection Xr. The recognition results of the signal light B11 and the traffic signs B12 included in the traffic-related three-dimensional objects B1 can be used for the HMI system 7 to notify information of the driver D and/or output warnings to the driver D. The recognition results of the signal light B11 and the traffic signs B12 included in the traffic-related three-dimensional objects B1 can also be used for the driving ECU 2 to perform motion control of the own vehicle V in the autonomous driving of the own vehicle V and/or in the driving assistance of the own vehicle V. The traffic-related three-dimensional objects B1 include, in addition to the signal lights B11 and the traffic signs B12, road-side structures B13, such as guardrails and curbstones. The traffic-related solid objects B11 also include, as illustrated in FIG. 20, road studs B14 and poles B15. The road studs may be recognized as obstacles depending on (i) the heights of the road studs and/or (ii) how the road studs are provided around the own vehicle V. The poles B15 are recognized as obstacles when the driving ECU 2 performs traveling control of the own vehicle V.

Referring to FIG. 18, the general three-dimensional objects B3 include, for example, on-road fallen objects B31, pedestrians B32, cyclists B33, and buildings B34. The on-road fallen objects B31, the pedestrians B32, and cyclists B33 are recognizes as obstacles when the driving ECU 2 performs traveling control of the own vehicle V. The buildings B34 are not recognized as obstacles, because the buildings B34 are located outside a road Rd, but may become contents to be superimposed on the forward scenery when the head-up display 704 displays the virtual image M.

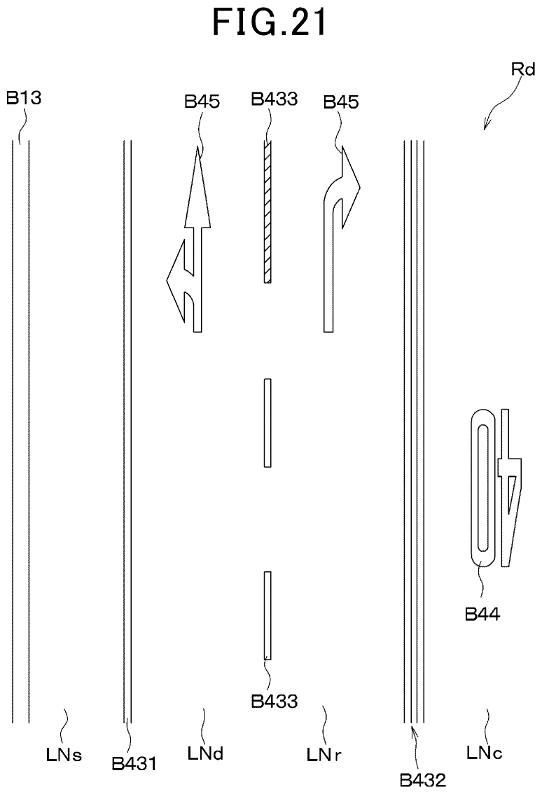

The road-surface markings B4 include, for example, pedestrian-crossing markings B41, stop lines B42, and road marking lines B43. The road-surface markings B41 additionally include, as illustrated in FIG. 21, letter markings B44 and symbol markings B45. The letter markings B44 include, for example, a numeral indicative of the maximum speed limit, vehicle traffic zones, such as “BUS ONLY”, or restriction letters, such as “STOP”. The symbol markings B45 include, for example, arrows indicating respective mandatory directions, and attention symbols for forward pedestrian crossings.

The recognition results of the road traffic markings B4 are used to estimate the location of each of the intersection entrance Xr1 and the intersection exit Xr2 and the location of the intersection center Xrc. The intersection entrance Xr1 represents an edge of a focusing intersection that the own vehicle V is going to enter. The focusing intersection is the nearest intersection Xr which (i) the own vehicle V is approaching and (ii) the own vehicle V is scheduled to pass through or is likely to pass through. An intersection which the own vehicle V is likely to pass through is, if no scheduled travel route and destination of the own vehicle V are determined by the navigation system 6, an intersection which is estimated, based on (i) a distance to the intersection from the own vehicle V and (ii) the speed of the own vehicle V, for the own vehicle V to pass through at a high probability. The intersection exit Xr2 represents an edge of the focusing intersection from which the own vehicle V is going to exit. The intersection center Xrc is the center of the focusing intersection.

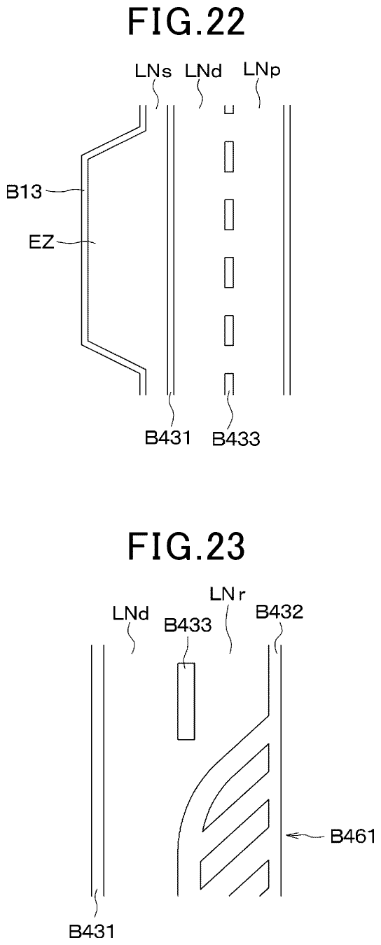

As illustrated in FIGS. 22 and 23, the road marking lines B43 include, for example, vehicle-road edge lines B431, centerlines B432, and lane lines B433. The vehicle-road edge lines B431 are provided for each vehicle-road, and they respectively show the left and right edges of the corresponding vehicle-road in the road width direction. The vehicle-road of a road Rd represents a section of the road Rd in which vehicles can travel. Each centerline B432 represents a line down the center of a two-way road, and divides the two-way road into two sections in the respective opposite traveling directions. Each centerline B432 is comprised of a single straight line pattern or a single broken line pattern, a double line pattern, or a triple line pattern. The lane lines B433 are provided for a road Rd with two or more lanes each way, and they divide the road Rd into two or more lanes each way. Each of the lane lines B433 is a painted white line or a painted yellow line. FIG. 20 illustrates, as an example, that a centerline B432 is comprised of a triple line pattern that is comprised of a white solid line and a pair of yellow lines located at both sides of the white line. The road studs B14 and the poles B15 are mounted on the white line of the triple line pattern of the centerline B432 illustrated in FIG. 20. FIG. 21 illustrates, as another example, that a centerline B432 is comprised of a double line pattern that is comprised of white solid lines, and the lane line B433 is comprised of a white broken line and a yellow solid line extending from the white broken line. It is possible to recognize, based on the recognition results of the road-side structures B13 and the road making lines B43, (i) a traveling lane LNd or an own lane LNm on which the own vehicle V is traveling (see for example FIGS. 20 and 21), (ii) oncoming lanes LNc (see for example FIGS. 20 and 21), (iii) a passing lane LNp (see for example, FIG. 20), (iv) a right turn lane LNr (see FIG. 21), (v) a road shoulder LNs (see FIGS. 20 to 22), and (vi) an emergency parking zone EZ (see FIG. 22).

The road traffic markings B4 additionally include, for example, diversion zone markings, i.e., zebra zone markings, B461, safety zone markings B462, no trespassing zone markings B463, and no stopping zone markings B464.

The diversion zone marking B461 is painted on a road and indicates a diversion zone where it is necessary to guide the safe and smooth running of vehicles. As described above, the diversion zone marking B461 is a marking that indicates a diversion zone for guiding the safe and smooth running of vehicles, and vehicles are legally not prohibited from entering the diversion zone. The diversion zone marking B461 can be provided to be adjacent to (i) an intersection Xr, (ii) a junction of roads, or (iii) a fork in a road.

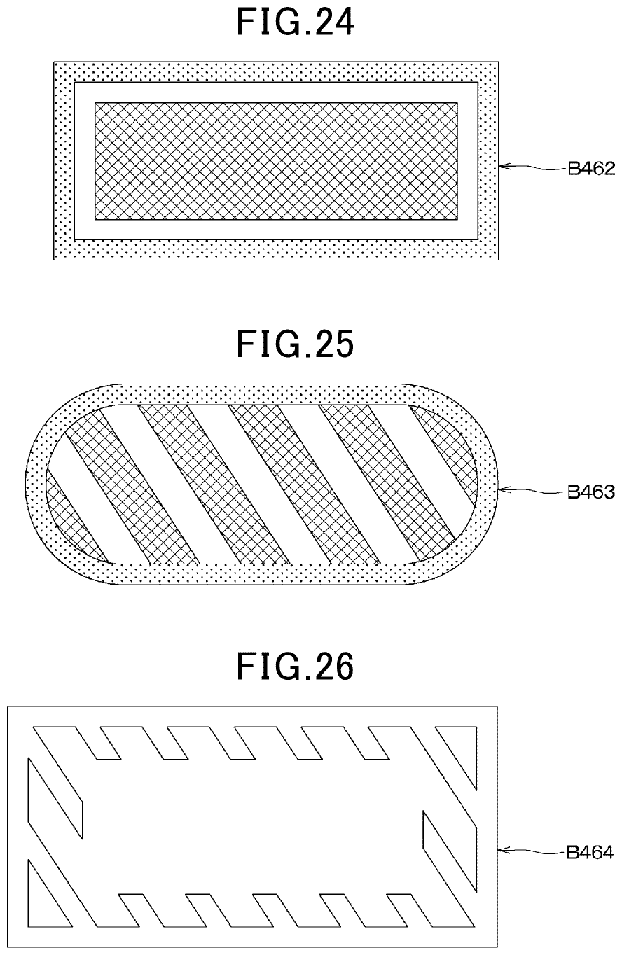

The safety zone marking B462 illustrated in FIG. 24 is used to indicate a safety zone. The safety zone represents, on a road, a zone provided to ensure safety of, for example, pedestrians B32, so that vehicles cannot regally enter the safety zone.

The no trespassing zone marking B463 illustrated in FIG. 25 is used to indicate a no entry zone. The no trespassing zone represents, on a road, a zone that cannot be used for traveling of vehicles, so that vehicles cannot enter the inside of the no trespassing zone.

The no stopping zone marking B464 illustrated in FIG. 26 is used to indicate a no stopping zone. The no stopping zone represents, on a road, a zone that, when a vehicle is likely to be stopped depending on the situations in front of the vehicle, the vehicle should not enter. That is, when any vehicle waits for a traffic light or is in a traffic jam, the vehicle should not be stopped inside the no stopping zone marking B464.

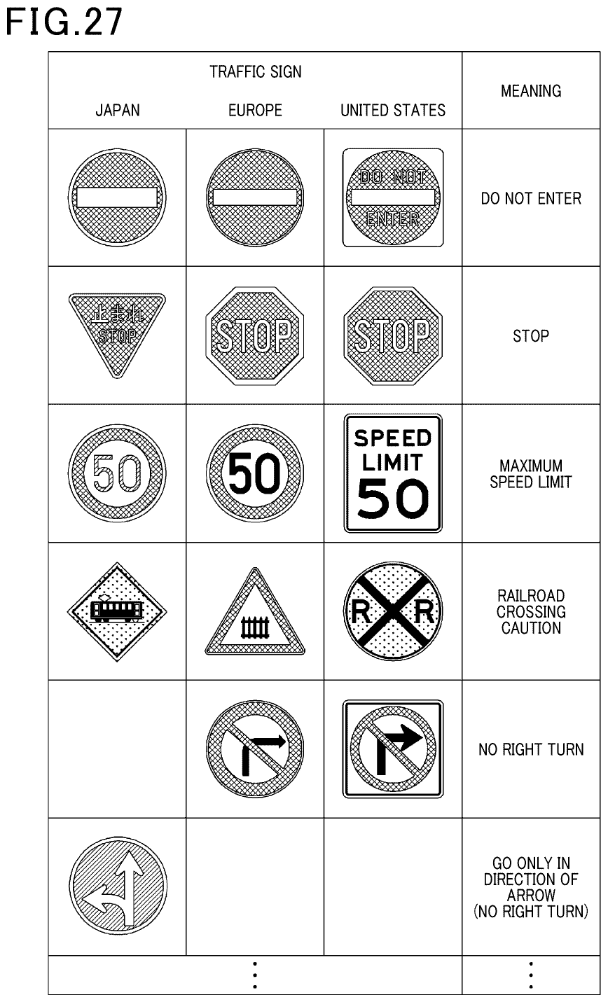

FIG. 27 illustrates examples of the traffic signs B12. Each of the traffic signs B12 are installed adjacent to corresponding one or more roads Rd or installed above the corresponding one or more roads Rd. Each of the traffic signs B12 is comprised of a display board designed to offer corresponding necessary information to users who face the corresponding one of the traffic signs B12. The display board of each traffic sign B12 has (i) a designed shape, (ii) one or more colors painted on at least one major surface thereof, and (iii) one or more symbols. The one or more colors include, for example, white, black, red, blue, and yellow. In FIG. 27 cross hatching represents red, diagonal hatching represents blue, dot hatching represents yellow, and shaded portion represents black. Each symbol used in the traffic signs B12 includes, for example, one or more letters, one or more figures, and a combination of one or more letters and one or more figures.

FIG. 27 illustrates examples of the traffic signs B12 in Japan (JP), the European Union (EU), and the United States (US) categorized by meaning. As typical examples of the traffic signs B12 in EP, examples of the traffic signs B12 in German and/or France are used.

For example, traffic signs of respective JP, EU, and US, which means “DO NOT ENTER” or “NO ENTRY”, have substantially the same design. In contrast, traffic signs of respective JP, EU, and US, which means “STOP” have substantially the same color and symbol, and the shape of the board of the traffic sign of EU is substantially identical to that of US, but the shape of the board of the traffic sign of JP is different from that of EU and US.

Traffic sings of respective JP and EU, which means “MAXIMUM SPEED LIMIT” by the letter “50”, have substantially the same design except for the difference in letter's color, but a traffic sing of US, which means “SPEED LIMIT” by the letter “50”, is different in the shape of the board and color from those of the respective JP and EU.

Traffic sings of respective JP, EU, and US, which means “RAILROAD CROSSING CAUTION”, have a low level of commonality in design.

Traffic signs of respective EU and US, which means “NO RIGHT TURN”, have substantially the same design, and there is no corresponding traffic sign in JP.

A traffic sign of JP, which means “GO ONLY IN DIRECTION OF ARROW”, and indicates, using white arrows, the forward direction and left-turn direction, illustrated in FIG. 27, similarly represents “NO RIGHT TURN”.

Precise recognition of the traffic signs B12 enables autonomous driving and/or advanced driving assistance to be implemented smoothly and safely. As described above, the designs of some of the traffic signs B12 vary considerably between JP, EU, and US. For this reason, the memory device 22 stores beforehand at least one database that stores information indicative of pattens of the traffic signs used in, for example, each of all the countries in the world or each of all the regions in the world. Pattern matching between a recognized traffic sign B12 and the information stored in the at least one database enables the meaning of the recognized traffic sign B12 to be detected. The at least one database can be configured as a common database all over the world, or can be comprised of a plurality of databases provided for all the counties in the world, each of the databases stores information indicative of pattens of the traffic signs used in the corresponding one of the countries in the world. The at least one database can be stored in a host computer in place of or in addition to the memory device 22; the driving ECU 2 is communicably connected, based on vehicle-to-everything technologies (V2X), to the host computer through the vehicular communication module 4. This enables the driving ECU 2 to freely access the at least one database stored in the host computer.

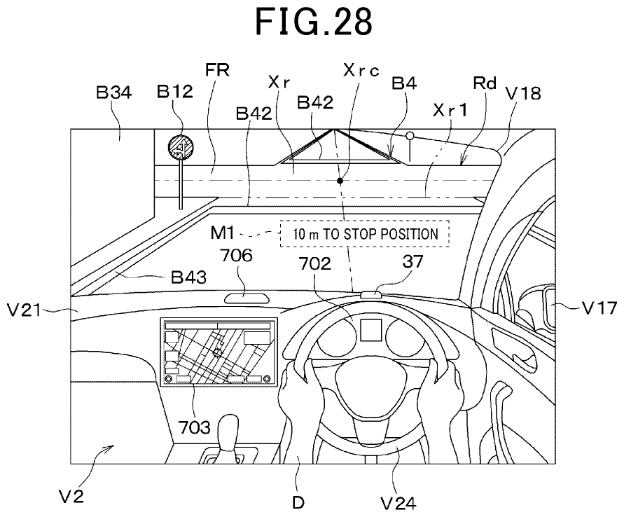

FIG. 28 schematically illustrates a first example indicative of how to use the recognition results of target objects B in a situation where the own vehicle V is approaching a cross intersection. In this situation, the head-up display 704 can superimpose, on the stop line B42, an information content M1 indicating a message “10 m to a stop position” representing the distance of 10 m to the stop line B42. Additionally, the HMI system 7 can output, using the speaker 705, a sound message indicative of “10 m to stop line”. This efficiently assists the driver D, who uses the advanced driving assistance, to reliably cause the own vehicle V to pause before the stop line B42. Alternatively, the sound message outputted from the HMI system 7 enables the one or more occupants of the own vehicle V to reliably grasp, beforehand, the occurrence of a temporary stop event of the own vehicle V, thus avoiding reduction in the comfort of the one or more occupants of the own vehicle V.

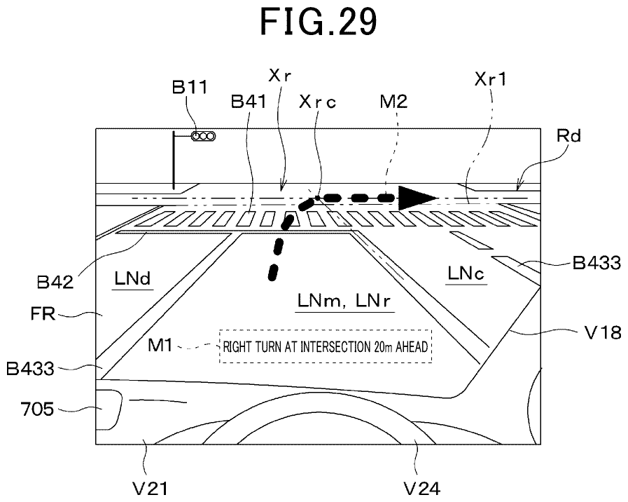

FIG. 29 schematically illustrates a second example indicative of how to use the recognition results of target objects B in a situation where the own vehicle V is approaching a cross intersection with a traffic light B11 and the own vehicle V is going to turn right in the cross intersection. In this situation, the head-up display 704 can superimpose, on the own lane LN, i.e., the right-turn lane LNr, of the road surface FR in front of the own vehicle V, an information content M1 indicating a message “right turn at intersection 20 m ahead”. The HMI system 7 also can output, using the speaker 705, a sound message indicative of “right turn at intersection 20 m ahead”. Additionally, the HMI system 7 can superimpose, on the road surface FR, a graphic content M2 of an arrow extending from the right-turn lane LNr up to a target road Rd through the center Xrc of the intersection or thereabout. This efficiently offers, to the one or more occupants including the driver D of the own vehicle V, the traveling direction guidance of the own vehicle V and/or an advance notice of the behavior of the own vehicle V subjected to lateral acceleration during right turning. This therefore enables the one or more occupants of the own vehicle V to reliably grasp, beforehand, the occurrence of the behavior of the own vehicle V, thus avoiding reduction in the comfort of the one or more occupants of the own vehicle V.

Referring to FIG. 17, the target object recognition module 2103 is operative to recognize the type and the state of at least one target object B in accordance with the recognition results of the at least one target object B and the HD map information stored in the HD map information database 5. The state of the at least one target object B includes, for example, positional information about the at least one target object B. The positional information about the at least one target object B includes, for example, the distance of the at least one target object B relative to the own vehicle V, the relative position of the at least one target object B relative to the own vehicle V, and, if the at least one target objects B is one of the plural lanes LN, the position of one of the lanes LN.

Specifically, the marking line recognition module 2131 of the target object recognition module 2103 is operative to recognize the road marking lines B43 in a peripheral region around the own vehicle V, which includes the road surface FR of a road Rd located on the traveling course of the own vehicle V. For example, the marking line recognition module 2131 is operative to recognize, for example, whether each of the vehicle-road edge lines B431, the centerlines B432, and/or the lane lines B433, which are illustrated in FIGS. 20 to 23, (i) has white or yellow, (ii) is a solid line or a dashed line, (iii) has a single line pattern or a multiple line pattern. Because the recognition technologies of the road marking lines B43 are well-known at the time of filing the present application, detailed descriptions of the recognition technologies of the road marking lines B43 are omitted in the present disclosure.

The road-surface marking recognition module 2132 of the target object recognition module 2103 is operative to recognize the type, the meaning, and the position of each of the road-surface markings B4 except for the road marking lines B43; the recognition targets of the road-surface marking recognition module 2132 include, for example, the pedestrian-crossing markings B41, the stop lines B42, and the symbol markings B45.

The road-side structure recognition module 2133 is operative to recognize the type and the position of at least one road-side structure B13 located around the own vehicle V in accordance with, for example, at least one of (i) the recognition results based on the images captured by cameras 34, (ii) the recognition results based on the at least one detection-point data cloud detected by the laser-radar sensor 33, and (iii) the HD map information stored in the HD map information database 5.

The traffic light recognition module 2134 is operative to recognize (i) whether a traffic light B11 is located on the traveling course of the own vehicle V and (ii) the position of the traffic light B11 and which of the color signal lights outputted from the traffic light B11 if it is recognized that the signal light B11 is located on the traveling course of the own vehicle V.

The traffic sign recognition module 2135 is operative to recognize the traffic signs B12 located around the own vehicle V.

The lane recognition module 2136 is operative to perform a lane recognition task of recognizing the number of lanes LN in a road Rd in which the own vehicle V is traveling, and the type of each lane LN in the road Rd. That is, the lane recognition module 2136 is operative to perform the lane recognition task in accordance with, for example, (i) the recognition results based on the images captured by the front camera CF of the cameras 34, (ii) the recognition results based on the at least one detection-point data cloud detected by the laser-radar sensor 33, and (iii) the HD map information stored in the HD map information database 5.

Specifically, the lane recognition module 2136 can be normally operative to perform the lane recognition task in accordance with the recognition results based on sed on the images captured by cameras 34 or, if necessary arises, perform a sensor-fusion lane recognition task in accordance with combination of (i) the recognition results based on the images captured by the front camera CF of the cameras 34 and at least one of (ii) the recognition results based on the at least one detection-point data cloud detected by the laser-radar sensor 33 and (iii) the HD map information stored in the HD map information database 5.

The pedestrian recognition module 2137 is operative to recognize one or more pedestrians B32 located around the own vehicle V. The surrounding vehicle recognition module 2138 is operative to recognize one or more other vehicles B2 located around the own vehicle V. The obstacle recognition module 2139 is operative to recognize one or more obstacles, such as one or more on-road fallen objects B31.

How each of the traffic light recognition module 2134, the traffic sign recognition module 2135, the lane recognition module 2136, the pedestrian recognition module 2137, the surrounding vehicle recognition module 2138, and the obstacle recognition module 2139 recognizes corresponding one or more target objects is well-known at the time of filing the present application, and therefore detailed descriptions of how each of the modules 2134 to 2139 recognizes corresponding one or more target objects are omitted in the present disclosure.

### First Embodiment

The following describes the first embodiment. In each of the following embodiments, the combination of (i) the driving ECU 2 serving as a vehicular apparatus according to the corresponding embodiment, (ii) computer programs, i.e., computer-program instructions, to be executed by the driving ECU 2, i.e., the processor 21, according to the corresponding embodiment and (iii) a storage medium storing the computer programs according to the corresponding embodiment will also be collectively referred to as a present embodiment.

### Limp-Home Control

The following describes, in detail, limp-home control, i.e., evacuation control, according to the present embodiment. The limp-home control represents vehicle motion control carried out by the vehicular system 1, which is to cause the own vehicle V to move to a safe place, such as a selected road shoulder LNs (see FIG. 21) or a selected emergency parking zone EZ (see FIG. 22). The limp-home control is programmed to be carried out by the vehicular system 1 in a first example case where the driver D of the own vehicle V may be unable or have difficulty to drive due to poor health and/or decreased level of consciousness. Additionally, the limp-home control is programmed to be carried out by the vehicular system 1 in a second example case where there may be a trouble or a malfunction in the own vehicle V.

Specifically, the driving ECU 2 is configured to determine whether to execute the limp-home control in accordance with, for example, the driver's state parameters detected, as input information, by the driver-state monitor 37. The driving ECU 2 is configured to determine (i) a stop location or a stop region for the own vehicle V and (ii) a traveling route from the current location of the own vehicle V to the stop location or stop region in response to determination of executing the limp-home control. Then, the driving ECU 2 is configured to generate control signals required for the own vehicle V to travel along the determined traveling route, and output, to the motion control system 9, the control signals.

The following describes, in detail, the limp-home control.

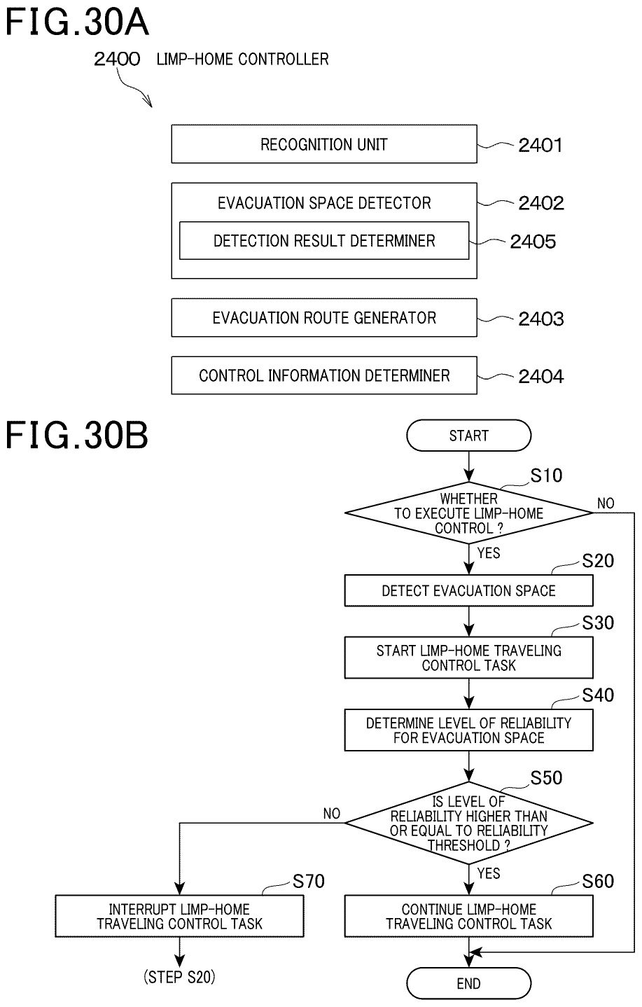

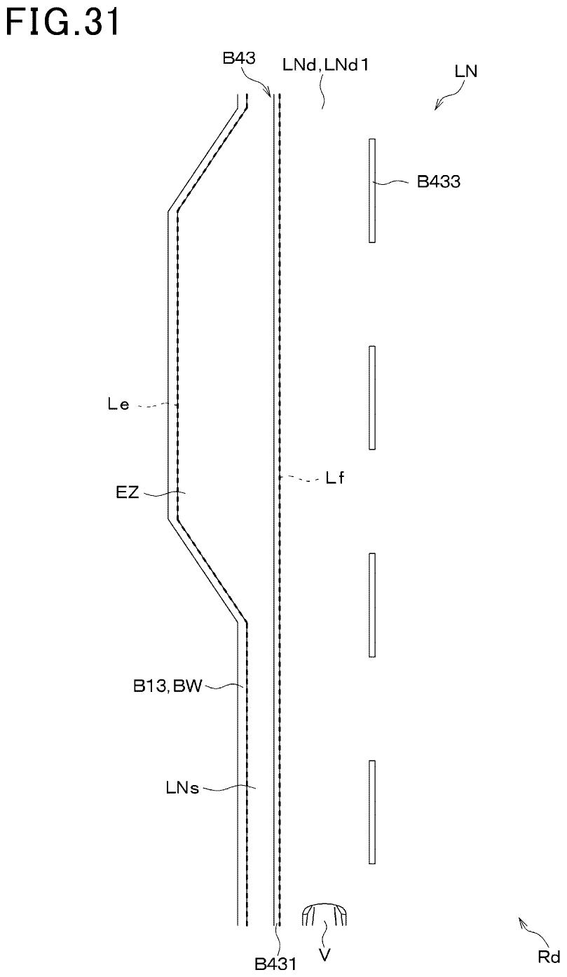

FIG. 30A schematically illustrates a functional configuration related to the limp-home control and implemented by the driving ECU 2 illustrated in FIG. 16. FIGS. 31 to 34 illustrate how the own vehicle V is controlled to travel based on the limp-home control carried out by the driving ECU 2. Specifically, FIGS. 31 to 34 illustrate time-series situations indicative of how the own vehicle V traveling in a farthest-end traveling lane LNd1 is controlled to travel in a limp-home mode based on the limp-home control. The farthest-end traveling lane LNd1 represents the lane LN in a plurality of traveling lanes LNd in a four-lane left-hand road Rd with a road shoulder LNs; the farthest-end traveling lane LNd1 is located closest to the road shoulder LNs.

The driving ECU 2 according to the present embodiment functionally includes, as illustrated in FIG. 30A, a limp-hone controller 2400 that includes a recognition unit 2401, an evacuation space detector 2402, an evacuation route generator 2403, and a control information determiner 2404.

The following schematically describes the limp-home control, i.e., evacuation control, according to the present embodiment with reference to FIGS. 31 to 34 and, if necessity arises, at least one of the other figures.

The recognition unit 2401 is operative to recognize various types of target objects B including road marking lines B43 located around the own vehicle V. The recognition unit 2401 is additionally operative to recognize, based on the recognition result acquired by the recognition unit 2401, road edges and lane edges. The road edges are edges of a road Rd in the road width direction while the own vehicle V is traveling on the road Rd. The lane edges represent edges of a lane in the road width direction while the own vehicle V is traveling in the lane. The road width direction is the width direction of the road Rd. A direction that intersects with the road width direction especially at right angles will be referred to as the road extending direction. The road extending direction is a direction extending along the road, and can be referred to as a road extension direction or a road elongation direction. That is, the road extending direction is defined as a direction in which a line passing through a center point of the road Rd in the road width direction extends. In other words, the road extending direction is a direction along a traveling trajectory or a scheduled traveling trajectory of the own vehicle V that is traveling along the road Rd.

The left edge of a road Rd with a road shoulder LNs, such as the road Rd illustrated in FIG. 31, substantially corresponds to the left edge of the road shoulder LNs. The left edge of the road Rd is defined as a closer edge of the road Rd than the right edge of the road Rd that is defined as a farther edge of the of the road Rd. Each of FIGS. 31 to 34 shows, as an example, a part, i.e., a left-side part, of the road Rd surrounded by sidewalls, which will also be referred to as road sidewalls, BW as the road-side structures B13 on both left and rights sides of the road Rd. Such a configuration of the road Rd can be seen as a configuration inside a tunnel or a configuration of an urban expressway in Japan. When the road Rd has a configuration illustrated in FIGS. 31 to 34, the road edges can be recognized based on recognized road sidewalls BW. Reference character Le in FIGS. 31 to 34 is a road-edge line representing a recognition result of the left road edge and having a continuous line or dashed lines extending in the road extending direction. The road-edge line Le is basically a virtual line. The road-edge line Le will also be referred to as a road-edge recognition line.

The lane edges can be recognized based on recognized road marking lines B43. Reference character Lf represents lane-edge recognition lines representing a recognition result of the lane edges and each having a continuous line or dashed lines extending in the road extending direction. The lane-edge recognition lines Lf can be recognized on both left and rights sides of the lane LN. Specifically, one of the recognized lane-edge lines of the farthest-end traveling lane LNd1 can be recognized at a location corresponding to the right edge of the left-side vehicle edge line B431 and also recognized at a location corresponding to the left edge of the lane line B433 of the road Rd. In each of FIGS. 31 to 34 or the other similar figures, one lane-edge recognition line Lf included in the lane-edge recognition lines Lf of the farthest-end traveling lane LNd1, which corresponds to the right edge of the left-side vehicle edge line B431, is only illustrated for the sake of simple illustration.

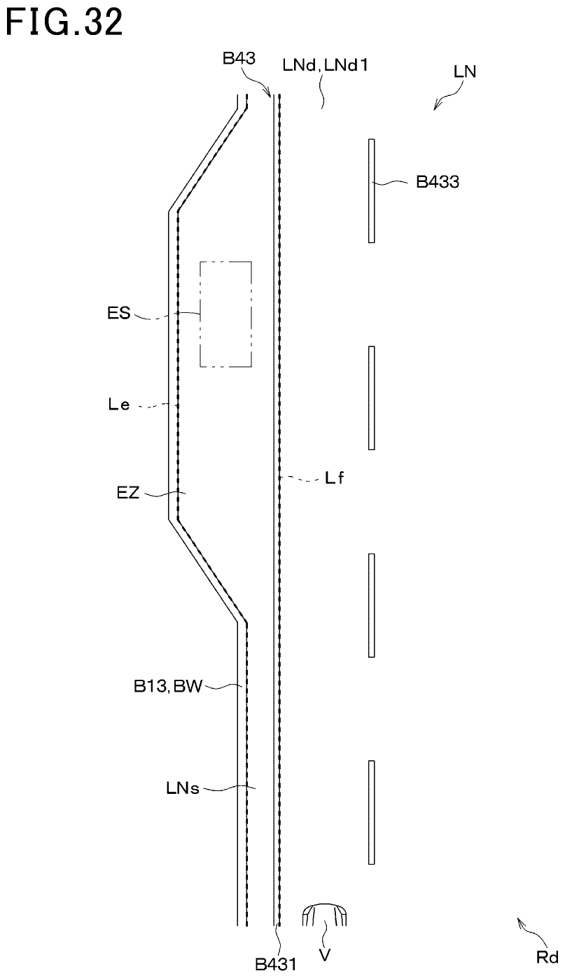

As illustrated in FIG. 32, the evacuation space detector 2402 is operative to detect, based on the recognized road marking lines B43 and the left edge, i.e., the road-edge line Le and the lane-edge recognition lines Lf, an evacuation space ES at a location where the own vehicle V is parkable in the road extending direction. Then, the evacuation space detector 2402 is operative to specify the location of the evacuation space ES.

The location where the own vehicle V is parkable is for example defined as a location where the own vehicle V is enabled to be safely parked based on the current location and the current vehicle speed without rapid braking and/or rapid steering. The evacuation space ES is, for example, a rectangular space having external dimensions that are determined to be in conformity with external dimensions of the own vehicle V viewed from above. Specifically, the evacuation space ES has long sides more than or equal to the longitudinal length of the own vehicle V, and short sides more than or equal to the width of the own vehicle V.

In particular, the evacuation space detector 2402 is operative to detect an evacuation space ES within a parkable distance range of the own vehicle V included in a road-shoulder region. The road-shoulder region is a region defined between the road-edge line Le and the lane-edge recognition line Lf corresponding to the right edge of the left-side vehicle edge line B431 that defines the farthest-end traveling lane LNd1 located adjacent to the road shoulder LNs.

Specifically, the evacuation space detector 2402 can be operative to determine, in a detected road shoulder LNs, whether there is a virtually rectangular space whose longitudinal side is longer than or equal to a predetermined first threshold length and whose lateral side is longer than or equal to a predetermined second length in a detected road shoulder LNs; the first and second lengths are determined based on the size of the own vehicle V. Then, the evacuation space detector 2402 can be operative to detect the virtually rectangular space as an evacuation space ES in the detected road shoulder LNs upon determination that there is a virtually rectangular space whose longitudinal side is longer than or equal to the predetermined first threshold length and whose lateral side is longer than or equal to the predetermined second length.

The road-shoulder region and the road shoulder LNs will be collectively referred to simply as the road shoulder LNs if it is unnecessary identify any of the road-shoulder region and the road shoulder LNs. The road shoulder LNs includes, for example, an emergency parking zone EZ. That is, the emergency parking zone EZ can be identified as a part of the road shoulder LNs that is extended outwardly in the road width direction.

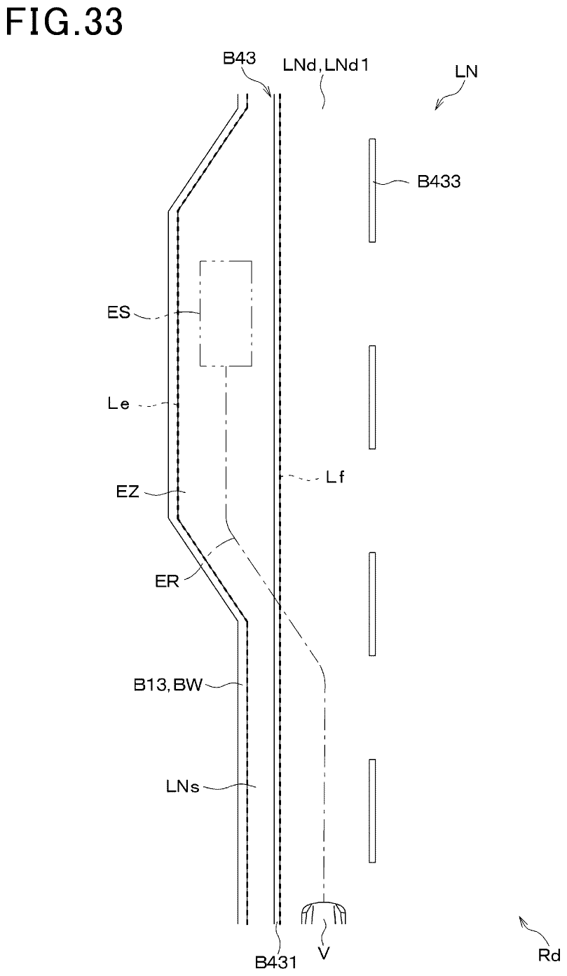

As illustrated in FIG. 33, the evacuation route generator 2403 is operative to generate, i.e., calculate, an evacuation route ER that is a traveling route from the current location of the own vehicle V to the evacuation space ES detected by the evacuation space detector 2402 for parking the own vehicle V in the evacuation space ES.

The control information determiner 2404 is operative to determine, based on the evacuation route ER generated by the evacuation route generator 2403, control information on the own vehicle V for causing the own vehicle V to travel from the current location to the evacuation space ES along the evacuation route ER. That is, the control information determiner 2404 is operative to determine, during the traveling of the own vehicle V along the evacuation route ER, the control information indicative of how the braking system 93 brakes the own vehicle V to decelerate the own vehicle V and/or how the steering system 94 steers the own vehicle V.

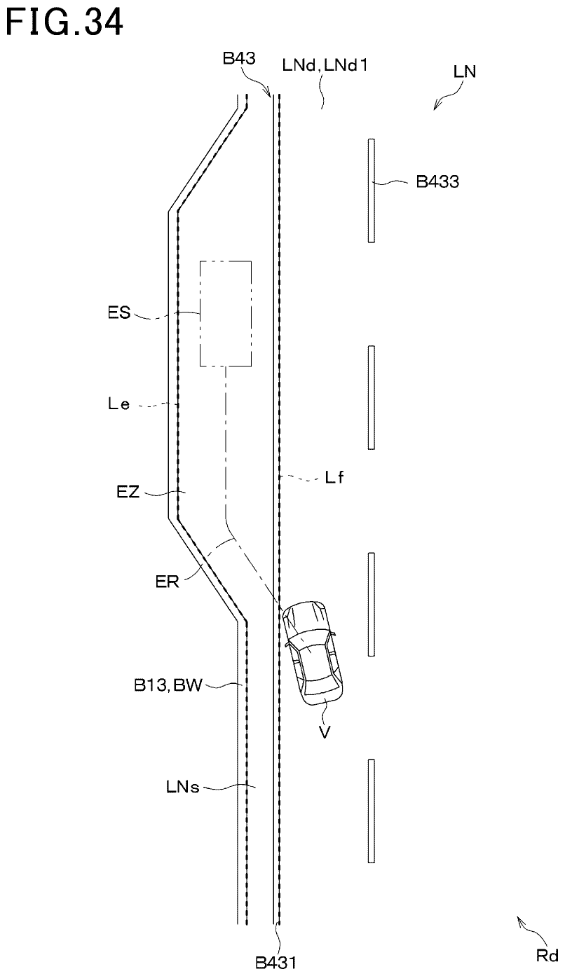

As described above, the present embodiment recognizes, as illustrated in FIG. 31, a road-edge line Le and lane-edge recognition lines Lf. Next, as illustrated in FIG. 32, the present embodiment detects, based on the road-edge line Le and the lane-edge recognition lines Lf, an evacuation space ES located between the road-edge line Le and the lane-edge recognition line Lf corresponding to the right edge of the left-side vehicle edge line B431. Additionally, as illustrated in FIG. 33, the present embodiment generates, based on the detected evacuation space ES, an evacuation route ER. Then, as illustrated in FIGS. 33 and 34, the present embodiment performs, based on the detected evacuation space ES and the generated evacuation route ER, a limp-home traveling control task, that is, a motion control task, which causes the own vehicle V to travel in the limp-home mode to the evacuation space ES along the evacuation route ER. During execution of the limp-home traveling control task based on the evacuation route ER, the evacuation space detector 2402 can be operative to correct the detection result of the evacuation space ES based on the recognition results of the road-edge line Le and the lane-edge recognition lines Lf, so that the control information determiner 2404 can be operative to correct the evacuation route ER based on the corrected detection result of the evacuation space ES.

The recognition unit 2401 of the present embodiment can be implemented as, for example, a function included in the identifying module 2001 illustrated in FIG. 16, and each of the evacuation space detector 2402, evacuation route generator 2403, and control information determiner 2404 of the present embodiment can be implemented as a function included in the operation determiner 2002 illustrated in FIG. 16.

That is, the operation determiner 2002 and/or the control signal output module 2003 illustrated in FIG. 16 generate control signals based on the control information determined by the control information determiner 2404, i.e., the operation determiner 2002, and the control signal output module 2003 outputs the control signals to the motion control system 9. This results in the motion control system 9 performing the limp-home traveling control task based on the outputted control signals.

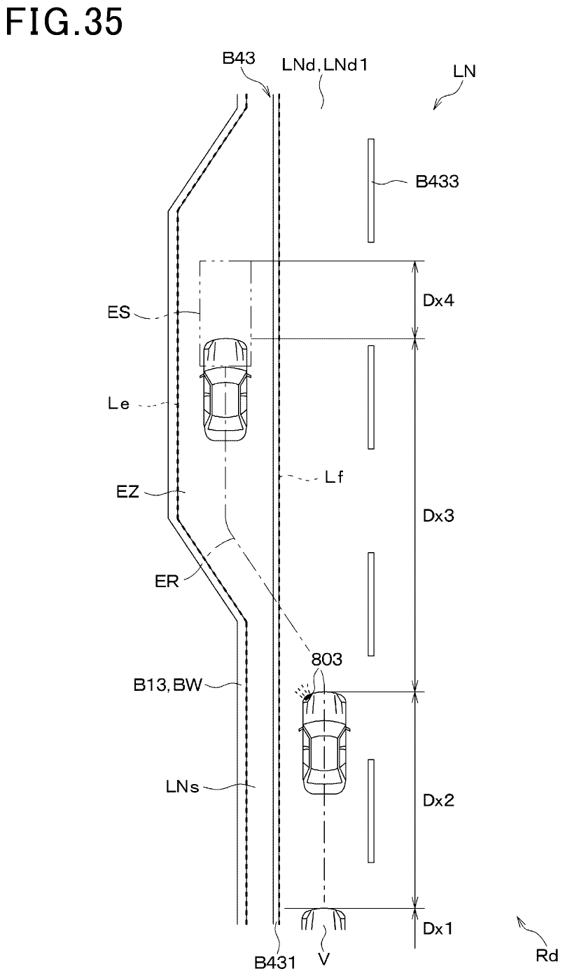

FIG. 35 illustrates, in detail, the limp-home traveling control task.

FIG. 35 shows a searching section Dx1 representing a traveling section of the vehicle V for searching for an evacuation space ES, that is, a traveling section of the own vehicle V from the point of time at which execution of the limp-home control is determined to the point of time at which an evacuation space EX is detected first.

FIG. 35 shows an evacuation preparation section Dx2 representing a preparation section of the own vehicle V for preparing for limp-home traveling to the evacuation space ES detected by the searching in the searching section DX1; the limp-home traveling includes lateral movement of the own vehicle V. Specifically, the evacuation preparation section Dx2 represents a traveling section of substantially three seconds in which selected ones of the blinkers 803 of the own vehicle V are turned on.

FIG. 35 shows an evacuation traveling section Dx3 representing a traveling section of the own vehicle V from the start of the lateral movement of the own vehicle V toward the evacuation space ES to the arrival of the own vehicle V at a deceleration and stop section Dx4. The deceleration and stop section Dx4 represents a section in which the own vehicle V is decelerated to be finally stopped in the evacuation space ES.

The lower the speed of the own vehicle V in the searching section Dx1 is, the more detectable an evacuation space ES is but the greater a road-traffic impact on the following other vehicles becomes. When the own vehicle V arrives at the deceleration and stop section Dx4, the speed of the own vehicle V becomes preferably a sufficiently low speed at which the own vehicle V can be slowly stopped. In addition, the speed of the own vehicle V needs to be lower than 10 km/h in a road shoulder LNs.

For these reasons, the control information determiner 2404 is operative to determine, in each of the searching section Dx1, the evacuation preparation section Dx2, and the evacuation traveling section Dx3, the speed of the own vehicle V, the amount of braking of the own vehicle V for decelerating the own vehicle V, and/or the steering amount of the own vehicle V.

As illustrated in, for example FIG. 31, emergency parking zones EZ are provided at intervals for a road Rd surrounded by road sidewalls BW on both left and right sides of the road Rd. Each emergency parking zone EZ usually has a longer dimension in the road width direction than that of a usual road shoulder LNs.

For this reason, in a case where an evacuation space ES can be detected in a selected emergency parking zone EZ, it is preferable to detect and specify the location of the evacuation space ES in the selected emergency parking zone EZ. It is preferable that the location of an evacuation space ES in the road extending direction is so specified as not too close to the location of the own vehicle V to (i) prevent sudden braking and sudden steering of the own vehicle V traveling in the limp-home mode and (ii) reduce errors in a controlled location of the own vehicle V.

Such an emergency parking zone EZ is usually located in a portion of a road; the portion, which will be referred to as an outwardly projecting portion, projects outwardly from a main portion of the road in the road width direction.

If a road is surrounded by road sidewalls BW on both left and right sides thereof, the outwardly projecting portion of the road is also surrounded by a corresponding portion of the road sidewall BW projecting outwardly from a main portion of the road sidewall BW; the portion of the road sidewall BW projecting outwardly from the main portion of the road sidewall BW will also be referred to as an outwardly projecting portion of the road sidewall BW. For this reason, a portion of the road sidewall BW located in front of an emergency parking zone EZ of a road when viewed from the own vehicle V traveling on the road may cause the emergency parking zone EZ to be likely to become a blind spot from the own vehicle V. For this reason, it may be difficult to detect an evacuation space ES in such an emergency parking zone EZ blocked by the road sidewall BW or there may be a false detection of, for example, the left edge of the road.

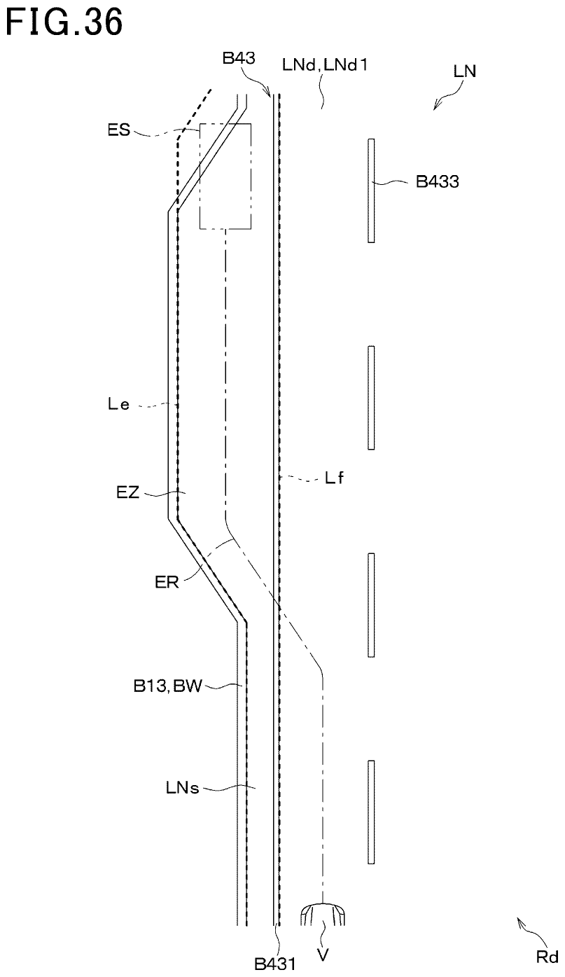

FIG. 36 shows a case where there may be a false detection of the shape of the far-side end of the left edge of the road relative to the emergency zone EZ, so that there may be a false detection of an evacuation space ES. Specifically, because the false-detected evacuation space ES in this example is recognized so as to project from the road sidewall BW, it may be difficult to park the own vehicle V in the false-detected evacuation space ES.

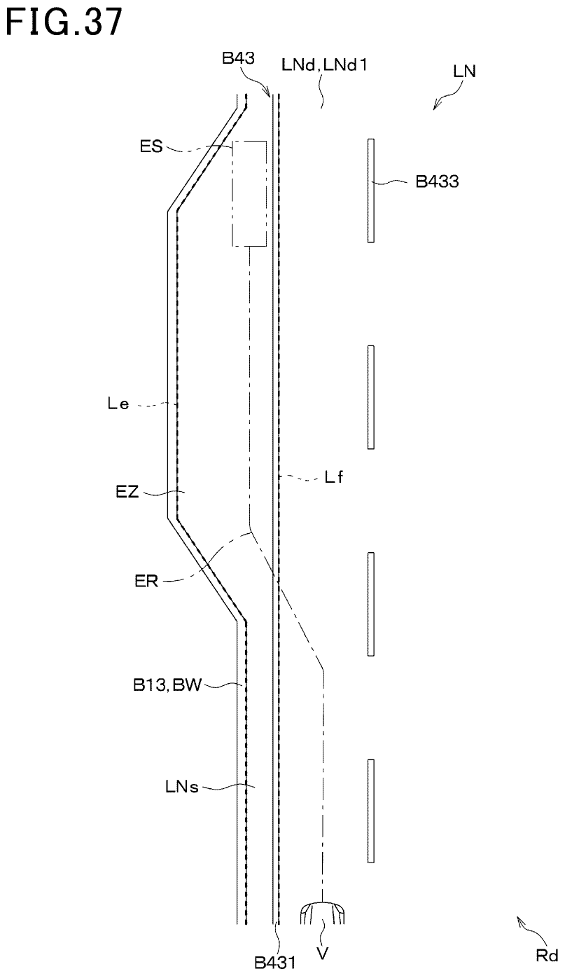

Additionally, FIG. 37 shows a case where major correction of the location and/or size of an evacuation space ES, which has been detected once, is performed. The major correction of the location and/or size of the evacuation space ES in this example may increase correction of the evacuation route ER, resulting in difficulty of stable execution of the limp-home traveling control task. The location and/or size of the corrected evacuation space ES may prevent the own vehicle V from being parked in the corrected evacuation space ES. The detected evacuation space ES according to each of the cases of FIG. 36 and FIG. 37 may be called an evacuation space ES having a low level of reliability. If such a detected evacuation space ES has a low reliability, it is preferable not to perform the limp-home traveling control task based on such a detected evacuation space ES having a low level of reliability.

If an evacuation space ES is detected in other cases, such a detected evacuation space EX may be referred to as an evacuation space ES having a high level of reliability. Even if a detected evacuation space ES has a high level of reliability, there may be an obstacle located in the detected evacuation space ES or the detected evacuation space ES may have a shortage of size smaller than the size of the own vehicle V.

From the above circumstances, the limp-home controller 2400 additionally includes, as illustrated in FIG. 30A, a detection result determiner 2405. The detection result determiner 2405 is operative to determine whether a detection result of an evacuation space ES detected by the evacuation space detector 2402 is reliable, i.e., determine whether an evacuation spaces ES detected by the evacuation space detector 2402 is actually usable as a stopping target, i.e., a parking target, for the own vehicle V by the limp-home control.

Specifically, the detection result determiner 2405 can be operative to determine whether an evacuation space ES detected by the evacuation space detector 2402 is a reliable evacuation space where the own vehicle V is actually parkable or stoppable. Alternatively, the detection result determiner 2405 can be operative to determine a level of reliability for an evacuation space ES detected by the evacuation space detector 2402. The level of reliability for an evacuation space ES detected by the evacuation space detector 2402 is an index representing information about at least one of
(I) The likelihood of an actual existence of the detected evacuation space ES
(II) Whether the evacuation space ES is detected stably by the evacuation space detector 2402
(III) The likelihood of the evacuation space ES being an evacuation space where the own vehicle V is actually parkable or stoppable

Then, the control information determiner 2404 is operative to determine the control information on the own vehicle V for causing the own vehicle V to travel from the current location to the evacuation space ES along the evacuation route ER while decelerating the own vehicle V in accordance with, in addition to the evacuation route ER, the determined detection result of the evacuation space ES, i.e., the determined level of reliability for the evacuation space ES.

The detection result determiner 2405 can be implemented, as illustrated in FIG. 30A, as a function in the control information determiner 2402 or can be implemented as another function, such as a function parallel to the control information determiner 2402, in the limp-home controller 2400. The detection result determiner 2405 can also be referred to as a reliability determiner for determining the level of reliability corresponding to the likelihood of an evacuation space ES actually existing.

### Specific Applications

The following describes several specific applications of the present embodiment. The driving ECU 2 according to each specific application is configured to detect an evacuation space ES, determine the detection result of the evacuation space ES, and execute the limp-home traveling control task based on the determined detection result of the evacuation space ES.

### First Specific Application

The following describes a first specific application of the first embodiment.

As described above, a portion of the road sidewall W located in front of an emergency parking zone EZ of a road when viewed from the own vehicle V traveling on the road may cause the emergency parking zone EZ to be likely to become a blind spot from the own vehicle V, resulting in recognition of, for example, the left edge of the road being likely to be unstable.

From this viewpoint, when the detection result determiner 2405 determines that the detected evacuation space ES is in a state in which parking of the own vehicle V is likely to be difficult, the control information determiner 2404 is programmed to perform the first limp-home control routine that determines to interrupt the limp-home control toward the evacuation space ES.

Specifically, the occurrence of such a false detection of an evacuation space ES illustrated in FIG. 36 may result in the level of reliability for the detection of the evacuation space being low. Similarly, major correction of the recognized location and/or size of an evacuation space ES illustrated in FIG. 37 may result in the level of reliability for the detection of the evacuation space ES being low. Additionally, variations in location and/or shape of recognized evacuation spaces ES may result in the level of reliability for the detection of the evacuation spaces ES being low.

In order to address such cases, the processor 21 according to the first specific application is programmed to cyclically read a first limp-home control program, i.e., first limp-home control program instructions, stored in the memory device 22 in response to the input information inputted from, for example, the driver-state monitor 37 to sequentially execute, for each cycle, operations of a first limp-home control routine illustrated as a flowchart in FIG. 30B corresponding to the first limp-home control program instructions. In FIG. 30B and the subsequent figures, reference character S is an abbreviate for Step.

When starting the first limp-home control routine illustrated in FIG. 30B, the processor 21 of the drive ECU 2 serves as, for example, a limp-home control determiner to determine, based on the driver's state parameters detected by the driver-state monitor 37 and included in the input information, whether to execute the limp-home control in step S10 of FIG. 30B.

When the processor 21 determines not to execute the limp-home control due to, for example, the driver's poor health or own-vehicle's malfunction (NO in step S10), the processor 21 terminates the first limp-home control routine.

Otherwise, when the processor 21 determines to execute the limp-home control due to, for example, the driver's poor health or own-vehicle's malfunction (YES in step S10), the first limp-home control routine proceeds to step S20.

In step S20, the processor 21 serves as, for example, the evacuation space detector 2402 to detect the recognized road marking lines B43 and the left road edge, i.e., the road-edge line Le and the lane-edge recognition lines Lf of a road Rd. Then, in step S20, the processor 21 serves as, for example, the evacuation space detector 2402, to detect, based on the recognized road marking lines B43 and the left road edge, i.e., the road-edge line Le and the lane-edge recognition lines Lf, an evacuation space ES at a location where the own vehicle V is parkable in the road extending direction.

Following the operation in step S20, the processor 21 serves as, for example, the evacuation route generator 2403 and the control information determiner 2404 to generate an evacuation route ER from the current location of the own vehicle V to the evacuation space ES detected by the evacuation space detector 2402 in step S30. Then, the processor 21 serves as, for example, the control information determiner 2404 to determine control information to accordingly start, based on the determined control information, the limp-home traveling control task of causing the own vehicle V to travel from the current location to the evacuation space ES along the evacuation route ER while decelerating the own vehicle V in step S30.

Next or simultaneously with the operation in step S30, the processor 21 serves as, for example, the detection result determiner 2405 to determine the level of reliability for the detected evacuation space ES in accordance with, for example, criteria of determination related to the detection of the evacuation space ES in step S40. The criteria of determination related to the detection of the evacuation space ES include, for example, at least one of (i) information on the recognized road marking lines B43 and/or the left road edge, (ii) the amount of correction of the location and/or size of the detected evacuation space ES, and (iii) a distance, i.e., a minimum distance, of the detected evacuation space ES from the own vehicle V. The detailed descriptions of the determination in step S40 will be described later.

Following the operation in step S40, the processor 21 serves as, for example, the control information determiner 2402 to determine whether the determined level of reliability for the evacuation space ES is higher than or equal to a predetermined reliability threshold in step S50.

Upon determination that the determined level of reliability is higher than or equal to the predetermined reliability threshold (YES in step S50), the processor 21 serves as, for example, the control information determiner 2404 to continue the limp-home traveling control task of causing the own vehicle V to travel to the evacuation space ES along the evacuation route ER while decelerating the own vehicle V in step S60, and thereafter, the processor 21 terminates the first limp-home control routine.

Otherwise, upon determination that the determined level of reliability is lower than the predetermined reliability threshold (NO in step S50), the processor 21 serves as, for example, the control information determiner 2404 to interrupt the limp-home traveling control task in step S70, and thereafter, the processor 21 returns to step S20 and performs the operation in step S20 and the subsequent operations.

As described above, the first limp-home determines the level of reliability for the detection result of an evacuation space ES, and determines whether to continue or interrupt the limp-home traveling control task in accordance with the determined level of reliability for the detection result of an evacuation space ES.

This therefore makes it possible to reliably cause the own vehicle V to travel to a high-reliability evacuation space while avoiding the own vehicle V from traveling toward the evacuation space ES with a low reliability.

As a modification of the first specific application, following the operation in step S20, the processor 21 can be programmed to perform the operation in step S40 and the subsequent operations without executing the operation in step S30.

In this modification, upon determination that the determined level of reliability is higher than or equal to the predetermined reliability threshold (YES in step S50), the control information determiner 2404 to determine control information to accordingly perform, based on the determined control information, the limp-home traveling control task of causing the own vehicle V to travel from the current location to the evacuation space ES along the evacuation route ER while decelerating the own vehicle V in step S30.

Otherwise, upon determination that the determined level of reliability is lower than the predetermined reliability threshold (NO in step S50), the processor 21 serves as, for example, the control information determiner 2404 not to perform the limp-home traveling control task of causing the own vehicle V to travel from the current location to the evacuation space ES detected in step S20, and thereafter, the processor 21 returns to step S20 and performs the operation in step S20 and the subsequent operations.

### Second Specific Application

The following describes a second specific application of the first embodiment.

The driving ECU 2 according to the second specific application is configured to search for at least two evacuation spaces ES located in a road in the road extending direction, one of which is farther from the own vehicle V than the other thereof, to accordingly detect the at least two evacuation spaces ES. Then, the driving ECU 2 according to the second specific application is configured to select one of the at least two evacuation spaces ES to be used for parking of the own vehicle V in accordance with the detection result of each of the at least two evacuation spaces ES.

Specifically, the evacuation space detector 2402 according to the second specific application detects at least two evacuation spaces ES at respective at least two locations in a road; distances of the at least two locations from the own vehicle V are different from each other, and the detection result determiner 2405 determines a detection result of each of the at least two evacuation spaces ES. When the detection result determiner 2405 determines that one of the at least two evacuation spaces ES has a level of reliability lower than the predetermined reliability threshold or is in a state in which parking of the own vehicle V is likely to be difficult, the control information determiner 2404 determines the control information that causes the own vehicle V to travel to the other of the at least two evacuation spaces ES while decelerating the own vehicle V.

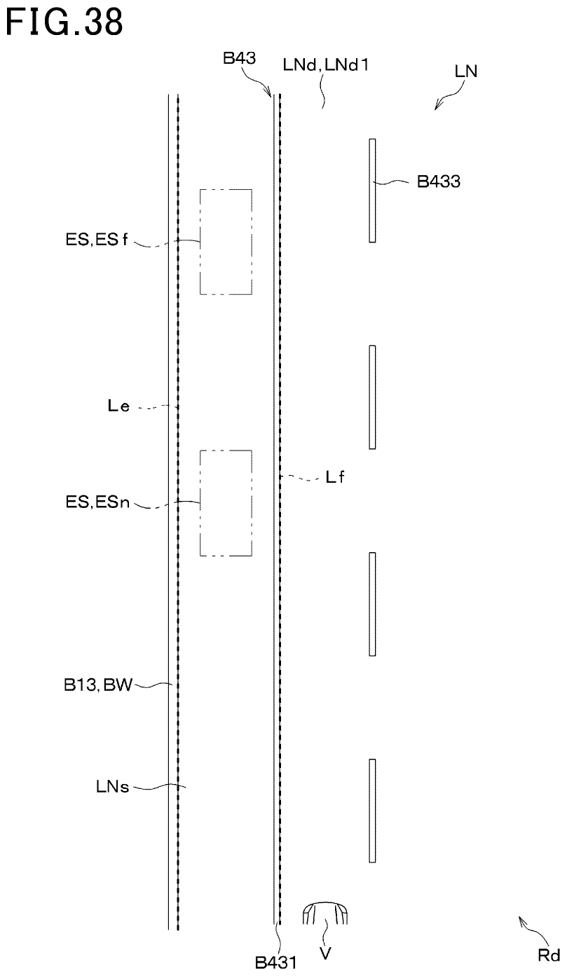

For example, FIG. 38 illustrates an example situation where the limp-home control is carried out when the own vehicle V is traveling in a section of a road Rd; the section has a road shoulder LNs, which has a width sufficiently wider than the width of the own vehicle V, continuously extending in the road extending direction.

In this situation, the recognition unit 2401 is able to recognize the road-edge line Le and the lane-edge recognition lines Lf with sufficient accuracy over a relatively long range. In this situation, the evacuation space detector 2402 therefore is able to detect, as illustrated in FIG. 38, evacuation spaces ES at different locations with a high level of reliability, one of which is farther from the own vehicle V than the other thereof. One of the detected evacuation spaces ES, which is farther from the own vehicle V than the other thereof, will also be referred to as a far-side evacuation space ESf, and the other thereof will also be referred to as a near-side evacuation space ESn. This enables the control information determiner 2404 to use the far-side evacuation space ESf to perform the limp-home control; braking control and steering control required to cause the own vehicle V to travel to the far-side evacuation space ESf are more simply carried out as compared with braking control and steering control required to cause the own vehicle V to travel to the near-side evacuation space ESn. That is, in this traveling situation illustrated in FIG. 38, the control information determiner 2404 has a higher priority use of the far-side evacuation space ESf for the limp-home traveling control task. In such a situation, the processor 21 can be programmed not to search for an evacuation space ES within a relatively near-field region of the own vehicle V.

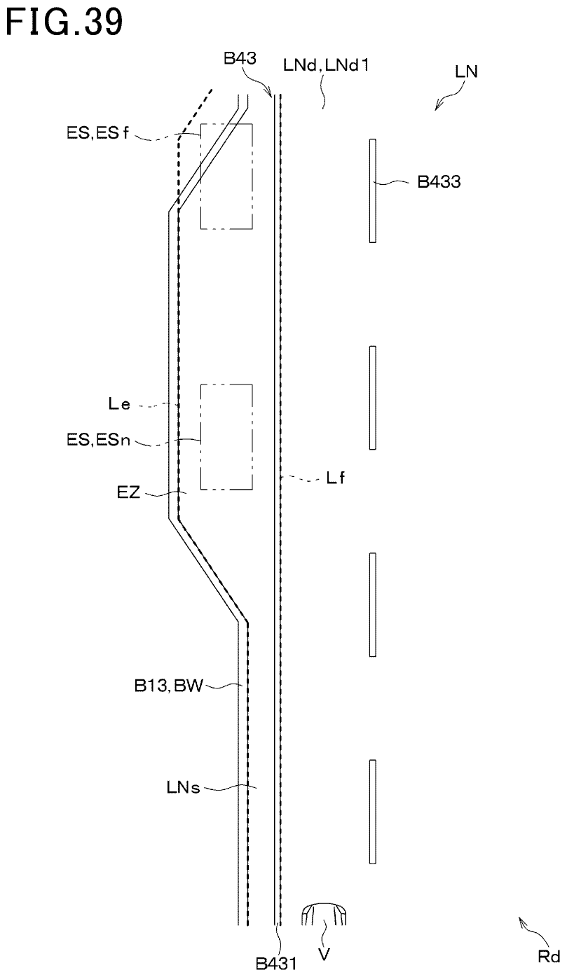

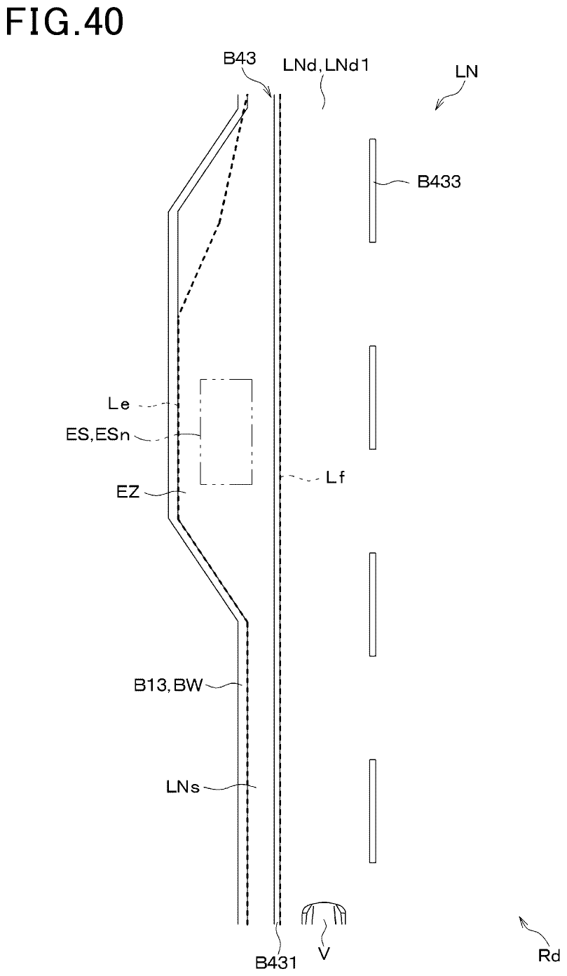

In contrast, each of FIGS. 39 and 40 illustrates an example situation where the limp-home control is carried out when the own vehicle V is traveling in a section of a road Rd having a road shoulder LNs with an emergency parking zone EZ located in the middle thereof. The road shoulder LNs has a width narrower than or substantially equal to the width of the own vehicle V, and the section is located in front of the emergency parking zone EZ.

In this situation illustrated in FIG. 39, a far-side evacuation space ESf, which is one of detected evacuation spaces ES farther from the own vehicle V than the other thereof, may be likely to have a low level of reliability. In this situation illustrated in FIG. 40, erroneous detection of the road edges may result in a far-side evacuation space ESf being undetected.

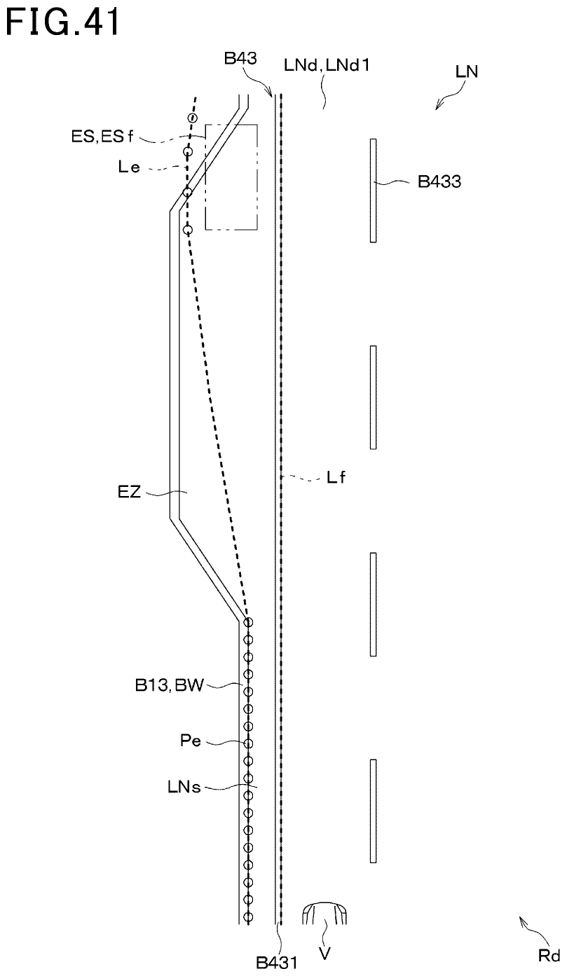

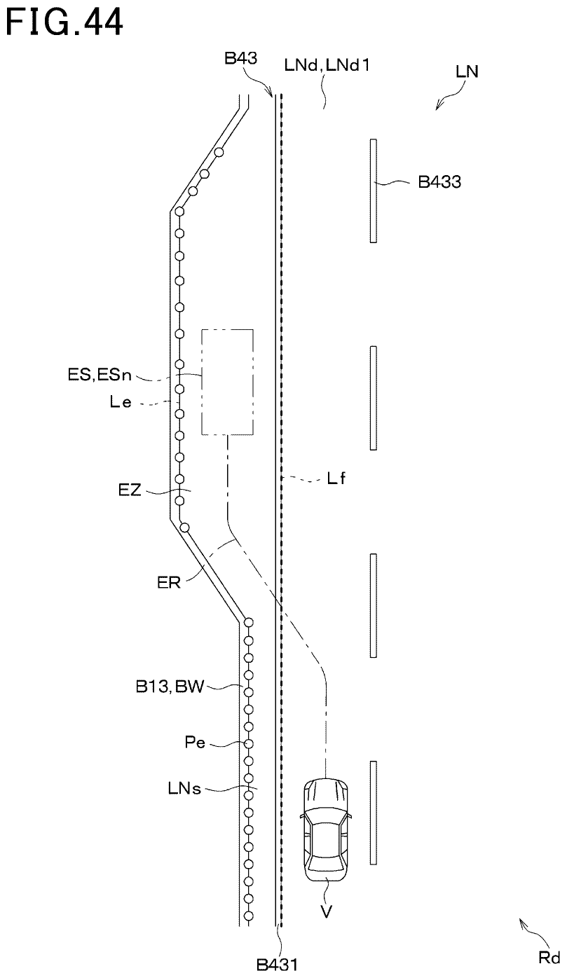

The following describes, in more detail, the example situation illustrated in FIG. 39 with reference to FIGS. 41 to 44.

In each of FIGS. 41 to 44, reference character Pe represents road-edge detection points constituting the road-edge line Le. That is, the road-edge detection points Pe, which constitute the road-edge line Pe, are detected by at least one of the ADAS sensors 31, 32, 33, and 34 or obtained by the sensor-fusion lane recognition task based on the recognition results of at least two different types of the ADAS sensors 31, 32, 33, and 34. The recognition unit 2401 can be operative to generate, i.e., calculate, the road-edge line Le based on the road-edge detection points Pe arranged in the road extending direction.

FIG. 41 is a first situation where the own vehicle V is traveling on a road Rd a certain distance before an emergency parking zone EZ.

As illustrated in FIG. 41, the evacuation space detector 2402 detects a far-side evacuation space ESf in a far-side region of an emergency parking zone EZ based on road-edge detection points Pe detected in the far-side region of an emergency parking zone EZ. The density of the road-edge detection points Pe detected in the far-side of the emergency parking zone EZ may be relatively low and there may be large errors in the road-edge detection points Pe detected in the far-side of the emergency parking zone EZ, resulting in the far-side evacuation space ESf being detected while being partly out of the emergency parking zone EZ.

In contrast, a near-side region of the emergency parking zone EZ may become a blind spot from the own vehicle V, resulting in no evacuation space ES being detected in the near-side region of the emergency parking zone EZ.

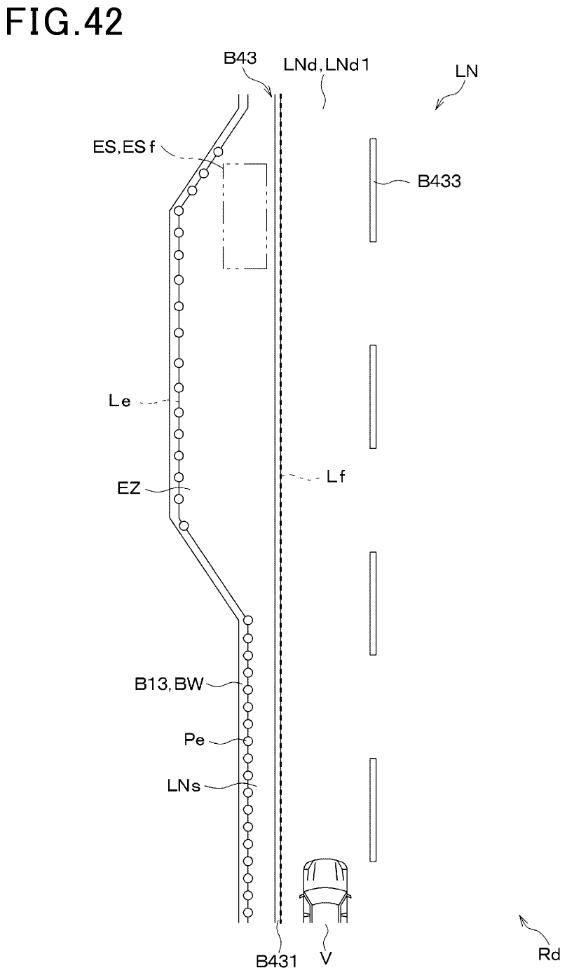

FIG. 42 is a second situation where the own vehicle V is traveling on the road Rd to be closer to the emergency parking zone EZ as compared with the first situation illustrated in FIG. 41.

As illustrated in FIG. 42, the density of the road-edge detection points Pe detected in the far-side of the emergency parking zone EZ becomes greater as compared with the first situation so that the detection accuracy of the road edge line Le in the far-side of the emergency parking zone EZ becomes higher. Then, the evacuation space detector 2402 corrects the location and size of the far-side evacuation space ESf detected in the first situation in accordance with, for example, the road edge line Le detected in the second situation.

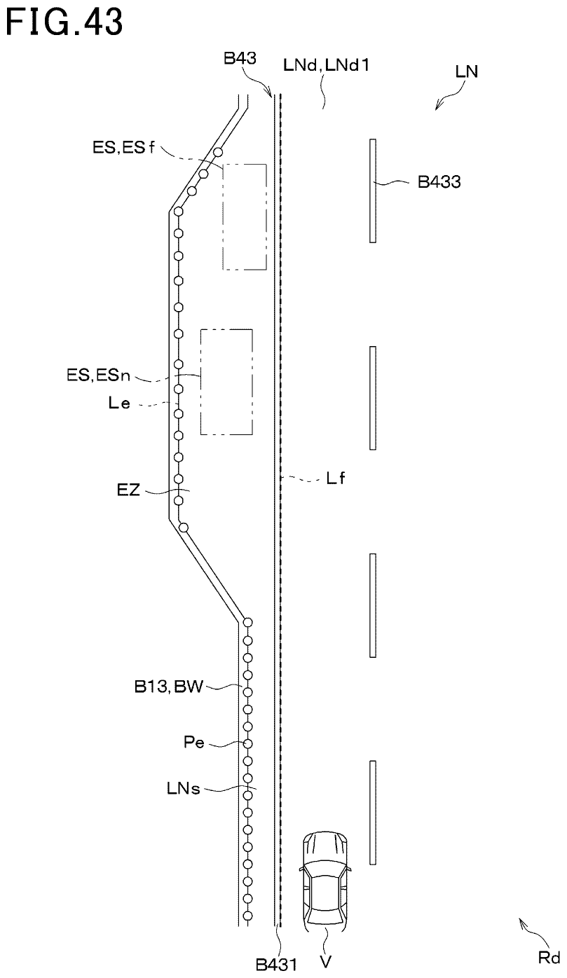

FIG. 43 is a third situation where the own vehicle V is traveling on the road Rd to be closer to the emergency parking zone EZ as compared with the second situation illustrated in FIG. 42.

As illustrated in FIG. 43, the evacuation space detector 2402 detects, based on road-edge detection points Pe detected in the near-side region of the emergency parking zone EZ, a near-side evacuation space ESn in the near-side region with a higher level of reliability than that of the far-side evacuation space ESf.

Then, the control information determiner 2404 abandons the far-side evacuation space ESf continuously tracked by the evacuation space detector 2402 to accordingly perform the limp-home traveling control task in accordance with the evacuation route ER determined from the current location of the own vehicle V to the detected near-side evacuation space ESn.

Accordingly, the driving ECU 2 according to the second specific application makes it possible to select one of at least two near- and far-side evacuation spaces ES to be used for parking of the own vehicle V; the selected one of the at least two near- and far-side evacuation spaces ES has a higher level of reliability.

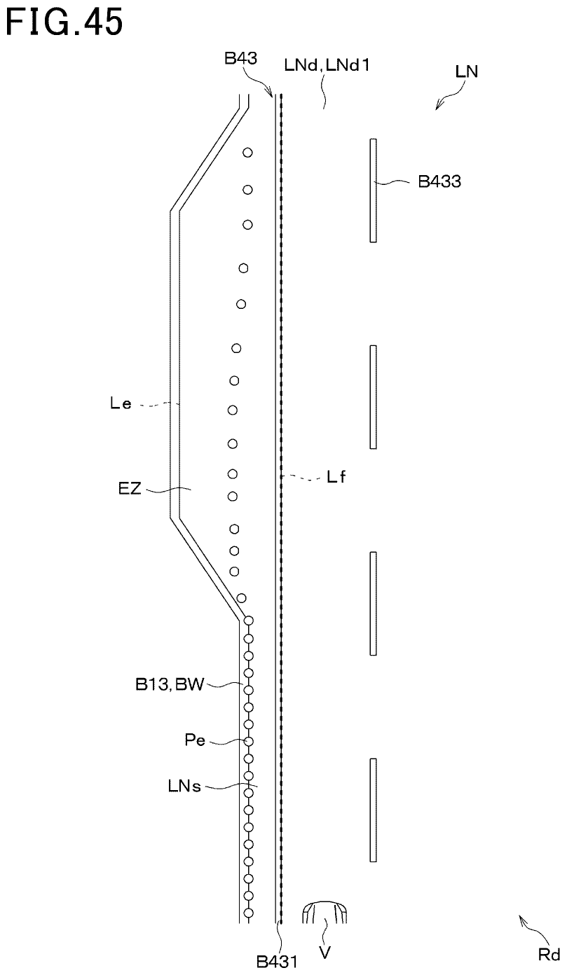

The following describes, in more detail, the example situation illustrated in FIG. 40 with reference to FIGS. 45 to 47.

FIG. 45 is a first situation where the own vehicle V is traveling on a road Rd a certain distance before an emergency parking zone EZ.

In the first situation where the own vehicle V is separated from the emergency parking zone EZ in the road extending direction illustrated in FIG. 45, the outwardly projecting portion of the road sidewall BW corresponding to the emergency parking zone EZ may become a blind spot from the own vehicle V. For this reason, the density of the road-edge detection points Pe detected in a far-side region of the road Rd corresponding to the emergency parking zone EZ may be relatively low and there may be large errors in the road-edge detection points Pe detected in the far-side region of the road Rd corresponding to the emergency parking zone EZ. This may result in the road-edge detection points Pe in the far-side region of the road Rd corresponding to the emergency parking zone EZ being erroneously detected inwardly, i.e., closer to the traveling lane LNd, as compared with the actual left edge of the road Rd. This may therefore result in no evacuation space ES being detected in the first situation illustrated in FIG. 45.

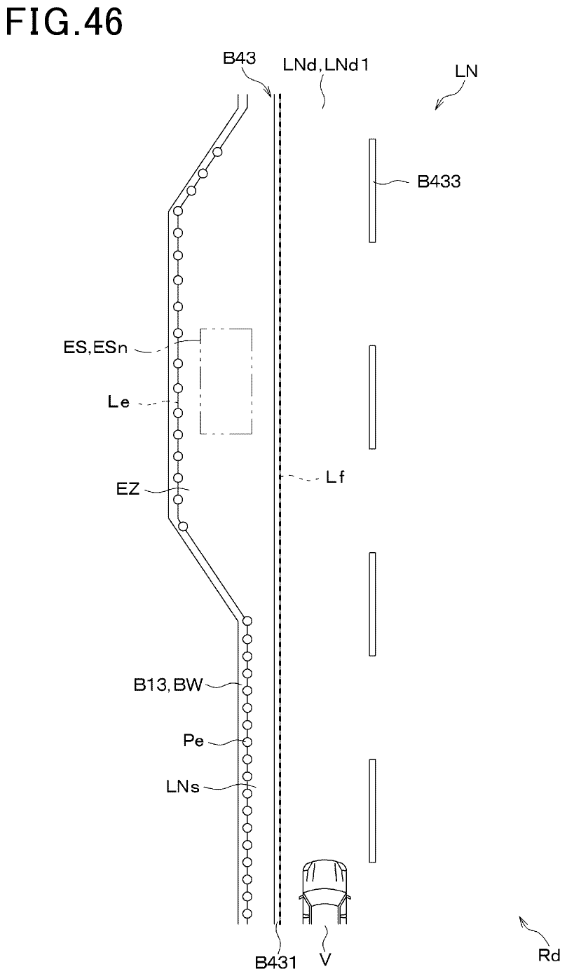

FIG. 46 is a second situation where the own vehicle V is traveling on the road Rd to be closer to the emergency parking zone EZ as compared with the first situation illustrated in FIG. 45.

As illustrated in FIG. 46, the density of the road-edge detection points Pe detected in the far-side region of the road Rd corresponding to the emergency parking zone EZ becomes greater as compared with the first situation so that the detection accuracy of the road edge line Le in the far-side region of the road Rd corresponding to the emergency parking zone EZ becomes higher. Then, the evacuation space detector 2402 is able to detect a near-side evacuation space ESn in the emergency parking zone EZ with high accuracy.

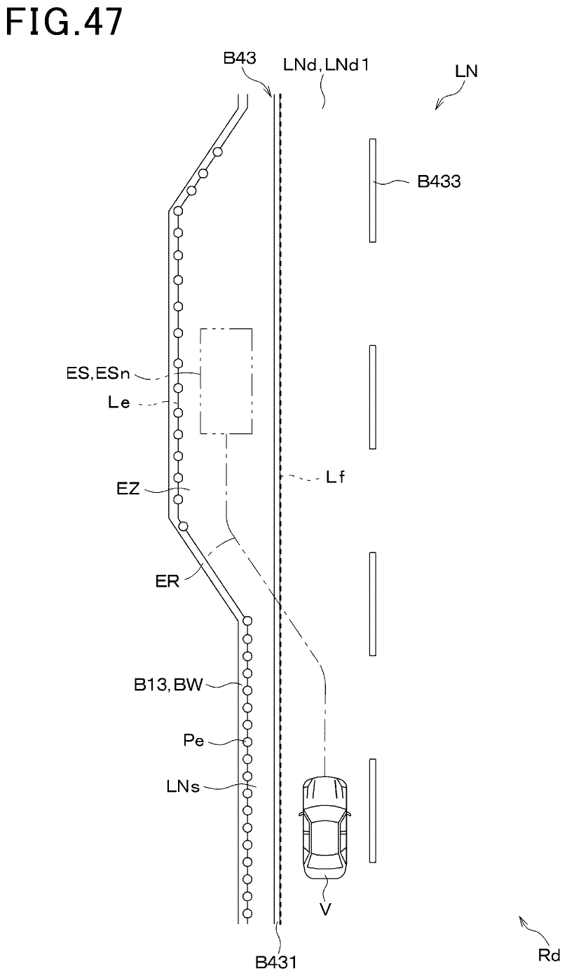

FIG. 47 is a third situation where the own vehicle V is traveling on the road Rd to be closer to the emergency parking zone EZ as compared with the second situation illustrated in FIG. 46.

That is, even if the evacuation space detector 2402 is unable to detect a far-side evacuation space ESf, as illustrated in FIG. 47, the control information determiner 2404 performs, based on the near-side evacuation space ESn detected with a high level of reliability, the limp-home traveling control task in accordance with the evacuation route ER determined from the current location of the own vehicle V to the detected near-side evacuation space ESn.

As described above, the driving ECU 2 according to the second specific application is configured to search, within a predetermined detection region of at least one of the ADAS sensors 31, 32, 33, and 34 in a section of a road RD, for at least two evacuation spaces ES located at different locations in the road extending direction; the section of the road Rd has a road shoulder LNs with an emergency parking zone EZ located in the middle thereof and the road shoulder LNs has a width narrower than or substantially equal to the width of the own vehicle V.

The driving ECU 2 according to the second specific application is configured to select, in terms of, for example, the amount of braking of the own vehicle V and/or errors in a controlled location of the own vehicle V, one of the at least two evacuation spaces ES to be used for parking of the own vehicle V. This therefore makes it possible to reliably cause the own vehicle V to travel to the selected evacuation space ES while reliably avoiding sudden stop of the own vehicle V in the middle of the traveling lane LN.

The driving ECU 2 according to the second specific application can be configured to detect plural evacuation spaces at different locations in a road Rd respectively having different distances relative to the own vehicle V or at different sections in a road Rd; the different sections respectively have different curvatures. The driving ECU 2 according to the second specific application can be configured to change each of the first and second thresholds for each of locations to be detected for respective plural evacuation spaces.

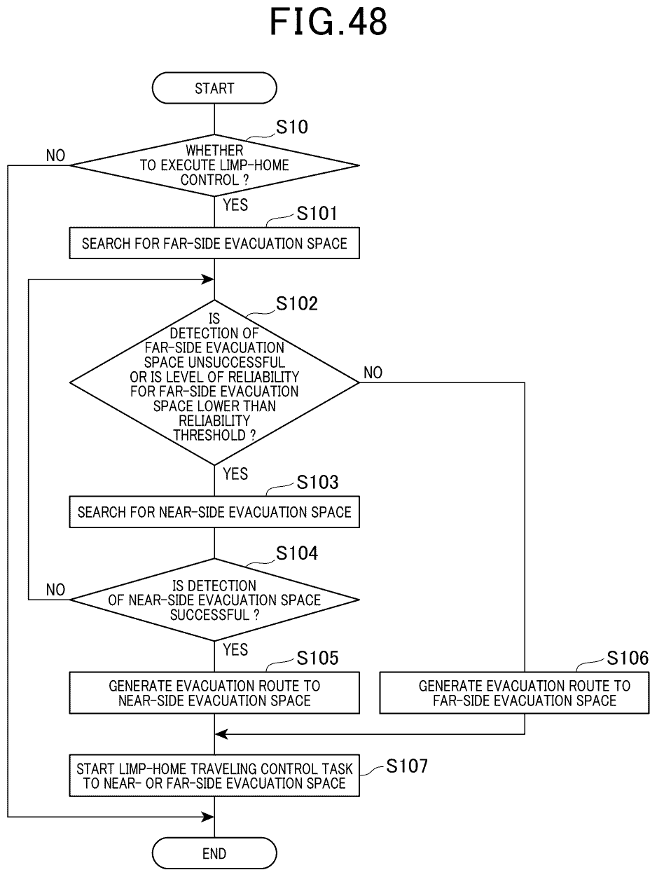

The processor 21 is programmed to cyclically read a second limp-home control program, i.e., second limp-home control program instructions, stored in the memory device 22 in response to the input information inputted from, for example, the driver-state monitor 37 to sequentially execute, for each cycle, operations of a second limp-home control routine according to the second specific application illustrated as a flowchart in FIG. 48 corresponding to the second limp-home control program instructions.

When starting the second limp-home control routine illustrated in FIG. 48, the processor 21 of the drive ECU 2 serves as, for example, a limp-home control determiner to determine, based on the driver's state parameters detected by the driver-state monitor 37 and included in the input information, to execute the limp-home control in step S10 of FIG. 48.

When the processor 21 determines not to execute the limp-home control due to, for example, the driver's poor health or own-vehicle's malfunction (NO in step S10), the processor 21 terminates the second limp-home control routine.

Otherwise, when the processor 21 determines to execute the limp-home control due to, for example, the driver's poor health or own-vehicle's malfunction (YES in step S10), the second limp-home control routine proceeds to step S101.

In step S101, the processor 21 serves as, for example, the evacuation space detector 2402 to detect the recognized road marking lines B43 and the road edges, i.e., the road-edge line Le and the lane-edge recognition lines Lf of a road Rd. Then, in step S101, the processor 21 serves as, for example, the evacuation space detector 2402 to search for an evacuation space ES, i.e., a far-side evacuation space ESf, in a far-side region of the road Rd. The far-side region is a far-side of the predetermined detection region of at least one of the ADAS sensors 31, 32, 33, and 34 relative to the own vehicle V.

Following the operation in step S101, the processor 21 serves as for example, the detection result determiner 2405 to determine whether detection of a far-side evacuation space ESf based on the search in step S101 is unsuccessful. Upon determination that detection of a far-side evacuation space ESf is successful, the processor 21 serves as, for example, the detection result determiner 2405 to determine the level of reliability for the detected far-side evacuation space ESf in accordance with, for example, the criteria of determination related to the detection of the far-side evacuation space ESf, and determines whether the determined level of reliability for the far-side evacuation space ESf is lower than the predetermined reliability threshold in step S102.

Upon determination that detection of a far-side evacuation space ESf is unsuccessful or that the level of reliability for the detected far-side evacuation space ESf is lower than the predetermined reliability threshold (YES in step S102), the second limp-home control routine proceeds to step S103.

In step S103, the processor 21 serves as, for example, the evacuation space detector 2402 to determine not to perform the limp-home traveling task of causing the own vehicle V to travel to the detected far-side evacuation space ESf. Then, in step S103, the processor 21 serves as, for example, the evacuation space detector 2402 to search for an evacuation space ES, i.e., a near-side evacuation space ESn, in a near-side region of, for example, the road Rd; the near-side region is located to be nearer than the far-side evacuation space ESn in the road extending direction.

Following the operation in step S103, the processor 21 serves as for example, the detection result determiner 2405 to determine whether detection of a near-side evacuation space ESn based on the search in step S103 is successful in step S104.

Upon determination that detection of a near-side evacuation space ESn is unsuccessful (NO in step S104), the processor 21 returns to step S101 and performs the operation in step S101 and the subsequent operations.

Otherwise, upon determination that detection of a near-side evacuation space ESn is successful (YES in step S104), the second limp-home control routine proceeds to step S105.

In step S105, the processor 21 serves as, for example, the evacuation route generator 2403 to generate an evacuation route ER from the current location of the own vehicle V to the near-side evacuation space ESn.

Otherwise, upon determination that detection of a far-side evacuation space ESf is successful or that the level of reliability for the detected far-side evacuation space ESf is higher than or equal to the predetermined reliability threshold (NO in step S102), the second limp-home control routine proceeds to step S106.

In step S106, the processor 21 serves as, for example, the evacuation route generator 2403 to generate an evacuation route ER from the current location of the own vehicle V to the far-side evacuation space ESf.

Following the operation in step S105 or S106, the processor 21 serves as, for example, the control information determiner 2404 to determine control information on the own vehicle V for causing the own vehicle V to travel from the current location to the evacuation space ES along the evacuation route ER generated in step S105 or S106, thus starting the limp-home traveling control task of causing the own vehicle V to travel to the near-side evacuation space ESn or far-side evacuation space ESf along the evacuation route ER generated in step S105 or S106 in step S107.

As described above, the driving ECU 2 of the second specific application makes it possible to select a near-side evacuation space ESn to be used for parking of the own vehicle V upon determination that (i) detection of a far-side evacuation space ESf is unsuccessful or the level of reliability of the far-side evacuation space ESf is lower than the predetermined reliability threshold. This therefore enables the own vehicle V to reliably travel to the near-side evacuation space ESn while preventing (i) repetition of searching for a high-side evacuation space ESf or (ii) movement of the own vehicle V from the current location to the far-side evacuation space ESf with a lower level of reliability.

### Modification of Second Specific Application

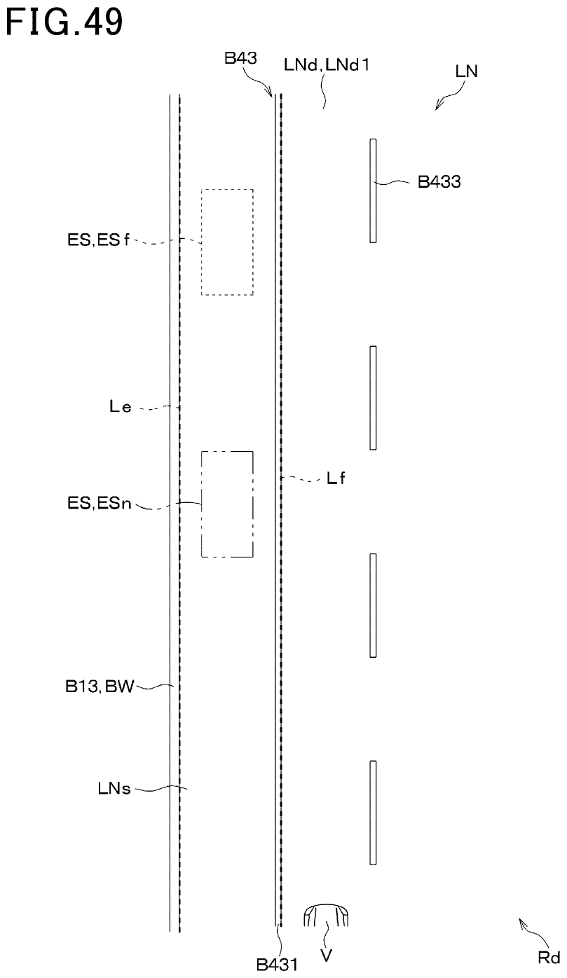

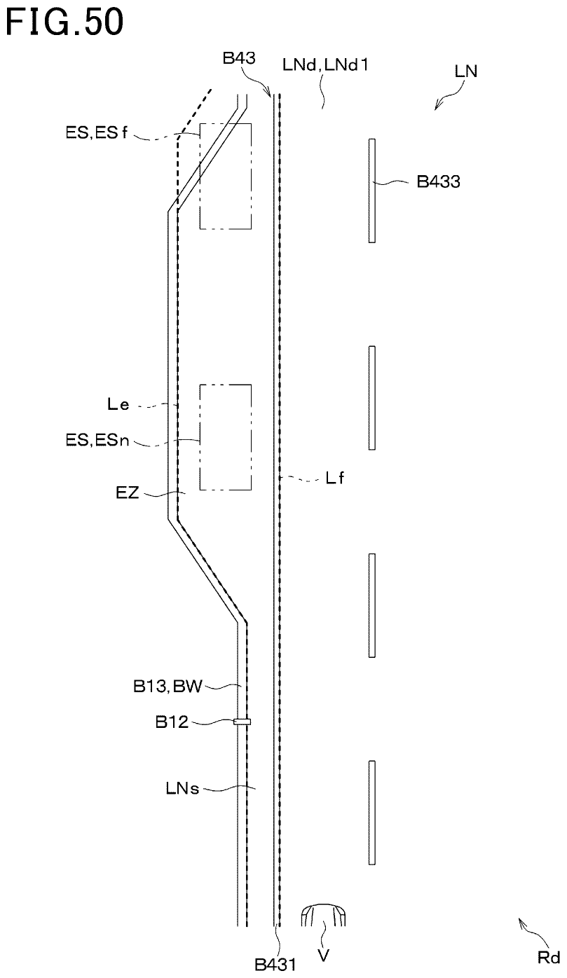

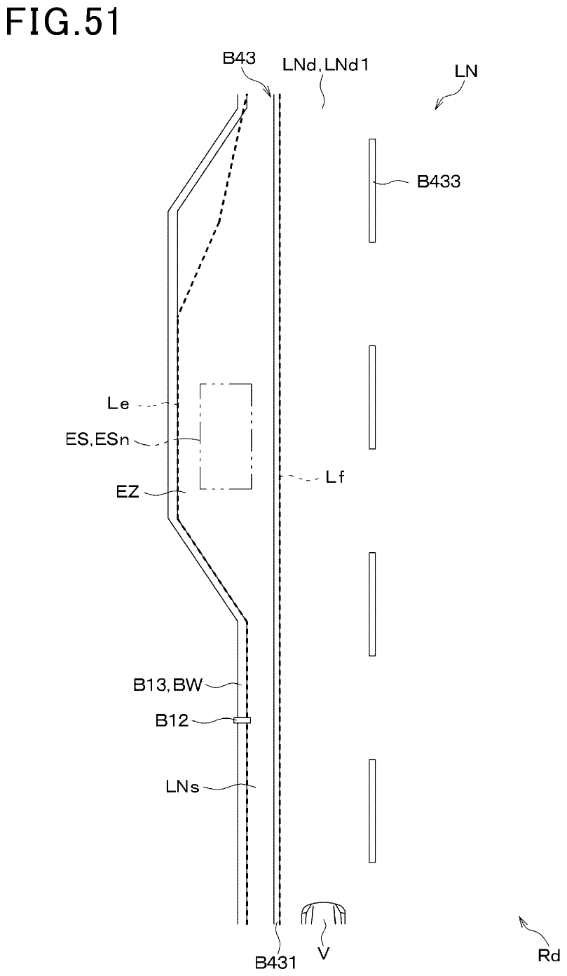

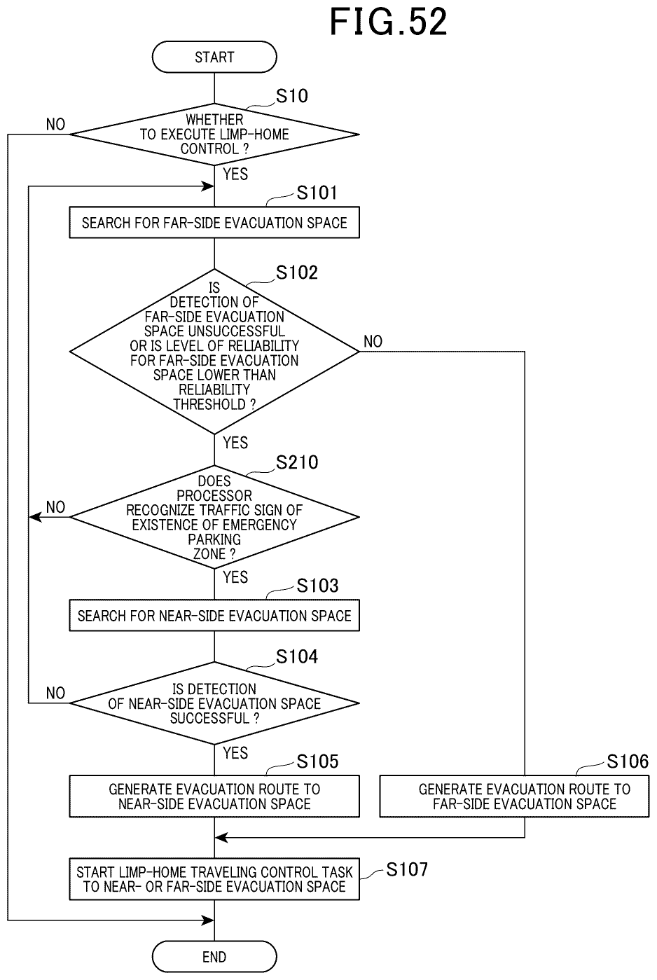

FIG. 49 illustrates, in the situation illustrated in FIG. 38, a near-side evacuation space ESn is detected but a far-side evacuation space ESf is not detected for any reason. In this situation illustrated in FIG. 49, if the processor 21 waits a little time, the processor 21 is likely to detect a far-side evacuation space ESf. For this reason, in this situation illustrated in FIG. 49, there is little need to employ the limp-home control based on the near-side evacuation space ESn that may require sudden deceleration as compared with a far-side evacuation space ESf. Accordingly, this situation illustrated in FIG. 49 is different from the situation illustrated in FIG. 50 where the portion of the road sidewall BW located in front of the emergency parking zone EZ of the road Rd when viewed from the own vehicle V traveling on the road Rd may cause the emergency parking zone EZ to be likely to become a blind spot from the own vehicle V, resulting in a detected far-side evacuation space ESf in the emergency parking zone EZ being likely to have a low level of reliability. Additionally, this situation illustrated in FIG. 49 is different from the situation illustrated in FIG. 51 where the portion of the road sidewall BW located in front of the emergency parking zone EZ of the road Rd when viewed from the own vehicle V traveling on the road Rd may cause the emergency parking zone EZ to be likely to become a blind spot from the own vehicle V, so that erroneous detection of the road edges may result in a far-side evacuation space ESf being undetected.

In such a road Rd with an emergency parking zone EZ illustrated in, for example, FIG. 50 or FIG. 51, a traffic sign B12, which represents the existence of the emergency parking zone EZ, is likely to be located in front of the emergency parking zone EZ in the road Rd.

From this viewpoint, the evacuation space detector 2402 according to a modification of the second specific application is operative to determine whether the recognition unit 2401 recognizes information indicative of the existence of an emergency parking zone EZ in the traveling course of the own vehicle V of a road Rd, and detect plural evacuation spaces at different locations in the emergency parking zone EZ of the road Rd in response to determination that the recognition unit 2401 recognizes the information indicative of the existence of an emergency parking zone EZ. The information indicative of the existence of an emergency parking zone EZ typically includes recognition information on a traffic sign B12 indicative of the existence of an emergency parking zone EZ. This therefore makes it possible for the processor 21 to reliably detect an evacuation space ESn in a near-side region of the emergency parking zone EZ. Additionally, this modification of the second specific application makes it possible to limit cases of detecting plural evacuation spaces ES at different locations in a road Rd as few times as possible, thus reducing processing load of the processor 21.

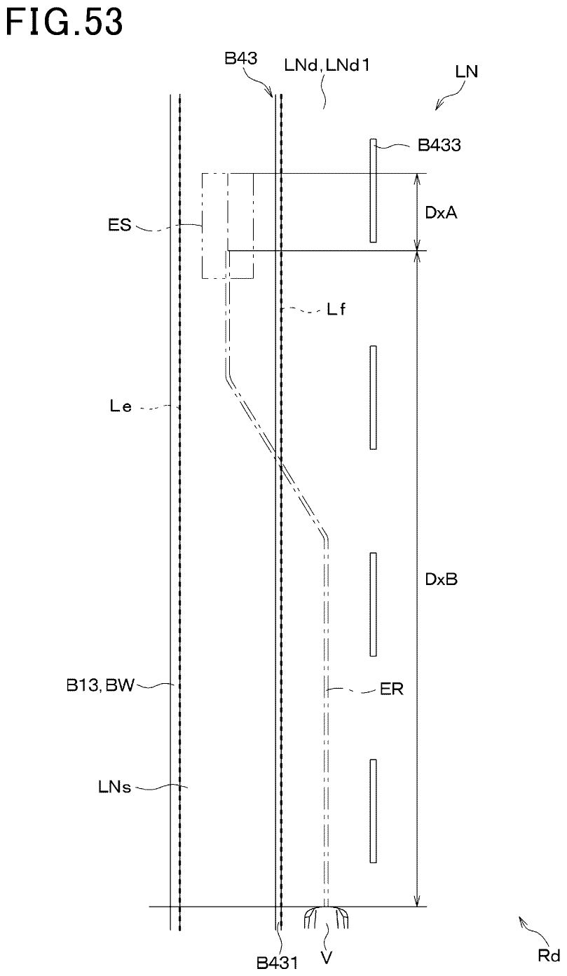

FIG. 52 is a flowchart schematically illustrating a modified second limp-home control routine; a part of the second limp-home control routine illustrated in FIG. 48 has been modified to create the modified second limp-home control routine illustrated in FIG. 52. Specifically, an operation in step S201 is added to a location between the operation in step S102 and the operation in step S103.

That is, because the operations in steps S101 to S107 of FIG. 52 are respectively identical to those in steps S101 to S107 of FIG. 48, and therefore additional descriptions of the operations in steps S101 to S107 of FIG. 52 are omitted.

Upon determination that detection of a far-side evacuation space ESf is unsuccessful or that the level of reliability for the detected far-side evacuation space ESf is lower than the predetermined reliability threshold (YES in step S102), the second limp-home control routine proceeds to step S210.

In step S210, the processor 21 determines whether the processor 21 recognizes a traffic sign B12 indicative of the existence of an emergency parking zone EZ.

Upon determination that the processor 21 recognizes a traffic sign B12 indicative of the existence of an emergency parking zone EZ (YES in step S201), the modified second limp-home control routine proceeds to step S103.

In step S103, the processor 21 serves as, for example, the evacuation space detector 2402 to search for an evacuation space ES, i.e., a near-side evacuation space ESn, in the near-side region of the road Rd, i.e., in a near-side region of the emergency parking zone EZ located to be nearer to the own vehicle V.

Otherwise, upon determination that the processor 21 does not recognize a traffic sign B12 indicative of the existence of an emergency parking zone EZ (NO in step S201), the processor 21 returns to step S101 and performs the operation in step S101 and the subsequent operations.

As described above, the modified second limp-home control routine makes it possible for the processor 21 to reliably detect an evacuation space ESn in a near-side region of the emergency parking zone EZ. Additionally, this modification of the second specific application makes it possible to limit cases of detecting plural evacuation spaces ES at different locations in a road Rd to be as few as possible, thus reducing processing load of the processor 21.

### Third Specific Application

The following describes a third specific application of the first embodiment.

The third specific application is related to speed control of the own vehicle V traveling along the evacuation route ER.

Specifically, in step S30 of the first limp-home control routine and step S107 of the second limp-home control routine, the processor 21 according to the third specific application serves as, for example, the control information determiner 2404 to change, as illustrated in FIGS. 53 to 55, how to decelerate the own vehicle V in accordance with change of the relative distance of the detected evacuation space ES from the own vehicle V. In particular, the processor 21 serves as, for example, the control information determiner 2404 to appropriately control the timing of braking the own vehicle V and/or the level of deceleration of the own vehicle V in accordance with change of the relative distance of the detected evacuation space ES from the own vehicle V. In each of FIGS. 53 to 55, the evacuation route ER is comprised of plural sections, for example, first, second, and third sections, in each of which the speed of the own vehicle V is different from one another. The first section is shown by a dash-dotted single line, the second section is shown by a dash-dotted double line, and the third section is shown by a dash-dotted triple line. The speed of the own vehicle V traveling in the second section is controlled to be higher than that of the own vehicle V traveling in the first section, and the speed of the own vehicle V traveling in the third section is controlled to be higher than that of the own vehicle V traveling in the second section.

For example, FIG. 53 schematically illustrates an example situation where the limp-home control of the own vehicle V to an evacuation space ES located to have a sufficiently long distance from the own vehicle V is carried out when the own vehicle V is traveling in a section of a road Rd; the section has a road shoulder LNs, which has a width sufficiently wider than the width of the own vehicle V, continuously extending in the road extending direction.

In this situation, the control information determiner 2404 according to the third specific application is operative to partition the evacuation route ER into a last section DxA immediately previous to parking of the own vehicle V in the evacuation space ES and a guide section DxB before the last section DxA. Then, the control information determiner 2404 according to the third specific application is operative to cause the own vehicle V to travel at a substantially constant speed of, for example, vm1 along the guide section DxB, and brake the own vehicle V in the last section DxA to finally stop the own vehicle V in the last section DxA. The constant speed vm1 can be set to, for example, 10 km/h, which can be freely changed or corrected. The last section DxA corresponds to the deceleration and stop section Dx4 illustrated in FIG. 35, and the guide section DxB corresponds to the evacuation preparation section Dx2 and the evacuation traveling section Dx3 illustrated in FIG. 35.

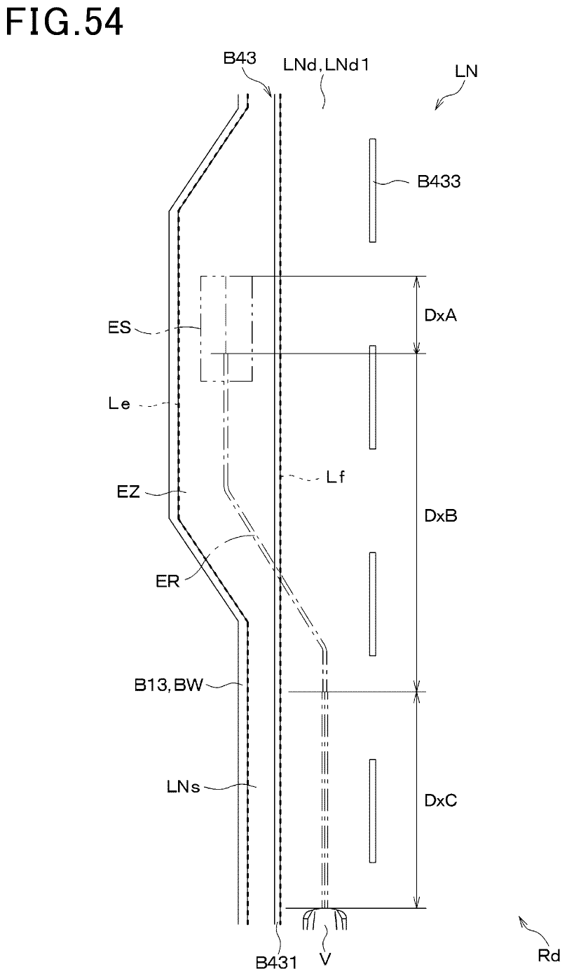

As another example, FIG. 54 schematically illustrates an example situation where the limp-home control of the own vehicle V to an evacuation space ES detected in an emergency parking zone EZ is carried out.

In this situation, the evacuation space ES detected and used by the limp-home control has a relatively close range relative to the own vehicle V.

From this viewpoint, in the example situation illustrated in FIG. 54, the control information determiner 2404 according to the third specific application is operative to partition the evacuation route ER into the last section DxA immediately previous to parking of the own vehicle V in the evacuation space ES, a guide section DxB1 before the last section DxA, and an early deceleration section DxC before the guide section DxB1. That is, the example situation illustrated in FIG. 54 represents that a part of the guide section DxB illustrated in FIG. 53 that is closer to the own vehicle V than the remaining section of the guide section DxB illustrated in FIG. 53 is.

Then, the control information determiner 2404 according to the third specific application is operative to start deceleration of the own vehicle V when the own vehicle V enters the early deceleration section DxC, and gradually decelerate the own vehicle V traveling along the early deceleration section DxC and the guide section DxB to thereby reduce the speed of the own vehicle V down to a predetermined speed vm2 of, for example, 5 km/h until the own vehicle V reaches the end of the guide section DxB. The speed vm2 can be freely changed or corrected.

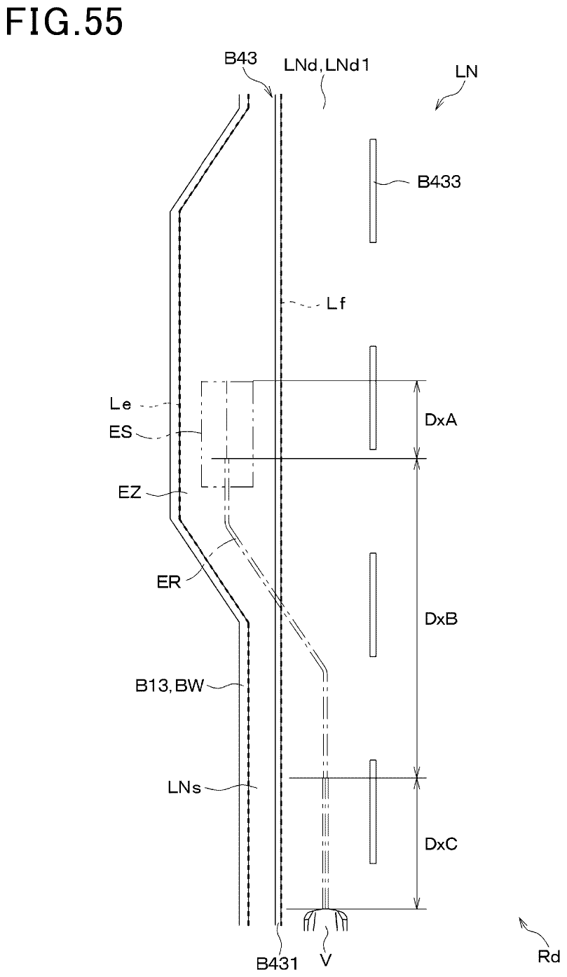

As a further example, FIG. 55 schematically illustrates an example situation where the location of an evacuation space ES is specified in an emergency parking zone EZ to be closer to the own vehicle V than that of the evacuation space ES thereto illustrated in FIG. 54.

As compared with the example situation illustrated in FIG. 54, in the example situation illustrated in FIG. 55, the control information determiner 2404 according to the third embodiment is operative to increase the level of deceleration of the own vehicle V traveling along the early deceleration section DxC and the guide section DxB.

### Fourth Specific Application

The following describes a fourth specific application of the first embodiment.

The fourth specific application shows, in detail, how to determine the level of reliability of the evacuation space ES in each of step S40 of the first limp-home control routine and step S102 of the second limp-home control routine.

The processor 21 of the fourth specific application is programmed to use, as a parameter of the level of reliability of an evacuation space ES, at least one of (i) a first level of reliability Qe1 of the road edge, i.e., the left road edge, (ii) a second level of reliability Qe2 of the road edge, i.e., the left road edge, and (iii) A third level of reliability Qw of the width of the evacuation space ES.

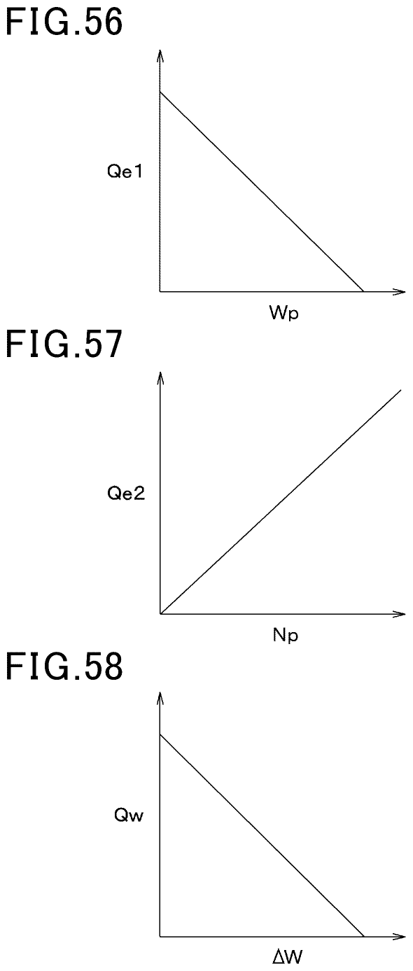

FIG. 56 illustrates an example of a relationship between the variable of the first level of reliability Qe1 of the road edge and the variable of a detection-point interval Wp between each adjacent pair of the road-edge detection points Pe. FIG. 57 illustrates an example of a relationship between the variable of the second level of reliability Qe2 of the road edge and the variable of the number Np of the road-edge detection points Pe.

FIG. 56 shows that, the smaller the road-edge interval Wp, i.e., the greater the density of the road-edge detection points Pe, the higher the first level of reliability Qe1 of the road edge, i.e., the level of reliability of the evacuation space ES. Similarly, FIG. 57 shows that, the greater the number Np of the road-edge interval Wp, i.e., the greater the density of the road-edge detection points Pe, the higher the second level of reliability Qe2 of the road edge, i.e., the level of reliability of the evacuation space ES.

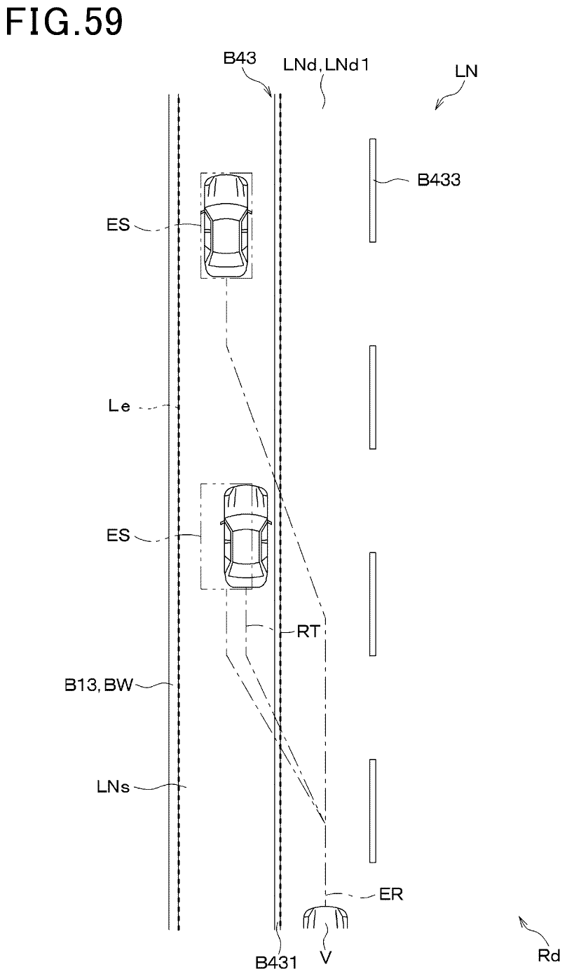

FIG. 58 illustrates an example of a relationship between the variable of the third level of reliability Qw of the width of the evacuation space ES and the variable of a correction quantity Aw of the width of the evacuation space ES in the road width direction. FIG. 58 shows that the smaller the correction quantity Aw of the width of the evacuation space ES, the higher the third level of reliability Qw of the width of the evacuation space ES, i.e., the level of reliability of the evacuation space ES.

Like the relationship between the variable of the first level of reliability Qe1 of the road edge and the variable of the detection-point interval Wp illustrated in FIG. 56, there is a relationship between the variable of a predicted travel distance of the own vehicle V to an evacuation space ES and the variable of a fourth level of distance reliability Qd of the evacuation space ES; the fourth level of distance reliability Qd of the evacuation space ES is a parameter of the level of reliability of the evacuation space ES.

Specifically, the smaller the predicted travel distance of the own vehicle V to an evacuation space ES, the higher the fourth level of distance reliability Qd of the evacuation space ES, i.e., the level of reliability of the evacuation space ES.

Accordingly, in each of step S40 of the first limp-home control routine and step S102 of the second limp-home control routine, the processor 21 is programmed to determine the level of reliability of the evacuation space ES in accordance with the criteria of determination related to the detection of the evacuation space ES that includes at least one of the relationships described above and at least one of (i) the information on the recognized road marking lines B43 and/or the road edges, (ii) the amount of correction of the location and/or size of the detected evacuation space ES, and (iii) the distance, i.e., the minimum distance, of the detected evacuation space ES from the own vehicle V.

The relationships set forth above can be stored as information items in the memory device 22 and/or can be written in the program instructions of the first or second limp-home control routine.

Specifically, in each of step S40 of the first limp-home control routine and step S102 of the second limp-home control routine, the processor 21 of the fourth embodiment is programmed to select, as the level of reliability of the evacuation space ES, at least one of the first level of reliability Qe1 of the road edge, the second level of reliability Qe2 of the road edge, the third level of reliability Qe3 of the width of the evacuation space ES, and the fourth level of distance reliability Qd of the evacuation space ES. Alternatively, in each of step S40 of the first limp-home control routine and step S102 of the second limp-home control routine, the processor 21 is programmed to calculate an integrated value of at least two of the first level of reliability Qe1 of the road edge, the second level of reliability Qe2 of the road edge, the third level of reliability Qw of the width of the evacuation space ES, and the fourth level of distance reliability Qd of the evacuation space ES.

For example, the processor 21 can be programmed to calculate an integrated value of a selected two of the first level of reliability Qe1, the second level of reliability Qe2, the third level of reliability Qw, and the fourth level of distance reliability Qd in accordance with the following equation (eq1A):

$$Px = \frac{PA \cdot PB}{PA \cdot PB + ( 1 - PA ) \cdot ( 1 - PB )} \qquad ( eq1A )$$

where:

PA represents a first value indicative of one of the selected two of the first to fourth levels of reliability and distance reliability Qe1, Qe2, Qw, and Qd;

PB represents a second value indicative of the other one of the selected two of the first to fourth levels of reliability and distance reliability Qe1, Qe2, Qw, and Qd; and

Px represents the integrated value of the first and second values PA and PB.

Each of the first and second values PA and PB takes a number between 0 and 1 inclusive.

Because various methods of calculating an integrated value of plural levels of reliability, i.e., plural levels of likelihood, are well known at the time of filing the present application, and therefore additional descriptions of how to calculate an integrated value of the first to fourth levels of reliability and distance reliability Qe1, Qe2, Qw, and Qd are omitted in the present disclosure.

### Fifth Specific Application

The following describes a fifth specific application of the first embodiment.

The fifth specific application is related to the limp-home traveling control task of the own vehicle V traveling along the evacuation route ER.

For example, FIG. 59 illustrates the limp-home traveling control task of the own vehicle V in a case where a detected evacuation space ES has a relatively distant location from the own vehicle V. As illustrated in FIG. 59, the limp-home traveling control task enables the own vehicle V to follow successfully the evacuation route ER so as to be relatively easily parked in the detected evacuation space ES.

In contrast, as illustrated in FIG. 59, in another case where a detected evacuation space ES has a relatively near location from the own vehicle V, the limp-home traveling control task of the own vehicle V may result in an actual traveling trajectory RT of the own vehicle V being significantly deviated from the evacuation route ER. This may result in an actual position of the own vehicle V parked in the detected evacuation space ES in the road width direction being likely to be offset from a designed position of the own vehicle V parked in the detected evacuation space ES based on the evacuation route ER. This is because a low speed of the own vehicle V may cause lateral movement of the own vehicle V based on a steering angle of the own vehicle V to be smaller than a predicted lateral movement based on the steering angle of the own vehicle V.

From this viewpoint, in each of step S30 of the first limp-home control routine and step S107 of the second limp-home control routine, the processor 21 of the fifth embodiment serves as, for example, the control information determiner 2404 to change at least one control parameter included in the limp-home traveling control task of the own vehicle V traveling along the evacuation route ER in accordance with the speed of the own vehicle V and/or the location of the evacuation space ES relative to the own vehicle V. The at least one control parameter included in the limp-home traveling control task of the own vehicle V, which includes, for example, a control gain Gn and/or a control algorithm, is configured to affect the level of response of the actual limp-home control operation to the own vehicle V.

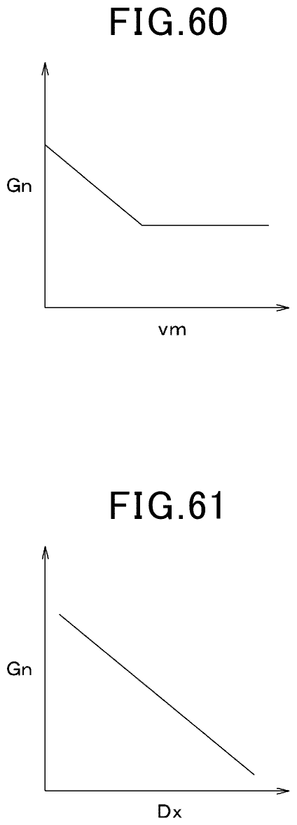

Specifically, the control information determiner 2404 increases the control gain Gn as the at least one control parameter included in the limp-home traveling control task of the own vehicle V to accordingly increase the level of response of the actual limp-home control operation to the own vehicle V to be higher as the speed (see reference character vm in FIG. 60) of the own vehicle V becomes lower (see FIG. 60). Alternatively, the control information determiner 2404 increases the control gain Gn as the at least one control parameter included in the limp-home traveling control task of the own vehicle V to accordingly increase the level of response of the actual limp-home control operation to the own vehicle V to be higher as the relative distance (reference character Dx) of the detected evacuation space ES relative to the own vehicle V becomes shorter (see FIG. 61).

Accordingly, the fifth embodiment makes it possible for the own vehicle V to more easily follow the evacuation route ER.

### Sixth Specific Application

The following describes a sixth specific application of the first embodiment.

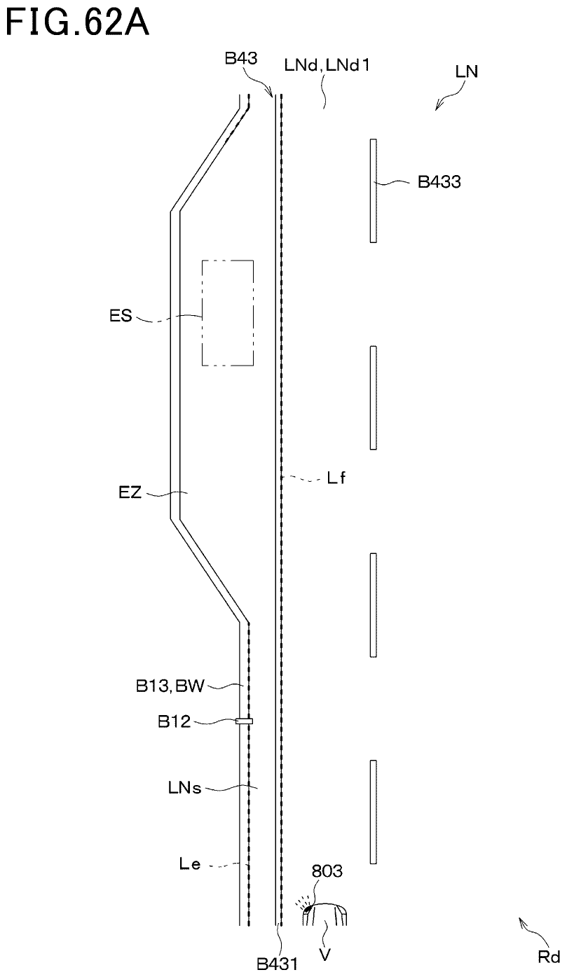

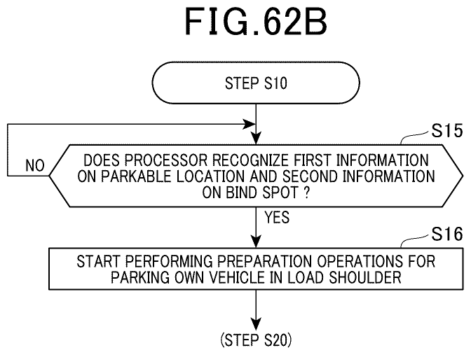

As illustrated in FIG. 62A, because an emergency parking zone EZ is likely to become a blind spot from the own vehicle V, recognition of a road edge, i.e., a left edge of the road Rd may be interrupted, so that a recognized road edge may include missing portions.

Additionally, in such a road Rd with an emergency parking zone EZ illustrated in, for example, FIG. 62A, a traffic sign B12, which represents the existence of the emergency parking zone EZ, is likely to be located in front of the emergency parking zone EZ in the road Rd.

The processor 21 can therefore recognize an existence of a space in which an evacuation space ES is detectable in a road Rd in the traveling course of the own vehicle V as long as the processor 21 recognizes (i) information indicative of the existence of an emergency parking zone EZ and (ii) information indicative of the existence of a blind spot from the own vehicle V in the road Rd.

From this viewpoint, immediately after the operation in step S10 of each of the first and second limp-home control routines, the processor 21 of the driving ECU 2 according to the sixth embodiment serves as, for example, the recognition unit 2401 to determine whether the processor 21 recognizes first information indicative of a parkable location in a road shoulder LNs and second information indicative of the existence of a blind spot from the own vehicle V in step S15 in FIG. 62B.

The first information is, for example, information indicative of the existence of an emergency parking zone EZ, and the second information is, for example, information indicative of breaks in the road-edge line Le or indicative of a greater space between at least one adjacent pair of road-edge detection points Pe than the regular intervals between the road-edge detection points Pe.

Upon determination that the processor 21 does not recognize the first information and the second information (NO in step S15), processor 21 repeats the determination in step S15.

Otherwise, upon determination that the processor 21 recognizes the first information and the second information (YES in step S15), processor 21 starts performing preparation operations for parking the own vehicle V in the load shoulder LNs in step S16. The preparation operations include, for example, deceleration of the own vehicle V and/or turning on selected ones of the blinkers 803.

Following the operation in step S16, the processor 21 executes the operation in step S20 of the first limp-home control routine or the operation in step S101 of the second limp-home control routine.

Accordingly, the sixth application makes it possible to more smoothly perform the limp-home control of the own vehicle V.

### Seventh Specific Application

The following describes a seventh specific application of the first embodiment.

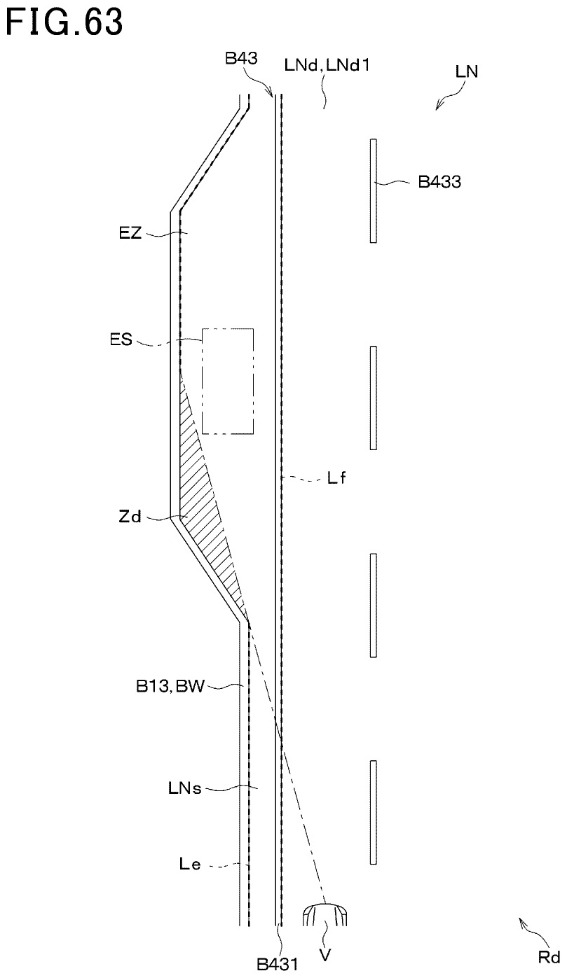

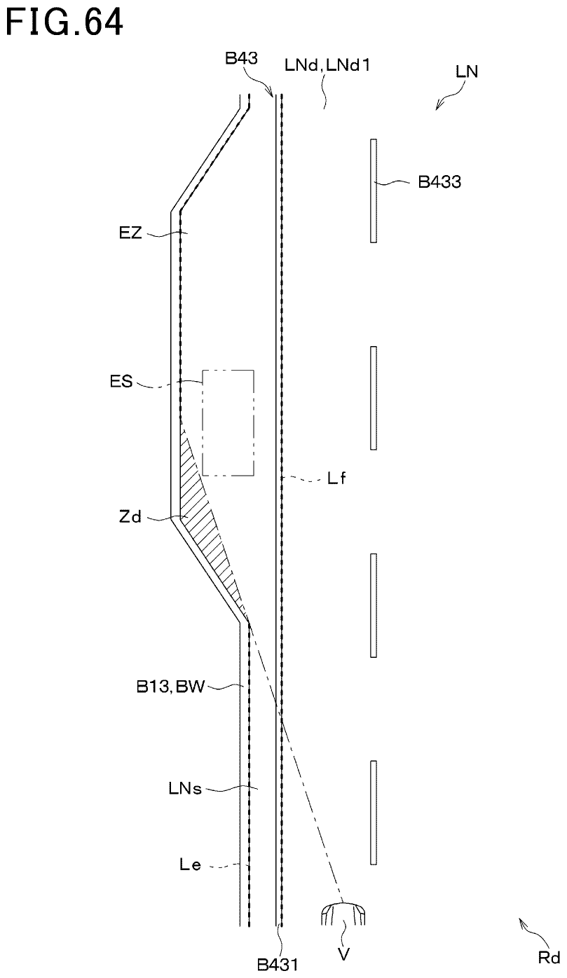

FIGS. 63 and 64 schematically illustrate that the size of a blind spot Zd from the own vehicle V changes depending on the traveling position of the own vehicle V in the road width direction.

FIGS. 63 and 64 illustrate an example situation where the own vehicle V is traveling in the traveling lane LNd of a road Rd, i.e., a left-hand road Rd with two or more lanes each way, and the road Rd has a road shoulder LNs that includes an emergency parking zone EZ. In the example situation, as illustrated in FIGS. 63 and 64, when the traveling position of the own vehicle V in the road width direction is offset rightward, i.e., offset in a direction away from the load shoulder LNs, the size of the blind spot Zd becomes smaller.

From this viewpoint, in step S16 illustrated in FIG. 62B, the processor 21 performs, as one of the preparation operations, offsetting the current location of the own vehicle V rightward, i.e., offsetting the current location of the own vehicle V in a direction away from the load shoulder LNs.

The seventh specific application therefore makes it possible to more easily detect an evacuation space ES in the emergency parking zone EZ. In particular, the seventh specific application makes it possible to detect an evacuation space ES in the emergency parking zone EZ from a position of the own vehicle V in the road extending direction farther away than a normal position of the own vehicle V in the road extending direction at which the evacuation space ES is detectable with no offsetting. In other words, the seventh specific application makes it possible to detect an evacuation space ES in the emergency parking zone EZ from a wider range of the road Rd in the road extending direction as compared with a normal range of the road Rd in the road extending direction in which the evacuation space ES is detectable with no offsetting.

### Eighth Specific Application

The following describes an eighth specific application of the first embodiment.

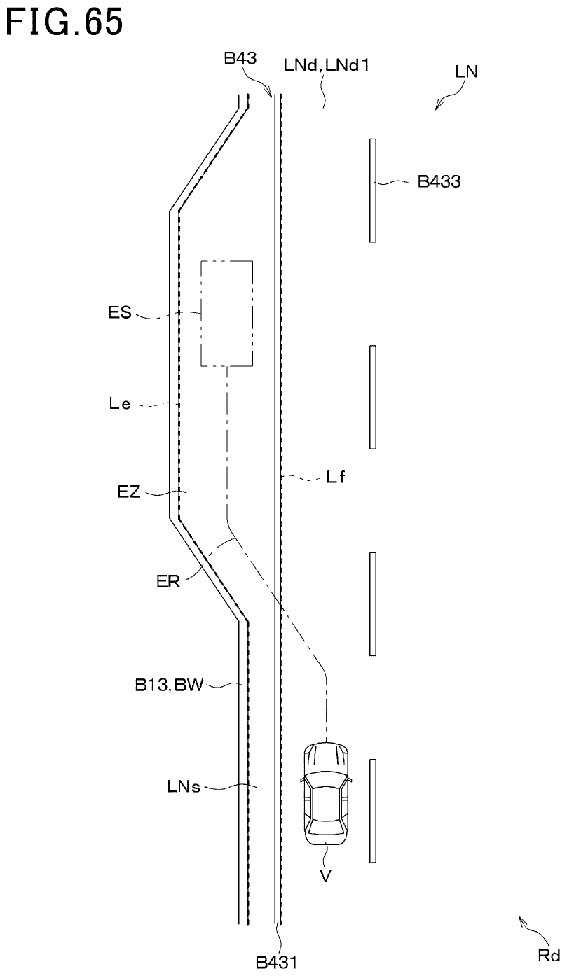

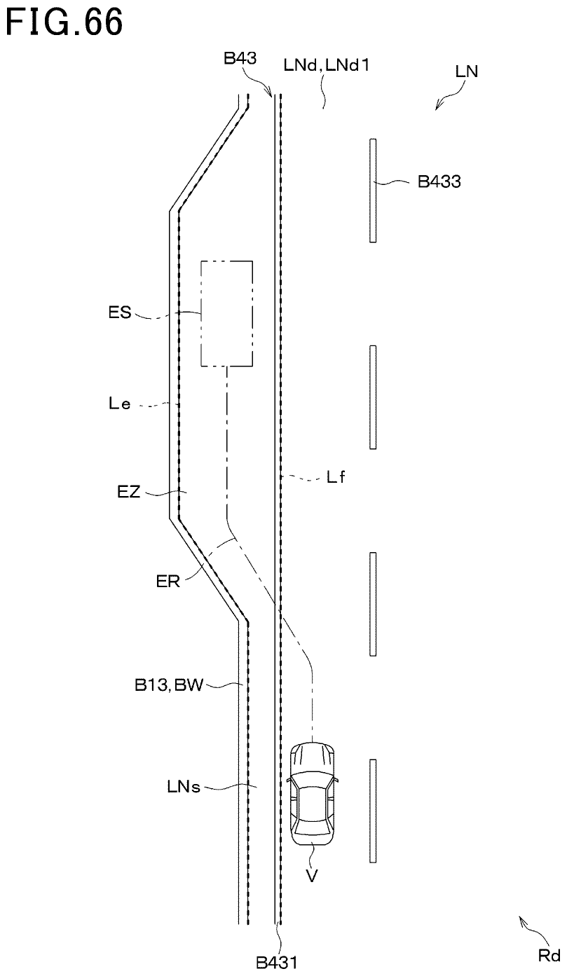

FIGS. 65 and 66 schematically illustrate that an evacuation route ER, which has, for example, two curved sections, changes depending on the traveling position of the own vehicle V in the road width direction.

FIGS. 65 and 66 illustrate an example situation where the own vehicle V is traveling in the traveling lane LNd of a road Rd, i.e., a left-hand road Rd with two or more lanes each way, and the road Rd has a road shoulder LNs that includes an emergency parking zone EZ. In the example situation, as illustrated in FIGS. 65 and 66, when the traveling position of the own vehicle V in the road width direction is offset leftward, i.e., offset in a direction close to the load shoulder LNs, an angle of each curved section of the evacuation route ER becomes gentler. The limp-home traveling control task according to the eight specific application therefore enables the own vehicle V to more smoothly follow each curved section of the evacuation route ER, making it possible to improve the efficiency of the limp-home traveling control task.

From this viewpoint, in each of step S30 of the first limp-home control routine and step S107 of the second limp-home control routine, the processor 21 of the eighth embodiment serves as, for example, the control information determiner 2404 to offset the own vehicle V leftward, i.e., offsetting the current location of the own vehicle V in a direction close to the load shoulder LNs. The processor 21 can be programmed to perform the offsetting of the current location of the own vehicle V after detection of an evacuation space ES. That is, before definitely determination of an evacuation space ES before step S30 of the first limp-home control routine or step S107 of the second limp-home control routine, the processor 21 causes the own vehicle V to travel in the traveling lane LNd while the own vehicle V is offset rightward to be adjacent to the lane lines B433 (see for example FIG. 64). Then, in step S30 of the first limp-home control routine or step S107 of the second limp-home control routine, the processor 21 causes the own vehicle V to travel in the traveling lane LNd while the own vehicle V is offset leftward to be closer to the road shoulder LNs.

Accordingly, the eighth application makes it possible to more smoothly perform the limp-home control of the own vehicle V.

Alternatively, in step S16 illustrated in FIG. 62B, the processor 21 can be programmed to perform, as one of the preparation operations, offsetting the current location of the own vehicle V leftward, i.e., offsetting the current location of the own vehicle V in a direction close to the load shoulder LNs.

### Ninth Specific Application

The following describes a ninth specific application of the first embodiment.

When each of the first to ninth specific applications determines that the detection result of the detected evacuation space ES or ESf represents that the evacuation space ES or ESf is unsuitable for parking of the own vehicle V, and determines not to perform the limp-home traveling task for parking the own vehicle V in the detected evacuation space ES or ESf, there may be a case where it is hard for the processor 21 to detect another evacuation space ES different from the detected evacuation space ES. In this case, the processor 21 does not so much search another evacuation space ES while the own vehicle V is continuously traveling for a long time or emergently stop the own vehicle V in the traveling lane LNd under constraint but stop the own vehicle V in the road shoulder LNs as soon as possible.

From this viewpoint, the control information determiner 2404 is programmed to determine, after it is determined by the detection result determiner 2405 that parking of the own vehicle V is likely to be difficult, whether it is difficult to detect another evacuation space ES. Then, the control information determiner 2404 is programmed to determine the continuation or restart of the limp-home traveling control for causing the own vehicle V to travel to the detected evacuation space ES upon determination that it is difficult to detect another evacuation space ES. This configuration therefore makes it possible to reduce adverse influence of execution of the limp-home control on following vehicles as much as possible.

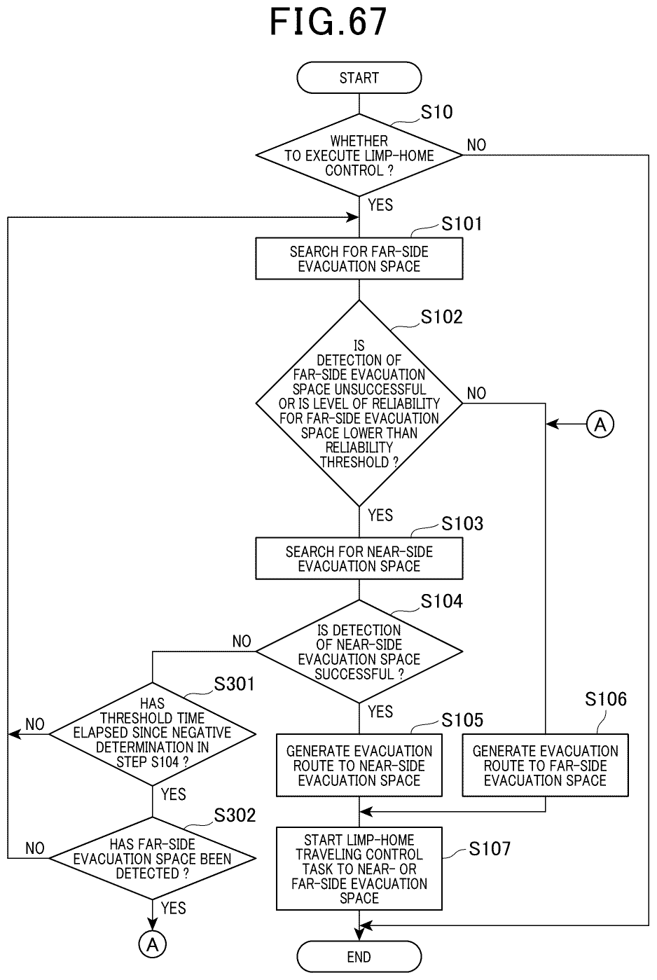

FIG. 67 is a flowchart schematically illustrating a modified second limp-home control routine. Specifically, operations of the second limp-home control routine illustrated in FIG. 48 after negative determination in step S104 are changed to create the modified second limp-home control routine illustrated in FIG. 67.

Specifically, because the operations in steps S101 to S107 of FIG. 67 are respectively identical to those in steps S101 to S107 of FIG. 48, and therefore additional descriptions of the operations in steps S101 to S107 of FIG. 67 are omitted.

Upon determination that detection of a near-side evacuation space ESn is unsuccessful (NO in step S104), the modified second limp-home control routine proceeds to step S301 of FIG. 67.

In step S301, the processor 21 determines whether a predetermined threshold time has elapsed since the negative determination in step S104. Upon determination that the predetermined threshold time has not elapsed since the negative determination (NO in step S104), the processor 21 returns to step S101 and performs the operation in step S101 and the subsequent operations.

Otherwise, upon determination that the predetermined threshold time has elapsed since the negative determination (YES in step S104), the modified second limp-home control routine proceeds to step S302.

In step S302, the processor 21 determines whether a far-side evacuation space ESf has been detected in step S101. That is, the processor 21 determines whether affirmative determination in step S102 is based on the determination that the level of reliability for the detected far-side evacuation space ESf is lower than the predetermined reliability threshold instead of the determination that detection of a far-side evacuation space ESf is unsuccessful.

Upon determination that a far-side evacuation space ESf has not been detected in step S101 (NO in step S302), the processor 21 returns to step S101 and performs the operation in step S101 and the subsequent operations.

Otherwise, upon determination that a far-side evacuation space ESf has been detected in step S101 (YES in step S302), the processor 21 performs the operations in steps S106 and S107, thus performing the limp-home traveling task for parking the own vehicle V in the far-side evacuation space ESf.

The ninth specific application of the first embodiment therefore makes it possible to reduce adverse influence of execution of the limp-home control on subsequent vehicles as much as possible.

### Second Embodiment

The following describes the second embodiment.

The second embodiment is related to a collision determination task carried out by the driving ECU 2, which determines whether there is a risk that the own vehicle V traveling in a predetermined traveling route will collide with one or more objects other than the own vehicle V. In particular, the collision determination task can be preferably applied to the own vehicle V traveling along the evacuation route ER to the evacuation space ES based on the limp-home traveling control task.

Specifically, let us assume that the collision determination task based on the evacuation route ER is carried out when the driver D is difficult to drive due to the driver's bad health and/or a decreased level of driver's consciousness. In this assumption, even if there is an object, which is different from the own vehicle V, located in the traveling course of the own vehicle V, the driver D is not expected to avoid any braking and/or steering operation of the own vehicle V from colliding with the object. For this reason, in this assumption, it is necessary to (i) determine a collision risk that the own vehicle V will collide with one or more other objects with high accuracy, (ii) autonomously perform, in response to the determined collision risk, motion control of the own vehicle V for avoiding a collision of the own vehicle V with the one or more other vehicles, and/or (iii) correct the evacuation route ER and/or the evacuation space ES for avoiding a collision of the own vehicle V with the one or more other vehicles.

From this viewpoint, Japanese Patent Publication No. 2799375 discloses the following technology related to the determination of the collision risk.

First, the technology calculates, every 100 msec, predicted point coordinates in a two-dimensional, i.e., an X-Y, coordinate system defined on a road with respect to an own vehicle; the road has a traveling lane of the own vehicle. The two-dimensional coordinate system is for example defined on the road as a two-dimensional coordinate system having, an X-axis corresponding to the longitudinal direction of the own vehicle, a Y-axis corresponding to the vehicle width direction, and an origin corresponding to, for example, the middle of the front portion of the body of the own vehicle.

Let us assume that the technology calculates predicted point coordinates (X0, Y0), (X1, Y1), (X2, Y2), . . . and (Xn, Yn) at times T (T0, T1, T2, . . . , Tn). The technology calculates, for the respective predicted point coordinates (X0, Y0), (X1, Y1), (X2, Y2), . . . and (Xn, Yn), corresponding left-side point coordinates (x0, y0), (x1, y1), (x2, y2), . . . , (xn,yn), separated away from the corresponding predicted point coordinates (X0, Y0), (X1, Y1), (X2, Y2), . . . and (Xn, Yn) by a predetermined distance. Additionally, the technology calculates, for the respective predicted point coordinates, corresponding right-side point coordinates (x′0, y′0), (x′1,y′1), (x′2, y′2), . . . and (x′n, y′n), separated away from the corresponding predicted point coordinates (X0, Y0), (X1, Y1), (X2, Y2), . . . and (Xn, Yn) by the predetermined distance.

Then, the technology connects the left-side point coordinates (x0, y0), (x1, y1), (x2, y2), . . . , (xn,yn) to one another, and connects the right-side point coordinates (x′0, y′0), (x′1,y′1), (x′2, y′2), . . . and (x′n, y′n) to one another, thus generating a left-side boundary of a predicted traveling region of the own vehicle and a right-side boundary of the predicted traveling region of the own vehicle; the predicted traveling region has a predetermined width between the left-side and right-side boundaries.

Next, the technology determines a collision risk that the own vehicle will collide with one or more other vehicles based on the predicted traveling region of the own vehicle.

However, the technology may result in the number of the predicted point coordinates (X0, Y0), (X1, Y1), (X2, Y2), (Xn, Yn), (x0, y0), (x1, y1), (x2, y2), . . . , (xn,yn), (x′0, y′0), (x′1,y′1), (x′2, y′2), . . . and (x′n, y′n) increasing, resulting in the processor's processing load increasing. In particular, if the technology is applied to the limp-home control according to the present disclosure, it may be difficult to satisfy both improvement of the accuracy of determining the collision risk that the own vehicle will collide with one or more other vehicles and reduction in the processing load of the processor 21.

From the above circumstances, the second embodiment discloses a collision determination method that enables both improvement of the accuracy of determining collision of the own vehicle with an obstacle and reduction in the processing load of the processor 21.

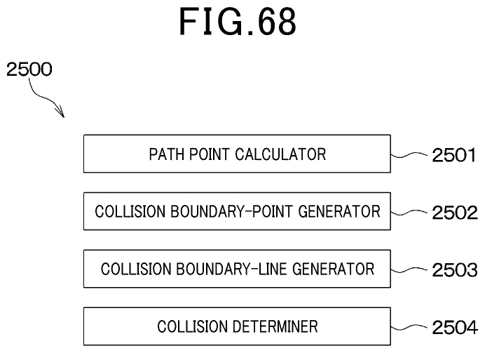

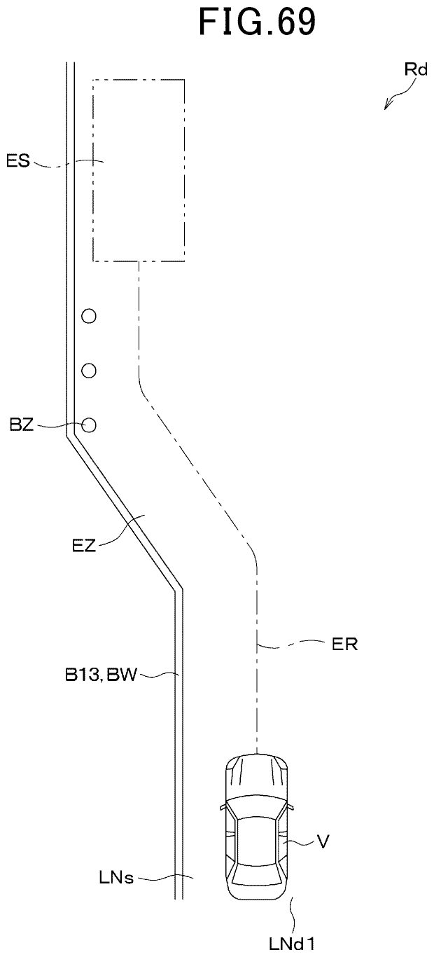

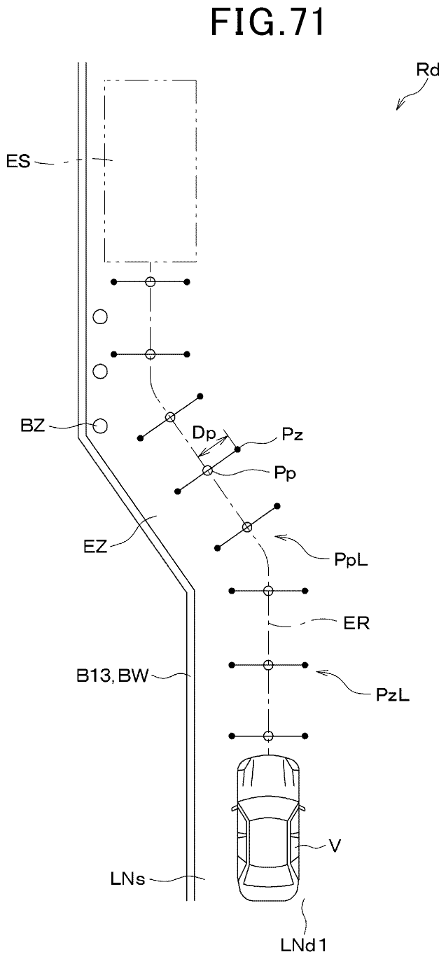

FIG. 68 schematically illustrates a functional configuration related to the collision determination method and implemented by the driving ECU 2 illustrated in FIG. 16. FIGS. 69 to 72 schematically illustrate how the collision determination method according to the second embodiment is carried out by the driving ECU 2.

The following describes the collision determination method according to the second embodiment with reference to FIGS. 68 to 72 and, if necessity arises, at least one of the other figures.

The driving ECU 2 according to the present embodiment functionally includes, as illustrated in FIG. 68, a collision determination unit 2500 that includes, as functionally implemented by the driving ECU 2, a path point calculator 2501, a collision boundary-point generator 2502, a collision boundary-line generator 2503, and a collision determiner 2504.

These functional modules 2501 to 2504 constituting the collision determination unit 2500 can be implemented as, for example, a function included in the operation determiner 2002 illustrated in FIG. 16.

Specifically, the operation determiner 2002 illustrated in FIG. 16 determines the control information based on a collision determination result obtained by the collision determination unit 2500 thereof, and the operation determiner 2002 and/or the control signal output module 2003 illustrated in FIG. 16 generate control signals based on the control information determined by the operation determiner 2002. Then, the control signal output module 2003 outputs the control signals to the motion control system 9. This results in the motion control system 9 performing the limp-home traveling control task based on the outputted control signals while avoiding a collision with obstacles.

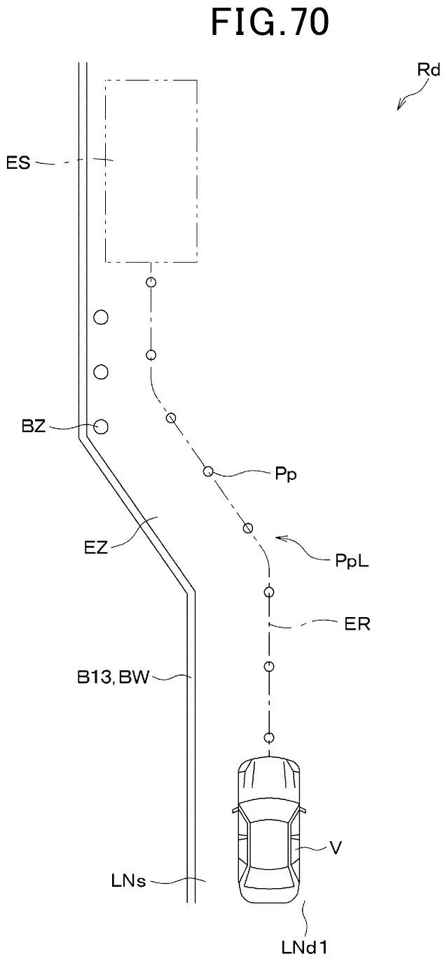

The path point calculator 2501 is operative to calculate, based on the evacuation route ER illustrated in FIG. 69, which is a traveling route from the current location of the own vehicle V to the evacuation space ES, a path-point sequence PPL illustrated in FIG. 70. That is, the evacuation route generator 2403 generates the evacuation route ER based on a predetermined evacuation route model that is a predetermined curve model stored in, for example, the memory device 22. The evacuation route model includes a function that is a variable expression representing a curve on a two-dimensional, i.e., an X-Y, coordinate system defined on the road Rd with respect to the own vehicle V. The two-dimensional coordinate system is for example defined on the road as a two-dimensional coordinate system having an X-axis corresponding to the vehicle width direction, a Y-axis corresponding to the longitudinal direction of the own vehicle V, and an origin corresponding to, for example, the middle of the front portion of the body of the own vehicle V.

The variable equation is made up of two variables in the respective X and Y axes. The evacuation route model includes model parameters that are coefficients assigned to terms of the variable expression.

The path-point sequence PpL is comprised of a plurality of path points Pp on the two-dimensional coordinate system, i.e., X-Y coordinates of each of the path points Pp on the two-dimensional coordinate system. The path points Pp have, for example, regular intervals located along the evacuation route ER. That is, because the path point calculator 2501 calculates the path points Pp based on the evacuation route ER, i.e., the evacuation route model, the path points Pp is arranged on the evacuation route ER having little position error.

The collision boundary-point generator 2502 is operative to generate, for each path point Pp, a pair of left- and right-side collision boundary points Pz. The left-side collision boundary point Pz generated for each path point Pp is located at a position on the road Rd, which is separated leftward away from the corresponding path point Pp by a predetermined distance Dp in a direction perpendicular to the extending direction of the corresponding portion of the evacuation route ER. Similarly, the right-side collision boundary point Pz generated for each path point Pp is located at a position on the road Rd, which is separated rightward away from the corresponding path point Pp by the predetermined distance Dp in a direction perpendicular to the extending direction of the corresponding portion of the evacuation route ER. The predetermined distance Dp for each left-side collision boundary point Pz can be set to be identical or different from the predetermined distance Dp for each right-side collision boundary point Pz.

That is, the method of generating the left- and right-side collision boundary points Pz for each path point Pp is substantially identical to the method of generating the left- and right side point coordinates (x′0, y′0), (x′1,y′1), (x′2, y′2), . . . , (x′n, y′n) and (x0, y0), (x1,y1), (x2, y2), . . . , (xn, yn) disclosed in the Patent Publication No. 2799375 except that the X and Y axes of the two-dimensional coordinate system according to the second embodiment are inversed from the X are inversed from those according to the Patent Publication No. 2799375. The distances Dp for the respective path points Pp can be set to a constant distance or can be set to be variable depending on the traveling conditions of the own vehicle V, such as the speed of the own vehicle V.

Specifically, the collision boundary-point generator 2502 according to the present embodiment is operative to determine the distance Dp for each path point Pp based on, for example, at least one of (i) the width, which will be referred to as the width Wv, of the own vehicle V, (ii) the inner wheel difference of the own vehicle V, (iii) the outer wheel difference of the own vehicle V, (iv) a recognition error of the recognition unit 2401 illustrated in FIG. 30, and (v) a motion-control error of the own vehicle V.

Specifically, the collision boundary-point generator 2502 can be operative to determine the distance Dp for each path point Pp in accordance with the following equation (eq1B):

Dp=Wh+ΔDp1+ΔDp2+ΔDp3 (eq1B)

where:

Wh represents half of the width, which is expressed by Wv/2;

ΔDp1 represents a correction value based on the inner wheel difference and/or the outer wheel difference of the own vehicle V;

ΔDp2 represents a correction value based on the recognition error of the recognition unit 2401 illustrated in FIG. 30; and

ΔDp3 represents a correction value based on the motion-control error of the own vehicle V.

For example, the greater one of the inner wheel difference and the outer wheel difference of the own vehicle V than the other thereof can be used as the correction value ΔDp1.

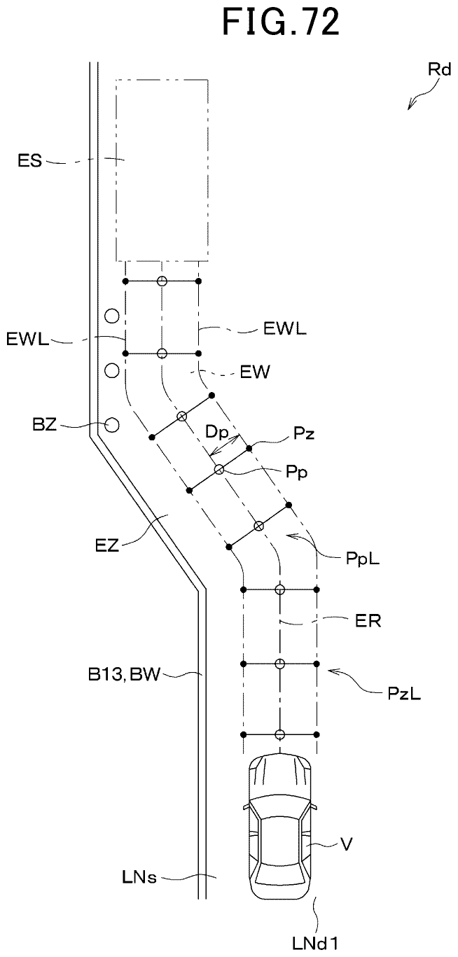

The collision boundary-line generator 2503 is operative to, as illustrated in FIG. 72, perform curve fitting into the sequence of the left-side collision boundary points Pz to accordingly generate a left-side collision boundary line EWL, and performs curve fitting into the sequence of the right-side collision boundary points Pz to accordingly generate a right-side collision boundary line EWL. In FIG. 72, reference character PzL shows each of the sequence of the left-side collision boundary points Pz and the sequence of the right-side collision boundary points Pz. The curve fitting is to approximately fit data in each interval of the sequence PzL of the left-side collision boundary points Pz using the curve model similar to the curve model of the evacuation route model to accordingly generate the left-side collision boundary line EWL. Similarly, the curve fitting is to approximately fit data in each interval of the sequence PzL of the right-side collision boundary points Pz using the curve model similar to the curve model of the evacuation route model to accordingly generate the right-side collision boundary line EWL.

The collision determiner 2504 is operative to determine a collision risk of the own vehicle V with one or more obstacles BZ in accordance with a scheduled traveling region EW of the own vehicle V; the scheduled traveling region EW is defined between the generated left- and right-side collision boundary lines EWL.

As described above, the second embodiment makes it possible to more easily calculate the path points Pp, the left-side collision boundary points Pz, and the right-side collision boundary points Pz using the already calculated evacuation route ER while maintaining the high accuracy of determining the collision risk of the own vehicle V with one or more obstacles BZ.

In particular, in such a case where the limp-home traveling control task is carried out for the own vehicle V, an approach angle of the own vehicle V moving from the farthest end traveling lane LNd1 into the emergency parking zone EZ or the road shoulder LNs may become large. For this reason, it is necessary to ascertain the behavior of the own vehicle V accurately. Additionally, if the ow vehicle V is located within a relatively short distance from the road sidewall BW, the processor 21 needs to consider the recognition error of the recognition unit 2401 and the motion-control error of the own vehicle V when calculating the scheduled traveling region EW of the own vehicle V.

From this viewpoint, the processor 21 according the second embodiment is configured to calculate the scheduled traveling region EW of the own vehicle V in consideration of the behavior of the own vehicle V and the recognition and the motion-control errors, thus improving the accuracy of determining the collision risk of the own vehicle V with one or more obstacles BZ during the evacuation traveling control of the own vehicle V. For example, the values of the respective parameters ΔDp1, ΔDp2, and ΔDp3 can be calculated by, for example, optimization experiment and/or computer simulation.

### First Specific Application

The following describes a first specific application of the second embodiment.

The driving ECU 2 according to the first specific application serves as, for example, the collision determiner 2504 to determine whether one or more obstacles BZ are located within the scheduled traveling region to accordingly determine the collision risk of the own vehicle V.

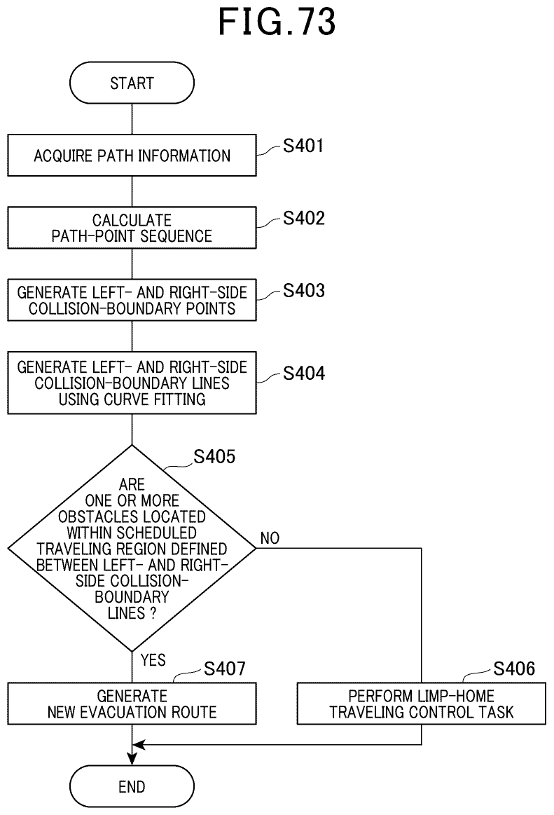

The processor 21 according to the first specific application of the second embodiment is programmed to cyclically read a collision risk determination program, i.e., collision risk determination program instructions, stored in the memory device 22 in response to, for example, generation of an evacuation route ER by the evacuation route generator 2403 to sequentially execute operations of a collision risk determination routine according to the first specific application illustrated as a flowchart in FIG. 73 corresponding to the collision risk determination program instructions.

When starting the collision risk determination routine, the processor 21 serves as, for example, the path point calculator 2501 to retrieve, from the memory device 22, the evacuation route model, i.e., the curve model of the evacuation route ER as path information, i.e., input information in step S401 of the collision risk determination routine. Then, the processor 21 serves as, for example, the path point calculator 2501 to calculate, based on the path information, a path-point sequence PpL in step S402. For example, in step S402, the path point calculator 2501 calculates, based on the curve model, a path point Pp on the evacuation model ER every predetermined period from the current time or every predetermined distance from the current location to accordingly calculate the path points Pp, i.e., the path-point sequence PpL.

Next, the processor 21 serves as, for example, the collision boundary-point generator 2502 to generate, for each path point Pp, a pair of left- and right-side collision boundary points Pz described set forth above in step S403.

Following the operation in step S403, the processor 21 serves as, for example, the collision boundary-line generator 2503 to perform curve fitting into the sequence of the left-side collision boundary points Pz to accordingly generate a left-side collision boundary line EWL, and performs curve fitting into the sequence of the right-side collision boundary points Pz to accordingly generate a right-side collision boundary line EWL in step S404.

Following the operation in step S404, the processor 21 serves as, for example, the collision determiner 2504 to define a scheduled traveling region EW of the own vehicle V between the generated left- and right-side collision boundary lines EWL in step S405. Then, the processor 21 serves as, for example, the collision determiner 2504 to determine whether one or more obstacles BZ are located in the scheduled traveling region EW in step S405.

Upon determination that no obstacles BZ are located in the scheduled traveling region EW (NO in step S405), the processor 21 determines that there is no collision risk of the own vehicle V with obstacles BZ during traveling of the own vehicle V along the evacuation route ER. Then, like the operation of the control information determiner 2404, the processor 21 determines control information to accordingly perform, based on the determined control information, the limp-home traveling control task of causing the own vehicle V to travel from the current location to the evacuation space ES along the evacuation route ER while decelerating the own vehicle V in step S406.

Otherwise, upon determination that one or more obstacles BZ are located in the scheduled traveling region EW (YES in step S405), the processor 21 determines that there is a collision risk of the own vehicle V with the one or more obstacles BZ. Then, like the operation of the evacuation route generator 2403, the processor 21 generates a new evacuation route ER again; the new evacuation route ER is located to avoid the one or more obstacles BZ in step S407. Subsequently, like the operation of the control information determiner 2404, the processor 21 determines control information to accordingly start, based on the determined control information, the limp-home traveling control task of causing the own vehicle V to travel from the current location to the evacuation space ES along the evacuation route ER while decelerating the own vehicle V in step S407. In step S407, the processor 21 can detect a new evacuation space ES and generate a new evacuation route ER from the current location of the own vehicle V to the new evacuation space ES.

Accordingly, the first specific application of the second embodiment makes it possible to more easily calculate the path-point sequence PpL and the scheduled traveling region EW using the already calculated evacuation route ER while improving the accuracy of determining the collision risk of the own vehicle V with one or more obstacles BZ.

### Modification of First Specific Application

In step S405, the processor 21 can determine whether there is a collision risk of the own vehicle V with the one or more obstacles BZ based on a lateral position of each of the one or more obstacles BZ in the road width direction and a lateral position of one of the left- and right-side collision boundary lines EWL that is closer to the one or more obstacles BZ than the other there of is. That is, the processor 21 can determine whether there is a collision risk of the own vehicle V with the one or more obstacles BZ in accordance with a relationship between the coordinates of each of the one or more obstacles and the coordinates of the closer collision boundary line EWL on the two-dimensional coordinate system.

The modification of the first specific application according to the second embodiment eliminates the need of calculating the scheduled traveling region EW, making it possible to further reduce the processing load of the processor 21.

### Second Specific Application

The following describes a second specific application of the second embodiment.

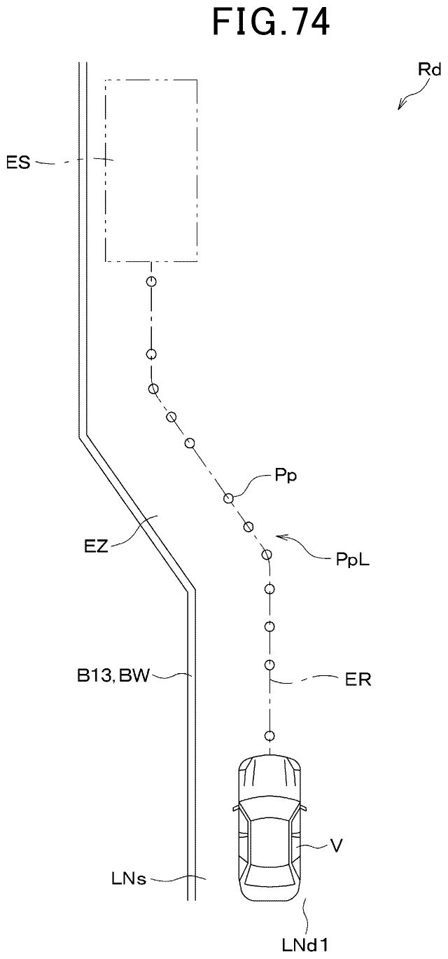

As illustrated in FIG. 74, the evacuation route ER may include at least one substantially linear section and at least one curved section. In this case, it is possible to reduce the number of path points Pp of the path-point sequence PpL included in the at least one substantially linear section. This makes it possible to further reduce the processing load of the processor 21. Similarly, as the curve model of the evacuation route model, a quadratic curve model, a cubic curve model, or m-dimensional curve model can be used (m is an integer more than 4). Using the quadratic curve model as the curve model enables the number of path points Pp to reduce as compared with using the cubic curve model as the curve model. That is, the lower the number of m of the m-dimensional curve model, the number of path points Pp constituting the path-point sequence PpL. In contrast, if the order of the m-dimensional curve model is a large value, an increase in the number of path points Pp constituting the path-point sequence PpL improves the accuracy of determining the collision risk of the own vehicle V with the one or more obstacles BZ.

Ad described above, in step S402, the processor 21 serves as, for example, the path point calculator 2501 to change the number of path points Pp constituting the path-point sequence PpL in accordance with the order of the curve model, making it possible to further reduce the processing load of the processor 21 while improving the accuracy of determining the collision risk of the own vehicle V with one or more obstacles BZ.

The processor 21 of the second specific application according to the second embodiment can be operative to calculate a distance of any path point Pp in accordance with the following equation (eq2):

$$TRn = TRs + \frac{TRe - TRs}{N - 1} \cdot n \qquad ( eq2 )$$

where:

N represents the number of path points Pp;

n is any one of integers 1 to N, which represents an ordinal number of the path points Pp;

TRn represents the distance of n-th path point Pp;

TRs represents a start distance; and

TRe represents an end distance.

The start distance represents a traveled distance of the own vehicle V to a start point of the evacuation route ER, and the end distance represents the product of (i) a traveled distance of the own vehicle V to an end point of the evacuation route ER and (ii) a correction value determined based on the longitudinal total length of the own vehicle V and/or a safety margin.

### Third Specific Application

The following describes a third specific application of the second embodiment.

The driving ECU 2 according to the third specific application of the second embodiment is configured to approximate a trigonometric function representing a multiple dimensional curve model as the evacuation route model by Taylor expansion based on parameters of the multiple dimensional curve model, making it possible to achieve both the improvement of calculation of, for example, the collision boundary points Pz and the reduction in the processing load of the processor 21. Specifically, in step S404, the processor 21 serves as, for example, the collision boundary-line generator 2503 to approximate a trigonometric function representing a multiple dimensional curve model using Taylor expansion based on parameters of the multiple dimensional curve model to accordingly calculate left- and right side collision boundary lines EWL. Note that approximating a trigonometric function using Tayler expansion specifically means approximating a sine function and/or a cosine function by tangent function using Tayer expansion

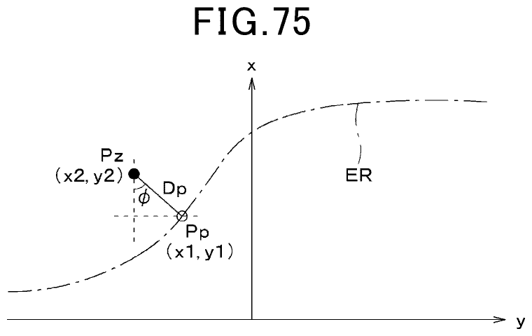

Specifically, as illustrated in FIG. 75, the evacuation route ER can be represented as a curved line corresponding to a function on the X-Y coordinate system. The coordinates of any path point Pp will be referred to as (x1, y1), and the coordinates of a left-side collision boundary point Pz corresponding to the coordinates (x1, y1) of the path point Pp will be referred to as (x2, y2). For the sake of simple descriptions, the evacuation route model is defined as a cubic function expressed by the following equation (eq3):

$$y 1 = K 3 \cdot x {1}^{3} + K 2 \cdot x {1}^{2} + K 1 \cdot x 1 + K 0 \qquad ( eq3 )$$

where coefficients K0 to K3 are the model parameters, each of which is a corresponding constant value.

The coordinates (x2, y2) of the left-side collision boundary point Pz corresponding to the coordinates (x1, y1) of the path point Pp is expressed by the following equation (eq4):

$$( x 2 , y 2 ) = ( x 1 + Dp \cdot cos Φ , y 1 - Dp \cdot sin Φ ) \qquad ( eq4 )$$

where Φ represents an angle formed by (i) a line connecting between the path point Pp and the left-side collision boundary point Pz and (ii) a vertical line passing through the left-side collision boundary point Pz and being parallel to the X axis of the X-Y coordinate system.

Then, the processor 21 serves as, for example, the collision boundary-line generator 2503 to approximate cos Φ and sin Φ in the equation (eq4) using the following equation (5) of tan Φ and equation (6):

$$cos Φ = \{ \begin{matrix}Q 1 - Q 2 * tan {Φ}^{2} [ 0 \leq \vert tan Φ \vert \leq 1.8708 ] \\ \pm ( 1 / tan Φ - 0.5 / tan {Φ}^{3} ) \{ \begin{matrix}+ 1.8708 \leq tan Φ < ∞ \\ - 1.8708 \geq tan Φ > - ∞\end{matrix}\end{matrix} \qquad [ eq5 ]$$

$$sin Φ = tan Φ * cos Φ \qquad [ eq6 ]$$

where:

Q1 is set to 1.0 and Q2 is set to 0.5 when 0≤|tan Φ|≤0.412;

Q1 is set to 0.9640 and Q2 is set to 0.2973 when 0.412≤|tan Φ|≤0.8206;
Q1 is set to 0.8839 and Q2 is set to 0.1768 when 0.8206≤|tan Φ|≤1.2186; and
Q1 is set to 0.7325 and Q2 is set to 0.07926 when 1.2186≤|tan Φ|≤1.8708.

This therefore makes it possible to calculate the coordinates (x2, y2) of the left-side collision boundary point Pz in accordance with the above equation (4) whose cos @ and sin @ have been approximated by tan ¢.

### Fourth Specific Application

The following describes a fourth specific application of the second embodiment.

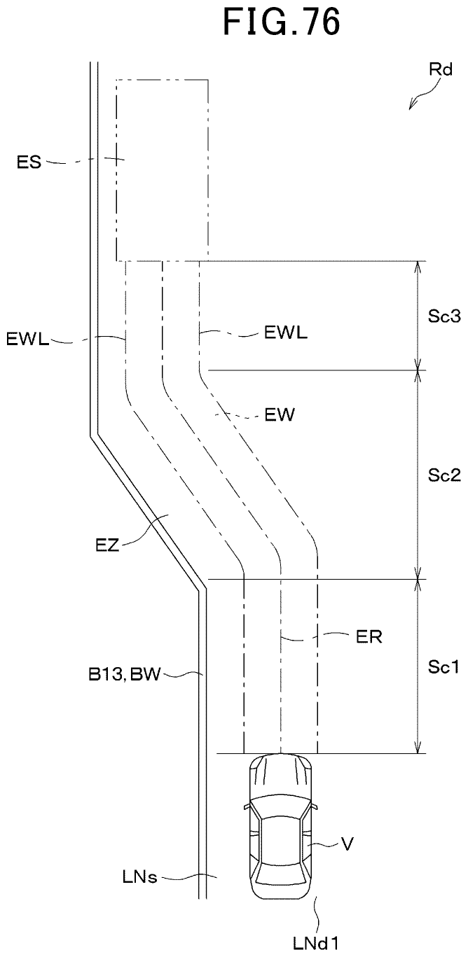

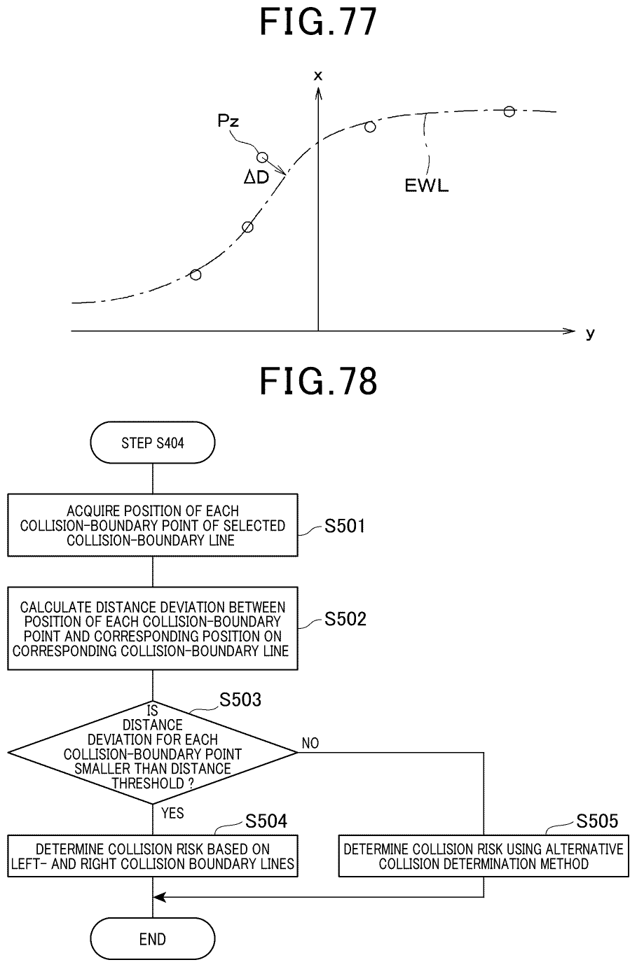

FIG. 76 illustrates an example where the processor 21 generates plural evacuation-route sections based on respective curve modes of the evacuation route model to accordingly generate the evacuation route ER that is comprised of the plural evacuation-route sections.

In this example, a plurality of curve fitting models, which are different from one another, are prepared for the plural evacuation-route sections. Then, in step S404, the processor 21 serves as, for example, the collision boundary-line generator 2503 to perform fitting of a selected one of the curve fitting models into each of (i) the sequence of the left-side collision boundary points Pz of a selected one of the plural evacuation-route sections to accordingly generate a corresponding section of the left-side collision boundary line EWL and (ii) the sequence of the right-side collision boundary points Pz of the selected one of the plural evacuation-route sections to accordingly generate a corresponding section of the right-side collision boundary line EWL.

For example, let us assume that the evacuation route ER is comprised of three sections, which is a first section Sc1 located nearest to the own vehicle V, a second section Sc2 located at a middle of the evacuation route ER, and a third section Sc3 located farthest from the own vehicle V; the second section Sc2 is located between the first and third sections Sc1 and Sc3. The processor 21 generates the first section Sc1 of the evacuation route ER using a linear model as the curve model, the second section Sc2 of the evacuation route ER based on a cubic curve model as the curve model, and the third section Sc3 of the evacuation route ER using the linear model as the curve model.

In the fourth specific application, a linear fitting mode and a cubic fitting model are prepared for the first to third sections Sc1 to Sc3.

Then, the collision boundary-line generator 2503 is operative to
(I) Perform fitting of the linear fitting model into the sequence of the left-side collision boundary points Pz of the first section Sc1 to accordingly generate a corresponding first section of the left-side collision boundary line EWL
(II) Perform fitting of the cubic fitting model into the sequence of the left-side collision boundary points Pz of the second section Sc2 to accordingly generate a corresponding second section of the left-side collision boundary line EWL
(III) Perform fitting of the linear fitting model into the sequence of the left-side collision boundary points Pz of the third section Sc3 to accordingly generate a corresponding third section of the left-side collision boundary line EWL
(IV) Perform fitting of the linear fitting model into the sequence of the right-side collision boundary points Pz of the first section Sc1 to accordingly generate a corresponding first section of the right-side collision boundary line EWL
(V) Perform fitting of the cubic fitting model into the sequence of the right-side collision boundary points Pz of the second section Sc2 to accordingly generate a corresponding second section of the right-side collision boundary line EWL
(VI) Perform fitting of the linear fitting model into the sequence of the right-side collision boundary points Pz of the third section Sc3 to accordingly generate a corresponding third section of the right-side collision boundary line EWL

The fourth specific application of the second embodiment therefore makes it possible to improve both the position accuracy of each collision-boundary point Pz and the curve fitting accuracy.

### Fifth Specific Application

The following describes a fifth specific application of the second embodiment.

Large curve-fitting error in generation of a collision boundary line EWL may result in reduction in the accuracy of determining, based on the collision boundary line EWL and/or the scheduled traveling region EW, the collision risk of the own vehicle V with one or more obstacles BZ. The curve-fitting error may include average error and individual errors.

The average error for a collision boundary line EWL is an average of error between the positions of the respective collision boundary points Pz and the corresponding positions on the corresponding collision boundary line calculated by the curve fitting.

The individual error for each collision boundary point Pz of a collision boundary line EWL is an error between the position of the corresponding collision boundary point Pz and the corresponding position on the collision boundary line EWL calculated by the curve fitting. In particular, the individual error for the farthest collision boundary point Pz of the collision boundary line EWL, which is located farthest from the collision boundary line EWL, may typically become a problem.

From this viewpoint, the collision determiner 2504 according to the fifth specific application can be operative to determine whether the average error for each collision boundary line EWL is greater than a predetermined average-error threshold or determine whether the individual error for each collision boundary point Pz of each collision boundary line EWL is greater than a predetermined individual-error threshold. Then, the collision determiner 2504 according to the fifth specific application of the second embodiment can be operative to determine that there is large fitting error in generation of at least one collision boundary line EWL upon determination that the average error for the at least one collision boundary line EWL is greater than the predetermined average-error threshold or upon determination that the individual error for at least one collision boundary point Pz of the at least one collision boundary line EWL is greater than the predetermined individual-error threshold.

Specifically, for addressing the individual error, the collision determiner 2504 can be operative to calculate a distance deviation AD between the position of each collision boundary point Pz and the corresponding position on the selected collision boundary line EWL. Then, the collision determiner 2504 can be operative to determine whether the distance deviation AD for each collision boundary point Pz and the corresponding position on the selected collision boundary line EWL is greater than or equal to a predetermined distance threshold.

Upon determination that the distance deviation AD for at least one collision boundary point Pz is greater than or equal to the predetermined distance threshold, the collision determiner 2504 can be operative to determine that there is large fitting error in generation of at least one collision boundary line EWL. Then, the collision determiner 2504 can be operative to determine the collision risk of the own vehicle V with one or more obstacles BZ using a well-known alternative collision determination method different from the above collision determination threshold based on the collision boundary lines EWL. As the well-known alternative collision determination method, one of well-known collision determination methods, such as a collision determination method based on distances between the own vehicle V and one or more obstacles BZ, can be used.

The fifth specific application of the second embodiment efficiently prevents reduction in the accuracy of determining the collision risk of the own vehicle V with the one or more obstacles BZ.

FIG. 78 is a flowchart schematically illustrating a collision determination subroutine according to the fifth specific application of the second embodiment.

Specifically, following the operation in step S404 of the collision risk determination routine illustrated in FIG. 73, the processor 21 performs a level of accuracy for the left-side collision boundary line EWL in steps S501 to S503.

That is, the processor 21 serves as, for example, the collision determiner 2504 to acquire, for example, the left-side collision boundary line EWL generated based on the curve fitting into the sequence of the left-side collision boundary points Pz, and acquire the position of each left-side collision boundary point Pz as input information in step S501.

Next, the processor 21 serves as, for example, the collision determiner 2504 to calculate a distance deviation AD between the position of each left-side collision boundary point Pz and the corresponding position on the left-side collision boundary line EWL in step S502.

Then, the processor 21 serves as, for example, the collision determiner 2504 to determine whether the distance deviation AD for each collision boundary point Pz of the left-side collision boundary line EW and the corresponding position on the left-side collision boundary line EWL is smaller than the predetermined distance threshold in step S503.

Upon determination that the distance deviation AD for each collision boundary point Pz is smaller than the predetermined distance threshold (YES in step S503), the processor 21 determines that the curve fitting used to generate the left-side collision boundary line EWL has a sufficient level of accuracy.

Otherwise, upon determination that the distance deviation AD for at least one collision boundary point Pz is greater than or equal to the predetermined distance threshold (NO in step S503), the processor 21 determines that there is large fitting error in generation of the left-side collision boundary line EWL.

Similarly, the processor 21 performs the level of accuracy for the right-side collision boundary line EWL in the same manner of steps S501 to S503.

That is, upon determination that the curve fitting used to generate each of the left- and right-side side collision boundary lines EWL has a sufficient level of accuracy (YES in step S503), the collision-determination subroutine proceeds to step S504. In step S504, the processor 21 serves as, for example, the collision determiner 2504 to determine the collision risk of the own vehicle V with one or more obstacles BZ based on the left- and right-side collision boundary lines EWL in step S504, which is similar to the operations in step S405 to S407. Thereafter, the processor 21 terminates the collision determination subroutine.

Otherwise, upon determination that there is large fitting error in generation of at least one of the left- and right-side collision boundary lines EWL (NO in step S503), the collision-determination subroutine proceeds to step S505. In step S505, the processor 21 serves as, for example, the collision determiner 2504 to determine the collision risk of the own vehicle V with one or more obstacles BZ using a well-known alternative collision determination method different from the above collision determination threshold based on the collision boundary lines EWL, and thereafter terminates the collision determination subroutine.

Accordingly, as described above, the fifth specific application of the second embodiment efficiently prevents reduction in the accuracy of determining the collision risk of the own vehicle V with the one or more obstacles BZ.

### Sixth Specific Application

The following describes a sixth specific application of the second embodiment.

Even if there is no such large curve-fitting error in generation of a collision boundary line EWL like the fifth specific application, a certain level of curve-fitting error may occur in generation of a collision boundary line EWL. Additionally, generation of a collision boundary line EWL using function approximation described in the third specific application of the second embodiment may result in approximation error occurring in generation of a collision boundary line EW.

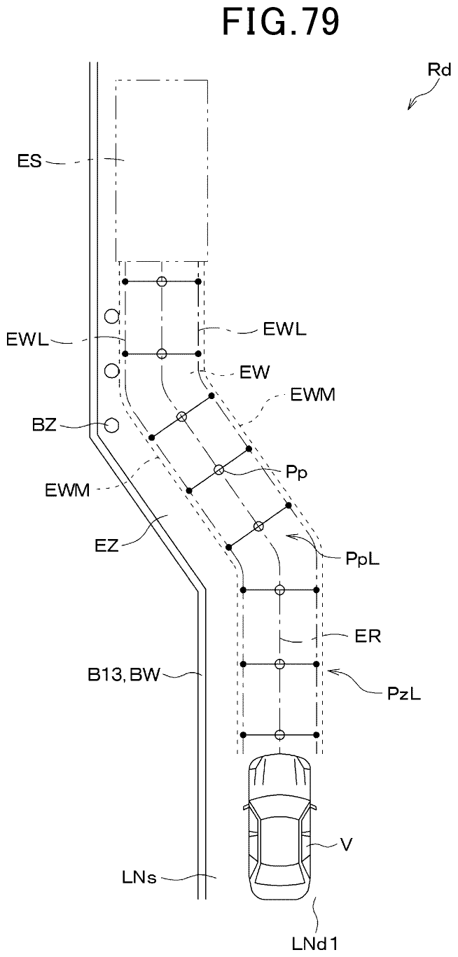

From this viewpoint, the collision boundary-line generator 2503 or the collision determiner 2504 according to the fifth specific application can be operative to establish, as illustrated in FIG. 79, left and right margins located outside the respective left- and right-side collision boundary lines EWL in accordance with the approximation error and/or the curve-fitting error.

Specifically, the collision boundary-line generator 2503 or the collision determiner 2504 according to the fifth specific application can be operative to generate left and right margin lines EWM located outside the respective left- and right-side boundary lines EW in accordance with the approximation error and/or the curve-fitting error; each of the left and right margin lines EWM is separated by a predetermined distance away from the corresponding one of the left- and right-side boundary lines EW. The predetermined distance, i.e., a predetermined interval, between each of the left and right margin lines EWM and the corresponding one of the left- and right-side boundary lines EW can be determined based on the sum of the approximation error and/or the curve-fitting error. This therefore makes it possible to improve the accuracy of determining the collision risk of the own vehicle V with the one or more obstacles BZ.

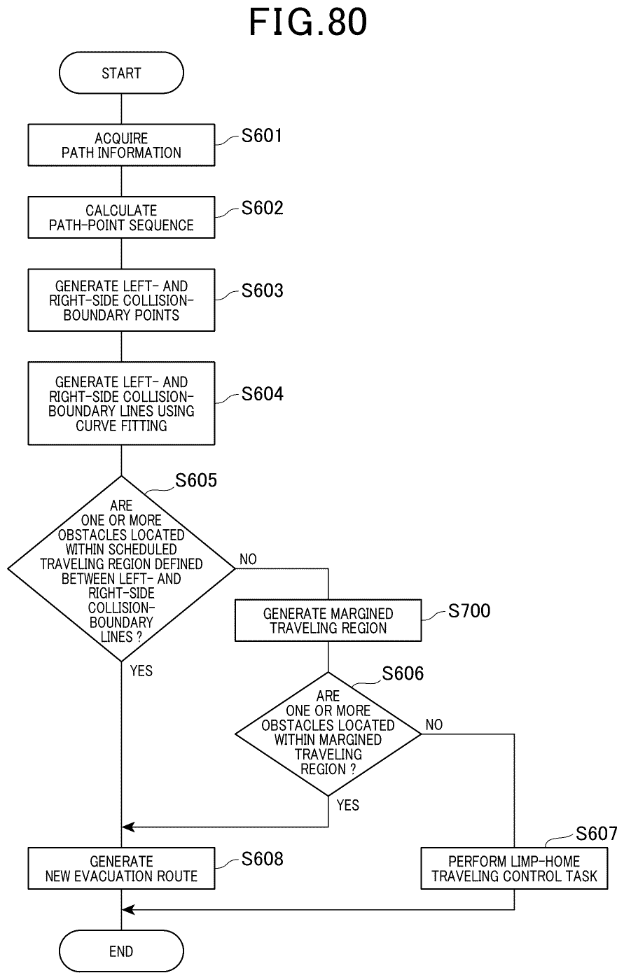

The following describes a collision risk determination routine carried out by the processor 21 of the driving ECU 2 in accordance with FIG. 80. Because the operations in steps S601 to S604 of FIG. 80 are respectively identical to those in steps S401 to S404 of FIG. 73, the descriptions of the operations in steps S401 to S404 are employed to describe the operations in steps S601 to S604 of FIG. 80, and therefore additional descriptions of the operations in steps S601 to S604 are omitted.

Following the operation in step S604, which generates the left- and right-side collision boundary lines EWL, the processor 21 serves as, for example, the collision determiner 2504 to define a scheduled traveling region EW of the own vehicle V between the generated left- and right-side collision boundary lines EWL in step S605. Then, the processor 21 serves as, for example, the collision determiner 2504 to determine whether one or more obstacles BZ are located in the scheduled traveling region EW in step S605. The operation in step S605 is substantially identical to that in step S405.

Upon determination that no obstacles BZ are located in the scheduled traveling region EW (NO in step S605), the collision risk determination routine proceeds to step S700.

In step S700, the processor 21 serves as, for example, the collision boundary-line generator 2503 or the collision determiner 2504 to generate left and right margin lines EWM located outside the respective left- and right-side boundary lines EW in accordance with the approximation error and/or the curve-fitting error; each of the left and right margin lines EWM is separated by a predetermined distance away from the corresponding one of the left- and right-side boundary lines EW.

In step S700, the processor 21 serves as, for example, the collision determiner 2504 to define a margined traveling region between the generated left- and right-side margin lines EWM. Then, the processor 21 serves as, for example, the collision determiner 2504 to determine whether one or more obstacles BZ are located in the margined traveling region in step S606.

Upon determination that no obstacles BZ are located in the margined traveling region (NO in step S606), the processor 21 determines that there is no collision risk of the own vehicle V with obstacles BZ during traveling of the own vehicle V along the evacuation route ER. Then, like the operation of the control information determiner 2404, the processor 21 determines control information to accordingly perform, based on the determined control information, the limp-home traveling control task of causing the own vehicle V to travel from the current location to the evacuation space ES along the evacuation route ER while decelerating the own vehicle V in step S607.

Otherwise, upon determination that one or more obstacles BZ are located in the scheduled traveling region EW (YES in step S605) or one or more obstacles BZ are located in the margined traveling region (YES in step S606), the processor 21 determines that there is a collision risk of the own vehicle V with the one or more obstacles BZ. Then, like the operation of the evacuation route generator 2403, the processor 21 generates a new evacuation route ER again; the new evacuation route ER is located to avoid the one or more obstacles BZ in step S608. Subsequently, like the operation of the control information determiner 2404, the processor 21 determines control information to accordingly start, based on the determined control information, the limp-home traveling control task of causing the own vehicle V to travel from the current location to the evacuation space ES along the evacuation route ER while decelerating the own vehicle V in step S608. In step S608, the processor 21 can detect a new evacuation space ES and generate a new evacuation route ER from the current location of the own vehicle V to the new evacuation space ES.

The sixteenth specific application of the second embodiment therefore makes it possible to improve the accuracy of determining the collision risk of the own vehicle V with the one or more obstacles BZ.

### Seventh Specific Application

The following describes a seventh specific application of the second embodiment.

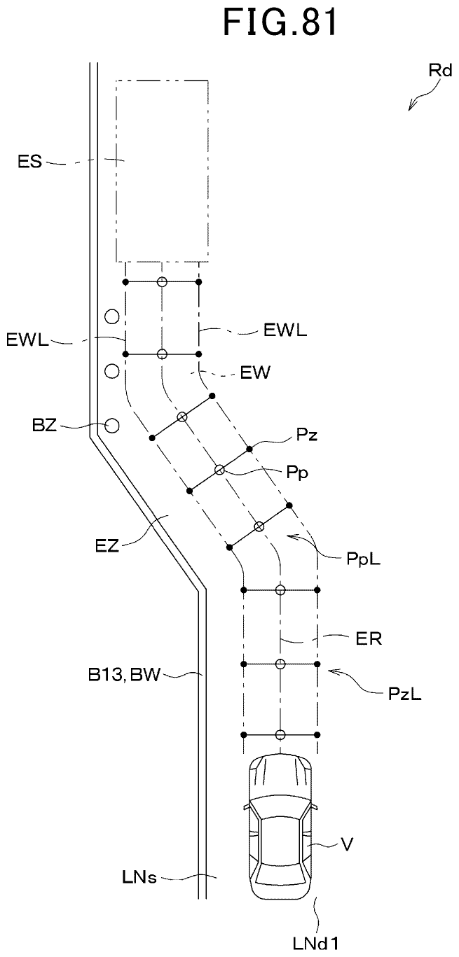

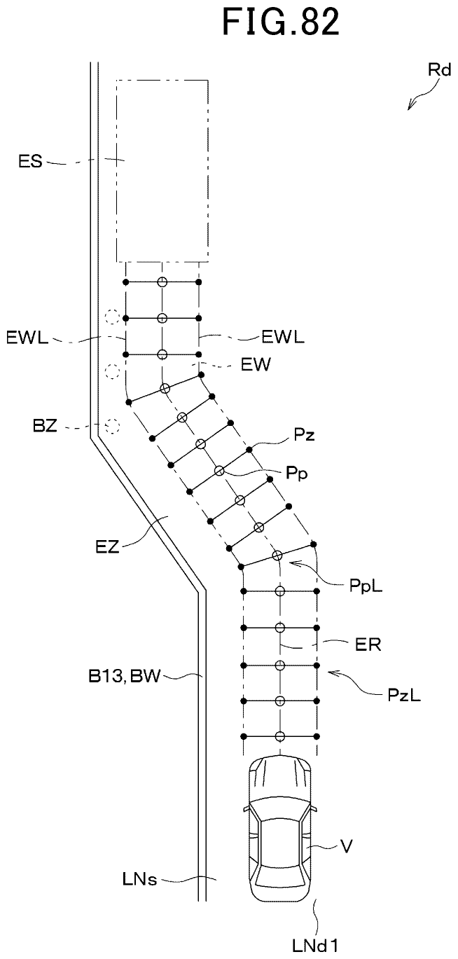

FIG. 81 schematically illustrates an example where information on one or more obstacles BZ detected or recognized around the scheduled traveling region EW has a higher level of certainty than a predetermined certainty threshold. In contrast, FIG. 82 schematically illustrates an example where information on one or more obstacles BZ detected around the scheduled traveling region EW has a lower level of certainty than the redetermined certainty threshold.

From this viewpoint, the seventh specific application of the second embodiment is configured to increase the number of path points Pp upon determination that information on one or more obstacles BZ detected around the scheduled traveling region EW has low certainty.

Specifically, in, for example, step S402, the processor 21 serves as, for example, the path point calculator 2501 to increase the number of path points Pp upon determination that existence information on one or more obstacles BZ existing around the scheduled traveling region EW has a lower level of certainty than a predetermined reference threshold. A lower level of certainty of the existence information on one or more obstacles BZ represents that a level of reliability or accuracy of at least one of (i) an existence, a position, and a type of each obstacle BZ is lower than at least one of corresponding reference thresholds.

The seventh specific application of the second embodiment therefore makes it possible to reduce the number of path points Pp to be as small as possible upon determination that information on one or more obstacles BZ detected or recognized around the scheduled traveling region EW has a higher level of certainty. This results in further reduction in the processing load of the processor 21.

Additionally, the seventh specific application of the second embodiment therefore makes it possible to increase the number of path points Pp, i.e., the number of collision boundary points Pz as large as possible upon determination that information on one or more obstacles BZ detected or recognized around the scheduled traveling region EW has a lower level of certainty. This results in an improvement of the accuracy of generating the scheduled target region EW, thus improving the accuracy of determining the collision risk of the own vehicle V with one or more obstacles BZ.

### Modifications

While the exemplary embodiment of the present disclosure has been described above, the present disclosure is not limited to the exemplary embodiment. Specifically, the present disclosure includes various modifications and/or alternatives of the exemplary embodiment within the scope of the present disclosure.

The following describes typical modifications of the exemplary embodiment. In the typical modifications, to the same parts or equivalent parts of the exemplary embodiment, like reference characters are assigned, so that, as the descriptions of each of the same or equivalent parts of the typical modifications, the descriptions of the corresponding one of the same or equivalent parts of the exemplary embodiment can be employed unless technical contradiction arises or otherwise specified.

The present disclosure is not limited to specific structures described in the exemplary embodiment. For example, the shape and/or the configuration of the body V1 of the system-installed vehicle V are not limited to a boxed shape, i.e., a substantially rectangular shape in plan view. The body panel V15 can be configured not to cover the top of the interior V2 or a part of the body panel V15, which covers the top of the interior V2, can be removable. Various applications of the system-installed vehicle V, the location of each of the driver's seat V23 and the steering wheel V24, and the number of occupants in the system-installed vehicle V may not have any limitations applied.

The definition of the autonomous driving, the driving levels of the autonomous driving, and various categories of the autonomous driving according to the exemplary embodiment are defined in the SAE J2016 standard, but the present disclosure is not limited thereto.

Specifically, the autonomous driving in each of the SAE levels 3 to 5 represents that the vehicular system 1 serves as the autonomous driving system to execute all dynamic driving tasks in the corresponding one of the SAE levels 3 to 5. For this reason, the above definition of the autonomous driving according to the exemplary embodiment naturally includes no driver's requirement for monitoring the traffic environment around the own vehicle V. The present disclosure is not limited to the above definition.

Specifically, the definition of the autonomous driving can include not only autonomous driving with no driver's requirement for monitoring the traffic environment around the own vehicle V, but also autonomous driving with driver's requirement for monitoring the traffic environment around the own vehicle V. For example, hands-off driving according to the exemplary embodiment can be interpreted as autonomous driving with a driver's requirement for monitoring the traffic environment around the own vehicle V. The concept of autonomous driving with driver's requirement for monitoring the traffic environment around the own vehicle V can include partial autonomous driving in which the driver D executes some of the dynamic driving tasks, such as the task of monitoring the traffic environment around the own vehicle V. The partial autonomous driving can be evaluated to be substantially synonymous with the advanced driving assistance. The road traffic system of each country can have limitations on types of the autonomous driving and/or conditions, such as autonomous-driving executable roads, allowable traveling speed ranges for autonomous driving, and lane-change enabling/disabling. For this reason, the specifications of the present disclosure can be modified to be in conformity with the road traffic system of each country.

The configuration of the vehicular system 1 according to the present disclosure is not limited to that of the vehicular system 1 of the exemplary embodiment described above.

For example, the number of ADAS sensors 31, 32, 33, and 34 and the location of each of the ADAS sensors 31, 32, 33, and 34 can be freely determined. For example, the number of relatively expensive radar sensor 32 and laser-radar sensors 33 can be reduced to be as small as possible, thus contributing to earlier proliferation of autonomous vehicles. The radar sensor 32 and laser-radar sensors 33 can be eliminated.

The locator 39 according to the present disclosure is not limited to the above configuration that includes the inertia detector 392. Specifically, the locator 39 according to the present disclosure can be configured not to include the inertia detector 392 and can be configured to receive (i) the linear accelerations measured by an acceleration sensor provided outside the locator 39 as one of the behavior sensors 36 and (ii) the angular velocities measured by an angular velocity sensor provided outside the locator 39 as one of the behavior sensors 36. The locator 39 can be integrated with the HD map database 5. The locator 39 is not limited to a POSLV system manufactured by Applanix Corporation.

The navigation system 6 can be communicably connected to the HMI system 7 through a subnetwork different from the vehicular communication network 10. The navigation system 6 can include a screen for displaying only navigation images, which is a separate member from the HMI system 7. Alternatively, the navigation system 6 can constitute a part of the HMI system 7. For example, the navigation system 6 can be integrated with the main display device 703.

The HMI system 7 according to the present disclosure is not limited to the above configuration that includes the meter panel 702, the main display device 703, and the head-up display 704. Specifically, the HMI system 7 can be configured to include a single display device, such as a liquid-crystal display device or an organic EL display device, that serves as both the meter panel 702 and the main display device 703. In this modification, the meter panel 702 can be designed as a part of a display region of the single display device. Specifically, the meter panel 702 can be comprised of a graphical tachometer, a graphic tachometer, a graphic speedometer, and a graphic water temperature gauge, each of which is comprised of an image of bezel, an image of a scale on the image of bezel, and an image of an indicator needle on the image of bezel.

The HMI system 7 can be configured not to include the head-up display 704.

Each ECU according to the exemplary embodiment is configured as a vehicular microcomputer comprised of, for example, a CPU and/or an MPU, but the present disclosure is not limited thereto.

Specifically, a part or the whole of each ECU can be configured as one or more digital circuits, such as one or more application specific integrated circuits (ASICs) or one or more field-programmable gate-array (FPGA) processors. That is, each ECU can be concurrently comprised of one or more vehicular microcomputers and one or more digital circuits.

The computer programs, i.e., computer-program instructions, described in the exemplary embodiment, which cause the processor 21 to execute various operations, tasks, and/or procedures set forth above, can be downloaded into the memory device 22 or upgraded using vehicle-to-everything (V2X) communications through the vehicular communication module 4. The computer-program instructions can be downloaded and/or upgraded through terminals; the terminals are provided in, for example, a manufacturing factor of the own vehicle V, a garage, or an authorized distributor. The computer programs can be stored in a memory card, an optical disk, or a magnetic disk, accessible to the processor 21 which can read out. That is, the memory card, optical disk, or magnetic disk can serve as the memory device 22.

The functional configurations and methods described in the present disclosure can be implemented by a dedicated computer including a memory and a processor programmed to perform one or more functions embodied by one or more computer programs.

The functional configurations and methods described in the present disclosure can also be implemented by a dedicated computer including a processor comprised of one or more dedicated hardware logic circuits.

The functional configurations and methods described in the present disclosure can further be implemented by a processor system comprised of a memory, a processor programmed to perform one or more functions embodied by one or more computer programs, and one or more hardware logic circuits.

The one or more computer programs can be stored in a non-transitory storage medium as instructions to be carried out by a computer or a processor. The functional configurations and methods described in the present disclosure can be implemented as one or more computer programs or a non-transitory storage medium that stores these one or more computer programs.

The present disclosure is not limited to the specific operations and/or the specific processes described in the above embodiments. For example, the specification and figures are described on the premise that the drivers keep to the left side of the road in conformity with the Japanese Road Traffic Laws/Regulations, but the present disclosure is not limited thereto. Specifically, the specification and figures of the present disclosure can be modified in accordance with the premise that the drivers keep to the right side of the road in conformity with the other country's Road Traffic Laws/Regulations, such as the US Road Traffic Laws/Regulations.

The second embodiment is typically applied to the driving ECU 2 of the own vehicle V in a situation where the driving ECU 2 determines a risk that the own vehicle V traveling in a predetermined traveling route will collide with one or more objects, but the present disclosure is not limited to such a situation.

Specifically, the second embodiment can be preferably applied to a control unit, such as an ECU, of a vehicle, which is subjected to parking assistance or autonomous parking, when the control unit determines a collision risk that the vehicle will collide with one or more obstacles. Alternatively, the second embodiment can be preferably applied to a control unit of a fixed route bus in a situation where the control unit of the fixed route bus performs a stop operation at a bus stop or a control unit of a vehicle in a situation where the control unit of the vehicle performs a stop operation for charging fuel and/or electric energy into a storage of the vehicle.

Specifically, the second embodiment can be preferably applied to a control unit of a vehicle in various situations where the vehicle is traveling along a scheduled traveling route toward a target stop space.

Similar expressions, such as “obtaining”, “calculation”, “estimation”, “detection”, and “determination”, can be mutually substituted for one another unless the substitution produces technological inconsistency. The expression that A is more than (greater than or other similar expressions) or equal to B, and the expression that A is more than B can be substituted for one another unless the substitution produces technological inconsistency. Similarly, the expression that A is less than (smaller than or other similar expressions) or equal to B, and the expression that A is less than B can be substituted for one another unless the substitution produces technological inconsistency.

One or more components in the exemplary embodiment are not necessarily essential components except for (i) one or more components that are described as one or more essential components or (ii) one or more components that are essential in principle.

Specific values disclosed in the exemplary embodiment, each of which represents the number of components, a physical quantity, and/or a range of a physical parameter, are not limited thereto except that (i) the specific values are obviously essential or (ii) the specific values are essential in principle.

The specific structure and direction of each component described in the exemplary embodiment are not limited thereto except for cases in which (1) the specific structure and direction are described to be essential or (2) the specific structure and direction are required in principle. Additionally, the specific structural or functional relationship between components described in the exemplary embodiment is not limited thereto except for cases in which (1) the specific structural or functional relationship is described to be essential or (2) the specific structural or functional relationship is required in principle.

Modifications of the present disclosure are not limited to those described set forth above. For example, specific examples described above can be combined with each other unless the combination produces technological inconsistency, and similarly the modifications set forth above can be combined with each other unless the combination produces technological inconsistency. At least part of the exemplary embodiment can be combined with at least part of the modifications set forth above unless the combination produces technological inconsistency.

The present disclosure includes the following technological-concepts.

### [Technological Concept A1-1]

The technological concept A1-1 provides an apparatus (2) for controlling an own vehicle (V) traveling on a road. The apparatus includes a recognizing unit (2401) configured to recognize at least one road marking line (B431) and at least a closer edge (Le) of the road located around the own vehicle. The closer edge of the road is one of edges of the road being closer to the own vehicle than the other of the edges of the road is. The apparatus includes a detecting unit (2402) configured to detect, based on the at least one road marking line and the closer edge of the road, an evacuation space at a location of the road where the own vehicle is parkable in an extending direction of the road. The apparatus includes a first determining unit (2404) configured to determine whether a detection result of the evacuation space is reliable. The apparatus includes a second determining unit (2405) configured to determine whether to perform limp-home control that causes the own vehicle to travel from a current location of the own vehicle to the evacuation space in response to determination of whether the detection result of the evacuation space is reliable.

### [Technological Concept A1-1A]

The technological concept A1-1A depends from the technological concept A1-1. Specifically, the second determining unit is configured to determine not to perform the limp-home control in response to determination that the detection result of the evacuation space is not reliable, and determine to perform the limp-home control in response to determination that the detection result of the evacuation space is reliable.

### [Technological Concept A1-2]

The technological concept A1-2 depends from the technological concept A1-1. Specifically, the first determining unit according to the technological concept A1-2 is configured to determine a level of reliability for the detection result of the evacuation space, the level of reliability being a likelihood of an actual existence of the evacuation space. The second determining unit is configured to determine whether to perform the limp-home control in accordance with the determined level of reliability.

### [Technological Concept A1-3]

The technological concept A1-3 depends from the technological concept A1-2. Specifically, the first determining unit according to the technological concept A1-3 is configured to determine the level of reliability in accordance with at least one of (i) information on the recognized closer edge of the road, (ii) an amount of correction of at least one of a location and a size of the evacuation space if at least one of the location and the size of the evacuation space is corrected, and (iii) a distance of the own vehicle to the evacuation space.

### [Technological Concept A1-4]

The technological concept A1-4 depends from any one of the technological concepts A1-1, A1-1A, A1-2, and A1-3. Specifically, the detecting unit according to the technological concept A1-4 is configured to detect, based on the at least one road marking line and the closer edge of the road, at least first and second evacuation spaces as the evacuation space at respective first and second locations of the road in the extending direction of the road. The first determining unit is configured to determine whether a detection result of the first evacuation space is reliable. The second determining unit is configured to determine not to perform the limp-home control upon determination that the detection result of the first evacuation space is not reliable. The second determining unit is configured to determine to perform modified limp-home control that causes the own vehicle to travel from the current location of the own vehicle to the second evacuation space upon determination that the detection result of the first evacuation space is not reliable.

### [Technological Concept A1-5]

The technological concept A1-5 depends from the technological concept A1-4. Specifically, the detecting unit according to the technological concept A1-5 is configured to detect the at least first and second evacuation spaces as the evacuation space at the respective first and second locations of the road in the extending direction of the road when determining that an emergency parking zone (EZ) is located in a traveling course of the own vehicle in the road.

### [Technological Concept A1-6]

The technological concept A1-6 depends from any one of the technological concepts A1-1, A1-1A, A1-2, A1-3, A1-4, and A1-5. Specifically, the recognizing unit according to the technological concept A1-6 is configured to recognize first information on indicative of a parkable location in a shoulder (LNs) of the road and second information indicative of an existence of a blind spot from the own vehicle. The apparatus according to the technological concept A1-6 further includes a performing unit configured to perform one or more preparation operations for parking the own vehicle in the road shoulder.

### [Technological Concept A1-7]

The technological concept A1-7 depends from the technological concept A1-6. Specifically, the one or more preparation operations according to the technological concept A1-7 include offsetting the own vehicle in a width direction of the road.

### [Technological Concept A1-8]

The technological concept A1-8 depends from any one of the technological concepts A1-1, A1-1A, A1-2, A1-3, A1-4, A1-5, A1-6, and A1-7. Specifically, the second determining unit according to the technological concept A1-8 is configured to determine to perform the limp-home control while decelerating the own vehicle upon determination that the detection result of the evacuation space is reliable.

The apparatus according to the technological concept A1-8 further includes a changing unit configured to change, during the limp-home control being performed, how to decelerate the own vehicle in accordance with change of a relative distance of the evacuation space from the own vehicle.

### [Technological Concept A1-9]

The technological concept A1-9 depends from any one of the technological concepts A1-1, A1-1A, A1-2, A1-3, A1-4, A1-5, A1-6, A1-7, and A1-8. Specifically, the second determining unit according to the technological concept A1-9 is configured to determine to perform the limp-home control in accordance with at least one control parameter upon determination that the detection result of the evacuation space is reliable. The apparatus according to the technological concept A1-9 further includes a changing unit configured to change, during the limp-home control being performed, the at least one control parameter in accordance with at least one of a speed of the own vehicle and a location of the evacuation space relative to the own vehicle.

### [Technological Concept A1-10]

The technological concept A1-10 depends from any one of the technological concepts A1-1, A1-1A, A1-2, A1-3, A1-4, A1-5, A1-6, A1-7, A1-8, and A1-9. Specifically, the apparatus according to the technological concept A1-10 further includes a continuity determining unit configured to determine, after it is determined that the detection result of the evacuation space is not reliable, to continue the limp-home control that causes the own vehicle to travel from the current location of the own vehicle to the evacuation space upon determination that it is difficult to detect another evacuation space.

### [Technological Concept A1-11]

The technological concept A1-11 depends from any one of the technological concepts A1-1, A1-1A, A1-2, A1-3, A1-4, A1-5, A1-6, A1-7, A1-8, A1-9, and A1-10. Specifically, the apparatus according to the technological concept A1-11 further includes an evacuation route generator (2403) configured to generate, based on a predetermined curve model, an evacuation route (ER) from the current location of the own vehicle to the evacuation space. The apparatus includes a calculating unit (2501) configured to calculate a path-point sequence (PpL) comprised of a plurality of path points (Pp) along the evacuation route, and a collision boundary generator (2502, 2503).

The collision boundary generator is configured to
(i) Generate, for each path point, a pair of left- and right-side collision boundary points (Pz), each of the left-side collision boundary points being separated leftward away from the corresponding path point by a first predetermined distance, each of the right-side collision boundary points being separated rightward away from the corresponding path point by a second predetermined distance
(ii) Perform curve fitting into each of a first sequence of the left-side collision boundary points to accordingly generate a left-side collision boundary line (PzL), and a second sequence of the right-side collision boundary points to accordingly generate a right-side collision boundary line (PzL)

The apparatus includes a collision determiner (2504) configured to determine a collision risk of the own vehicle with one or more obstacles (BZ) in accordance with the left- and right-side collision boundary lines.

### [Technological Concept A1-12]

The technological concept A1-12 depends from the technological concept A1-11. Specifically, each of the first and second distances according to the technological concept A1-12 is determined based on at least one of (i) a wheel of the own vehicle, (ii) an inner wheel difference of the own vehicle, (iii) an outer wheel difference of the own vehicle, (iv) a recognition error of the recognition, and (v) a motion-control error of the own vehicle.

### [Technological Concept A1-13]

The technological concept A1-13 depends from the technological concept A1-11 or A1-12. Specifically, the calculating unit according to the technological concept A1-13 is configured to change the number of the path points in accordance with the curve model.

### [Technological Concept A1-14]

The technological concept A1-14 depends from any one of the technological concepts A1-11 to A1-13. Specifically, the calculating unit according to the technological concept A1-14 is configured to increase the number of the path points upon determination that existence information on the one or more obstacles has a lower level of certainty than a predetermined reference threshold.

### [Technological Concept A1-15]

The technological concept A1-15 depends from any one of the technological concepts A1-11 to A1-14. Specifically, the collision determiner according to the technological concept A1-15 is configured to determine whether the one or more obstacles are located within a region defined between the left- and right-side collision boundary lines to accordingly determine the collision risk of the own vehicle with the one or more obstacles.

### [Technological Concept A1-16]

The technological concept A1-16 depends from any one of the technological concepts A1-11 to A1-14. Specifically, the collision determiner according to the technological concept A1-16 is configured to determine the collision risk of the own vehicle with the one or more obstacles based on a lateral position of each of the one or more obstacles in a width direction of the road and a lateral position of one of the left- and right-side collision boundary lines.

### [Technological Concept A1-17]

The technological concept A1-17 depends from any one of the technological concepts A1-11 to A1-16. Specifically, the collision boundary generator according to the technological concept A1-17 is configured to approximate a trigonometric function representing a multiple dimensional curve model as the curve model by Taylor expansion based on parameters of the multiple dimensional curve model to accordingly calculate the left- and right side collision boundary lines. The collision boundary generator according to the technological concept A1-17 is configured to establish left and right margins located outside the respective left- and right-side collision boundary lines in accordance with first error of the approximating error and/or second error of the fitting.

### [Technological Concept A1-18]

The technological concept A1-18 depends from any one of the technological concepts A1-11 to A1-17. Specifically, the collision boundary generator according to the technological concept A1-18 is configured to establish left and right margins located outside the respective left- and right-side collision boundary lines in accordance with (i) approximation error occurring in generation of the collision boundary lines and (ii) curve-fitting error occurring in generation of the collision boundary lines.

### [Technological Concept A1-19]

The technological concept A1-19 depends from any one of the technological concepts A1-11 to A1-18. Specifically, the collision determiner according to the technological concept A1-19 is configured to:
(i) calculate a distance deviation between a position of each collision boundary point and a corresponding position of a selected one of the left- and right-side collision boundary lines;
(ii) determine whether the distance deviation for each collision boundary point and the corresponding position on the selected one of the left- and right-side collision boundary lines is greater than or equal to a predetermined distance threshold;
(iii) determine that there is large fitting error in generation of at least one of the left- and right-side collision boundary lines upon determination that the distance deviation for at least one collision boundary point is greater than or equal to the predetermined distance threshold; and
(iv) determine the collision risk of the own vehicle with the one or more obstacles using an alternative collision determination method different from a collision determination threshold based on the left- and right-side collision boundary lines.

### [Technological Concept A1-20]

The technological concept A1-20 depends from any one of the technological concepts A1-11 to A1-19. Specifically, the curve model according to the technological concept A1-20 is comprised of a plurality of curve models, and the evacuation route generator according to the technological concept A1-20 is configured to generate, based on the plurality of curve models, a plurality of sections of the evacuation route, respectively. The collision boundary generator according to the technological concept A1-20 is configured to perform fitting of a plurality of curve-fitting models prepared for the respective curve models into each of the first sequence of the left-side collision boundary points to accordingly generate the left-side collision boundary line and the second sequence of the right-side collision boundary points to accordingly generate the right-side collision boundary line.

### [Technological Concept A2-1]

The technological concept A2-1 provides a method of controlling an own vehicle (V) traveling on a road. The method includes:
(i) recognizing at least one road marking line (B431) and at least a closer edge (Le) of the road located around the own vehicle, the closer edge of the road being one of edges of the road being closer to the own vehicle than the other of the edges of the road is
(ii) detecting, based on the at least one road marking line and the closer edge of the road, an evacuation space (ES) at a location of the road where the own vehicle is parkable in an extending direction of the road
(iii) determining whether a detection result of the evacuation space is reliable
(iv) determining whether to perform limp-home control that causes the own vehicle to travel from a current location of the own vehicle to the evacuation space in response to determination of whether the detection result of the evacuation space is reliable.

### [Technological Concept A2-1A]

The technological concept A2-1A depends from the technological concept A2-1. Specifically, the determining whether to perform limp-home control determines not to perform the limp-home control in response to determination that the detection result of the evacuation space is not reliable, and determines to perform the limp-home control in response to determination that the detection result of the evacuation space is reliable.

### [Technological Concept A2-2]

The technological concept A2-2 depends from the technological concept A2-1. Specifically, the determining whether a detection result of the evacuation space is reliable according to the technological concept A2-2 includes determining a level of reliability for the detection result of the evacuation space, the level of reliability being a likelihood of an actual existence of the evacuation space. The determining whether to perform limp-home control determines whether to perform the limp-home control in accordance with the determined level of reliability.

### [Technological Concept A2-3]

The technological concept A2-3 depends from the technological concept A2-2. Specifically, the determining a level of reliability according to the technological concept A2-3 determines the level of reliability in accordance with at least one of:
(i) information on the recognized closer edge of the road;
(ii) an amount of correction of at least one of a location and a size of the evacuation space if at least one of the location and the size of the evacuation space is corrected; and
(iii) a distance of the own vehicle to the evacuation space.

### [Technological Concept A2-4]

The technological concept A2-4 depends from any one of the technological concepts A2-1, A2-1A, A2-2, and A2-3. Specifically, the detecting according to the technological concept A2-4 detects, based on the at least one road marking line and the closer edge of the road, at least first and second evacuation spaces as the evacuation space at respective first and second locations of the road in the extending direction of the road.

The determining whether a detection result of the evacuation space is reliable according to the technological concept A2-4 determines whether a detection result of the first evacuation space is reliable.

The determining whether to perform limp-home control according to the technological concept A2-4 determines not to perform the limp-home control upon determination that the detection result of the first evacuation space is not reliable.

The method according to the technological concept A2-4 further includes determining to perform modified limp-home control that causes the own vehicle to travel from the current location of the own vehicle to the second evacuation space upon determination that the detection result of the first evacuation space is not reliable.

### [Technological Concept A2-5]

The technological concept A2-5 depends from the technological concept A2-4. Specifically, the detecting according to the technological concept A2-5 detects the at least first and second evacuation spaces as the evacuation space at the respective first and second locations of the road in the extending direction of the road when determining that an emergency parking zone (EZ) is located in a traveling course of the own vehicle in the road.

### [Technological Concept A2-6]

The technological concept A2-6 depends from any one of the technological concepts A2-1, A2-1A, A2-2, A2-3, A2-4, and A2-5. Specifically, the recognizing according to the technological concept A2-6 recognizes first information on indicative of a parkable location in a shoulder (LNs) of the road and second information indicative of an existence of a blind spot from the own vehicle.

The method according to the technological concept A2-6 further includes performing one or more preparation operations for parking the own vehicle in the road shoulder.

### [Technological Concept A2-7]

The technological concept A2-7 depends from the technological concept A2-6. Specifically, the one or more preparation operations according to the technological concept A2-7 include offsetting the own vehicle in a width direction of the road.

### [Technological Concept A2-8]

The technological concept A2-8 depends from any one of the technological concepts A2-1, A2-1A, A2-2, A2-3, A2-4, A2-5, A2-6, and A2-7. Specifically, the determining whether to perform limp-home control according to the technological concept A2-8 determines to perform the limp-home control while decelerating the own vehicle upon determination that the detection result of the evacuation space is reliable.

The method according to the technological concept A2-8 further includes changing, during the limp-home control being performed, how to decelerate the own vehicle in accordance with change of a relative distance of the evacuation space from the own vehicle.

### [Technological Concept A2-9]

The technological concept A2-9 depends from any one of the technological concepts A2-1, A2-1A, A2-2, A2-3, A2-4, A2-5, A2-6, A2-7, and A2-8. Specifically, the determining whether to perform limp-home control according to the technological concept A2-9 determines to perform the limp-home control in accordance with at least one control parameter upon determination that the detection result of the evacuation space is reliable.

The method according to the technological concept A2-9 further includes changing, during the limp-home control being performed, the at least one control parameter in accordance with at least one of a speed of the own vehicle and a location of the evacuation space relative to the own vehicle.

### [Technological Concept A2-10]

The technological concept A2-10 depends from any one of the technological concepts A2-1, A2-1A, A2-2, A2-3, A2-4, A2-5, A2-6, A2-7, A2-8, and A2-9. Specifically, the method according to the technological concept A2-10 further includes determining, after it is determined that the detection result of the evacuation space is not reliable, to continue the limp-home control that causes the own vehicle to travel from the current location of the own vehicle to the evacuation space upon determination that it is difficult to detect another evacuation space.

### [Technological Concept A2-11]

The technological concept A2-11 depends from any one of the technological concepts A2-1, A2-1A, A2-2, A2-3, A2-4, A2-5, A2-6, A2-7, A2-8, A2-9, and A2-10. Specifically, the method according to the technological concept A2-11 further includes:
(i) generating, based on a predetermined curve model, an evacuation route (ER) from the current location of the own vehicle to the evacuation space;
(ii) calculating a path-point sequence (PpL) comprised of a plurality of path points (Pp) along the evacuation route;
(iii) generating, for each path point, a pair of left- and right-side collision boundary points (Pz), each of the left-side collision boundary points being separated leftward away from the corresponding path point by a first predetermined distance, each of the right-side collision boundary points being separated rightward away from the corresponding path point by a second predetermined distance;
(iv) performing curve fitting into each of:
   a first sequence of the left-side collision boundary points to accordingly generate a left-side collision boundary line (PzL); and
   a second sequence of the right-side collision boundary points to accordingly generate a right-side collision boundary line (PzL); and
determining a collision risk of the own vehicle with one or more obstacles (BZ) in accordance with the left- and right-side collision boundary lines.

### [Technological Concept A2-12]

The technological concept A2-12 depends from the technological concept A2-11. Specifically, each of the first and second distances according to the technological concept A2-12 is determined based on at least one of (i) a wheel of the own vehicle, (ii) an inner wheel difference of the own vehicle, (iii) an outer wheel difference of the own vehicle, (iv) a recognition error of the recognition, and (v) a motion-control error of the own vehicle.

### [Technological Concept A2-13]

The technological concept A2-13 depends from the technological concept A2-11 or A2-12. Specifically, the calculating according to the technological concept A2-13 changes the number of the path points in accordance with the curve model.

### [Technological Concept A2-14]

The technological concept A2-14 depends from any one of the technological concepts A2-11 to A2-13. Specifically, the calculating according to the technological concept A2-14 increases the number of the path points upon determination that existence information on the one or more obstacles has a lower level of certainty than a predetermined reference threshold.

### [Technological Concept A2-15]

The technological concept A2-15 depends from any one of the technological concepts A2-11 to A2-14. Specifically, the determining a collision risk according to the technological concept A2-15 determines whether the one or more obstacles are located within a region defined between the left- and right-side collision boundary lines to accordingly determine the collision risk of the own vehicle with the one or more obstacles.

### [Technological Concept A2-16]

The technological concept A2-16 depends from any one of the technological concepts A2-11 to A2-14. Specifically, the determining a collision risk according to the technological concept A2-16 determines the collision risk of the own vehicle with the one or more obstacles based on a lateral position of each of the one or more obstacles in a width direction of the road and a lateral position of one of the left- and right-side collision boundary lines.

### [Technological Concept A2-17]

The technological concept A2-17 depends from any one of the technological concepts A2-11 to A2-16. Specifically, the performing curve fitting according to the technological concept A2-17 includes:
(i) approximating a trigonometric function representing a multiple dimensional curve model as the curve model by Taylor expansion based on parameters of the multiple dimensional curve model to accordingly calculate the left- and right side collision boundary lines; and
(ii) establishing left and right margins located outside the respective left- and right-side collision boundary lines in accordance with first error of the approximating error and/or second error of the fitting.

### [Technological Concept A2-18]

The technological concept A2-18 depends from any one of the technological concepts A2-11 to A2-17. Specifically, the determining a collision risk according to the technological concept A2-18 includes:
(i) calculating a distance deviation between a position of each collision boundary point and a corresponding position of a selected one of the left- and right-side collision boundary lines;
(ii) determining whether the distance deviation for each collision boundary point and the corresponding position on the selected one of the left- and right-side collision boundary lines is greater than or equal to a predetermined distance threshold;
(iii) determining that there is large fitting error in generation of at least one of the left- and right-side collision boundary lines upon determination that the distance deviation for at least one collision boundary point is greater than or equal to the predetermined distance threshold; and
(iv) determining the collision risk of the own vehicle with the one or more obstacles using an alternative collision determination method different from a collision determination threshold based on the left- and right-side collision boundary lines.

### [Technological Concept A2-19]

The technological concept A2-19 depends from any one of the technological concepts A2-11 to A2-18. Specifically, the determining a collision risk according to the technological concept A2-19 includes:
(i) calculating a distance deviation between a position of each collision boundary point and a corresponding position of a selected one of the left- and right-side collision boundary lines;
(ii) determining whether the distance deviation for each collision boundary point and the corresponding position on the selected one of the left- and right-side collision boundary lines is greater than or equal to a predetermined distance threshold;
(iii) determining that there is large fitting error in generation of at least one of the left- and right-side collision boundary lines upon determination that the distance deviation for at least one collision boundary point is greater than or equal to the predetermined distance threshold; and
(v) determining the collision risk of the own vehicle with the one or more obstacles using an alternative collision determination method different from a collision determination threshold based on the left- and right-side collision boundary lines.

### [Technological Concept A2-20]

The technological concept A2-20 depends from any one of the technological concepts A2-11 to A2-19. Specifically, the curve model according to the technological concept A2-20 is comprised of a plurality of curve models, and the generating an evacuation route generates, based on the plurality of curve models, a plurality of sections of the evacuation route, respectively. The performing performs fitting of a plurality of curve-fitting models prepared for the respective curve models into each of the first sequence of the left-side collision boundary points to accordingly generate the left-side collision boundary line and the second sequence of the right-side collision boundary points to accordingly generate the right-side collision boundary line.

### [Technological Concept A3-1]

The technological concept A3-1 provides a processor program product that includes a non-transitory storage medium readable by a processor for controlling a vehicle traveling on a road, and control program instructions stored in the non-transitory storage medium.

The control program instructions cause the processor to:
recognize at least one road marking line and at least a closer edge of the road located around the own vehicle, the closer edge of the road being one of edges of the road being closer to the own vehicle than the other of the edges of the road is;
detect, based on the at least one road marking line and the closer edge of the road, an evacuation space at a location of the road where the own vehicle is parkable in an extending direction of the road;
determine whether a detection result of the evacuation space is reliable; and
determine whether to perform limp-home control that causes the own vehicle to travel from a current location of the own vehicle to the evacuation space in response to determination of whether the detection result of the evacuation space is reliable.

### [Technological Concept A3-1A]

The technological concept A3-1A depends from the technological concept A3-1. Specifically, the control program instructions according to the technological concept A3-1A cause the processor to determine not to perform the limp-home control in response to determination that the detection result of the evacuation space is not reliable, and determine to perform the limp-home control in response to determination that the detection result of the evacuation space is reliable.

### [Technological Concept A3-2]

The technological concept A3-2 depends from the technological concept A3-1. Specifically, the control program instructions according to the technological concept A3-1A cause the processor to determine a level of reliability for the detection result of the evacuation space, the level of reliability being a likelihood of an actual existence of the evacuation space. The control program instructions cause the processor to determine whether to perform the limp-home control in accordance with the determined level of reliability.

### [Technological Concept A3-3]

The technological concept A3-3 depends from the technological concept A3-2. Specifically, the control program instructions according to the technological concept A3-3 cause the processor to determine the level of reliability in accordance with at least one of (i) information on the recognized closer edge of the road, (ii) an amount of correction of at least one of a location and a size of the evacuation space if at least one of the location and the size of the evacuation space is corrected, and (iii) a distance of the own vehicle to the evacuation space.

### [Technological Concept A3-4]

The technological concept A3-4 depends from any one of the technological concepts A3-1, A3-1A, A3-2, and A3-3. Specifically, the control program instructions according to the technological concept A3-4 cause the processor to detect, based on the at least one road marking line and the closer edge of the road, at least first and second evacuation spaces as the evacuation space at respective first and second locations of the road in the extending direction of the road. The control program instructions according to the technological concept A3-4 cause the processor to determine whether a detection result of the first evacuation space is reliable. The control program instructions according to the technological concept A3-4 cause the processor to determine not to perform the limp-home control upon determination that the detection result of the first evacuation space is not reliable. The control program instructions according to the technological concept A3-4 cause the processor to determine to perform modified limp-home control that causes the own vehicle to travel from the current location of the own vehicle to the second evacuation space upon determination that the detection result of the first evacuation space is not reliable.

### [Technological Concept A3-5]

The technological concept A3-5 depends from the technological concept A3-4. Specifically, the control program instructions according to the technological concept A3-5 cause the processor to detect the at least first and second evacuation spaces as the evacuation space at the respective first and second locations of the road in the extending direction of the road when determining that an emergency parking zone (EZ) is located in a traveling course of the own vehicle in the road.

### [Technological Concept A3-6]

The technological concept A3-6 depends from any one of the technological concepts A3-1, A3-1A, A3-2, A3-3, A3-4, and A3-5. Specifically, the control program instructions according to the technological concept A3-6 cause the processor to recognize first information on indicative of a parkable location in a shoulder (LNs) of the road and second information indicative of an existence of a blind spot from the own vehicle. The control program instructions according to the technological concept A3-6 cause the processor further to perform one or more preparation operations for parking the own vehicle in the road shoulder.

### [Technological Concept A3-7]

The technological concept A3-7 depends from the technological concept A3-6. Specifically, the one or more preparation operations according to the technological concept A3-7 include offsetting the own vehicle in a width direction of the road.

### [Technological Concept A3-8]

The technological concept A3-8 depends from any one of the technological concepts A3-1, A3-1A, A3-2, A3-3, A3-4, A3-5, A3-6, and A3-7. Specifically, the control program instructions according to the technological concept A3-8 cause the processor to determine to perform the limp-home control while decelerating the own vehicle upon determination that the detection result of the evacuation space is reliable.

The control program instructions according to the technological concept A3-8 cause the processor to change, during the limp-home control being performed, how to decelerate the own vehicle in accordance with change of a relative distance of the evacuation space from the own vehicle.

### [Technological Concept A3-9]

The technological concept A3-9 depends from any one of the technological concepts A3-1, A3-1A, A3-2, A3-3, A3-4, A3-5, A3-6, A3-7, and A3-8. Specifically, the control program instructions according to the technological concept A3-9 cause the processor to determine to perform the limp-home control in accordance with at least one control parameter upon determination that the detection result of the evacuation space is reliable. The control program instructions according to the technological concept A3-9 cause the processor to change, during the limp-home control being performed, the at least one control parameter in accordance with at least one of a speed of the own vehicle and a location of the evacuation space relative to the own vehicle.

### [Technological Concept A3-10]

The technological concept A3-10 depends from any one of the technological concepts A3-1, A3-1A, A3-2, A3-3, A3-4, A3-5, A3-6, A3-7, A3-8, and A3-9. Specifically, the control program instructions according to the technological concept A3-10 cause the processor to determine, after it is determined that the detection result of the evacuation space is not reliable, to continue the limp-home control that causes the own vehicle to travel from the current location of the own vehicle to the evacuation space upon determination that it is difficult to detect another evacuation space.

### [Technological Concept A3-11]

The technological concept A3-11 depends from any one of the technological concepts A3-1, A3-1A, A3-2, A3-3, A3-4, A3-5, A3-6, A3-7, A3-8, A3-9, and A3-10. Specifically, the control program instructions according to the technological concept A3-11 cause the processor to:
(i) generate, based on a predetermined curve model, an evacuation route (ER) from the current location of the own vehicle to the evacuation space;
(ii) calculate a path-point sequence (PpL) comprised of a plurality of path points (Pp) along the evacuation route, and a collision boundary generator (2502, 2503);
(iii) generate, for each path point, a pair of left- and right-side collision boundary points (Pz), each of the left-side collision boundary points being separated leftward away from the corresponding path point by a first predetermined distance, each of the right-side collision boundary points being separated rightward away from the corresponding path point by a second predetermined distance;
(iv) perform curve fitting into each of a first sequence of the left-side collision boundary points to accordingly generate a left-side collision boundary line (PzL), and a second sequence of the right-side collision boundary points to accordingly generate a right-side collision boundary line (PzL); and
(v) determine a collision risk of the own vehicle with one or more obstacles (BZ) in accordance with the left- and right-side collision boundary lines.

### [Technological Concept A3-12]

The technological concept A3-12 depends from the technological concept A3-11. Specifically, each of the first and second distances according to the technological concept A3-12 is determined based on at least one of (i) a wheel of the own vehicle, (ii) an inner wheel difference of the own vehicle, (iii) an outer wheel difference of the own vehicle, (iv) a recognition error of the recognition, and (v) a motion-control error of the own vehicle.

### [Technological Concept A3-13]

The technological concept A3-13 depends from the technological concept A3-11 or A3-12. Specifically, the control program instructions according to the technological concept A3-13 cause the processor to change the number of the path points in accordance with the curve model.

### [Technological Concept A3-14]

The technological concept A3-14 depends from any one of the technological concepts A3-11 to A3-13. Specifically, the control program instructions according to the technological concept A3-14 cause the processor to increase the number of the path points upon determination that existence information on the one or more obstacles has a lower level of certainty than a predetermined reference threshold.

### [Technological Concept A3-15]

The technological concept A3-15 depends from any one of the technological concepts A3-11 to A3-14. Specifically, the control program instructions according to the technological concept A3-15 cause the processor to determine whether the one or more obstacles are located within a region defined between the left- and right-side collision boundary lines to accordingly determine the collision risk of the own vehicle with the one or more obstacles.

### [Technological Concept A3-16]

The technological concept A3-16 depends from any one of the technological concepts A3-11 to A3-14. Specifically, the control program instructions according to the technological concept A3-16 cause the processor to determine the collision risk of the own vehicle with the one or more obstacles based on a lateral position of each of the one or more obstacles in a width direction of the road and a lateral position of one of the left- and right-side collision boundary lines.

### [Technological Concept A3-17]

The technological concept A3-17 depends from any one of the technological concepts A3-11 to A3-16. Specifically, the control program instructions according to the technological concept A3-17 cause the processor to:
(i) approximate a trigonometric function representing a multiple dimensional curve model as the curve model by Taylor expansion based on parameters of the multiple dimensional curve model to accordingly calculate the left- and right side collision boundary lines; and
(ii) establish left and right margins located outside the respective left- and right-side collision boundary lines in accordance with first error of the approximating error and/or second error of the fitting.

### [Technological Concept A3-18]

The technological concept A3-18 depends from any one of the technological concepts A3-11 to A3-17. Specifically, the control program instructions according to the technological concept A3-18 cause the processor to establish left and right margins located outside the respective left- and right-side collision boundary lines in accordance with (i) approximation error occurring in generation of the collision boundary lines and (ii) curve-fitting error occurring in generation of the collision boundary lines.

### [Technological Concept A3-19]

The technological concept A3-19 depends from any one of the technological concepts A3-11 to A3-18. Specifically, the control program instructions according to the technological concept A3-19 cause the processor to:
(i) calculate a distance deviation between a position of each collision boundary point and a corresponding position of a selected one of the left- and right-side collision boundary lines;
(ii) determine whether the distance deviation for each collision boundary point and the corresponding position on the selected one of the left- and right-side collision boundary lines is greater than or equal to a predetermined distance threshold;
(iii) determine that there is large fitting error in generation of at least one of the left- and right-side collision boundary lines upon determination that the distance deviation for at least one collision boundary point is greater than or equal to the predetermined distance threshold; and
(iv) determine the collision risk of the own vehicle with the one or more obstacles using an alternative collision determination method different from a collision determination threshold based on the left- and right-side collision boundary lines.

### [Technological Concept A3-20]

The technological concept A3-20 depends from any one of the technological concepts A3-11 to A3-19. Specifically, the curve model according to the technological concept A3-20 is comprised of a plurality of curve models. The control program instructions according to the technological concept A3-20 cause the processor to:
(i) generate, based on the plurality of curve models, a plurality of sections of the evacuation route, respectively; and
(ii) perform fitting of a plurality of curve-fitting models prepared for the respective curve models into each of the first sequence of the left-side collision boundary points to accordingly generate the left-side collision boundary line and the second sequence of the right-side collision boundary points to accordingly generate the right-side collision boundary line.

### [Technological Concept B1-1]

The technological concept B1-1 provides an apparatus (2) for controlling an own vehicle (V) traveling on a road. The apparatus includes a recognizing unit (2401) configured to recognize at least one road marking line (B431) and at least a closer edge (Le) of the road located around the own vehicle. The closer edge of the road is one of edges of the road being closer to the own vehicle than the other of the edges of the road is. The apparatus includes a detecting unit (2402) configured to detect, based on the at least one road marking line and the closer edge of the road, an evacuation space at a location of the road where the own vehicle is parkable in an extending direction of the road. The apparatus includes a first determining unit (2404) configured to determine a level of reliability that is a likelihood of an actual existence of the evacuation space. The apparatus includes a second determining unit is configured to determine whether to perform limp-home control that causes the own vehicle to travel from a current location of the own vehicle to the evacuation space in accordance with the determined level of reliability.

### [Technological Concept B1-2]

The technological concept B1-2 depends from the technological concept B1-1. Specifically, the first determining unit according to the technological concept B1-2 is configured to determine the level of reliability in accordance with at least one of (i) information on the recognized closer edge of the road, (ii) an amount of correction of at least one of a location and a size of the evacuation space if at least one of the location and the size of the evacuation space is corrected, and (iii) a distance of the own vehicle to the evacuation space.

### [Technological Concept B1-3]

The technological concept B1-3 depends from the technological concept B1-1 or B1-2. Specifically, the detecting unit according to the technological concept B1-3 is configured to detect, based on the at least one road marking line and the closer edge of the road, at least first and second evacuation spaces as the evacuation space at respective first and second locations of the road in the extending direction of the road. The first determining unit is configured to determine whether a detection result of the first evacuation space is reliable. The second determining unit is configured to determine not to perform the limp-home control upon determination that the detection result of the first evacuation space is not reliable. The second determining unit is configured to determine to perform modified limp-home control that causes the own vehicle to travel from the current location of the own vehicle to the second evacuation space upon determination that the detection result of the first evacuation space is not reliable.

### [Technological Concept B1-4]

The technological concept B1-4 depends from the technological concept B1-3. Specifically, the detecting unit according to the technological concept B1-4 is configured to detect the at least first and second evacuation spaces as the evacuation space at the respective first and second locations of the road in the extending direction of the road when determining that an emergency parking zone (EZ) is located in a traveling course of the own vehicle in the road.

### [Technological Concept B1-5]

The technological concept B1-5 depends from any one of the technological concepts B1-1 to B1-4. Specifically, the recognizing unit according to the technological concept B1-4 is configured to recognize first information on indicative of a parkable location in a shoulder (LNs) of the road and second information indicative of an existence of a blind spot from the own vehicle. The apparatus according to the technological concept A1-6 further includes a performing unit configured to perform one or more preparation operations for parking the own vehicle in the road shoulder.

### [Technological Concept B1-6]

The technological concept B1-6 depends from the technological concept B1-5. Specifically, the one or more preparation operations according to the technological concept B1-6 include offsetting the own vehicle in a width direction of the road.

### [Technological Concept B1-7]

The technological concept B1-7 depends from any one of the technological concepts B1-1 to B1-6. Specifically, the second determining unit according to the technological concept B1-7 is configured to determine to perform the limp-home control while decelerating the own vehicle upon determination that the detection result of the evacuation space is reliable.

The apparatus according to the technological concept B1-7 further includes a changing unit configured to change, during the limp-home control being performed, how to decelerate the own vehicle in accordance with change of a relative distance of the evacuation space from the own vehicle.

### [Technological Concept B1-8]

The technological concept B1-8 depends from any one of the technological concepts B1-1 to B1-7. Specifically, the second determining unit according to the technological concept B1-8 is configured to determine to perform the limp-home control in accordance with at least one control parameter upon determination that the detection result of the evacuation space is reliable. The apparatus according to the technological concept B1-8 further includes a changing unit configured to change, during the limp-home control being performed, the at least one control parameter in accordance with at least one of a speed of the own vehicle and a location of the evacuation space relative to the own vehicle.

### [Technological Concept B1-9]

The technological concept B1-9 depends from any one of the technological concepts B1 to B8. Specifically, the apparatus according to the technological concept B1-9 further includes a continuity determining unit configured to determine, after it is determined that the detection result of the evacuation space is not reliable, to continue the limp-home control that causes the own vehicle to travel from the current location of the own vehicle to the evacuation space upon determination that it is difficult to detect another evacuation space.

### [Technological Concept B1-10]

The technological concept B1-10 depends from any one of the technological concepts B1-1 to B1-9. Specifically, the apparatus according to the technological concept B1-10 further includes an evacuation route generator (2403) configured to generate, based on a predetermined curve model, an evacuation route (ER) from the current location of the own vehicle to the evacuation space. The apparatus includes a calculating unit (2501) configured to calculate a path-point sequence (PpL) comprised of a plurality of path points (Pp) along the evacuation route, and a collision boundary generator (2502, 2503).

The collision boundary generator is configured to
(i) Generate, for each path point, a pair of left- and right-side collision boundary points (Pz), each of the left-side collision boundary points being separated leftward away from the corresponding path point by a first predetermined distance, each of the right-side collision boundary points being separated rightward away from the corresponding path point by a second predetermined distance
(ii) Perform curve fitting into each of a first sequence of the left-side collision boundary points to accordingly generate a left-side collision boundary line (PzL), and a second sequence of the right-side collision boundary points to accordingly generate a right-side collision boundary line (PzL)

The apparatus includes a collision determiner (2504) configured to determine a collision risk of the own vehicle with one or more obstacles (BZ) in accordance with the left- and right-side collision boundary lines.

### [Technological Concept B1-11]

The technological concept B1-11 depends from the technological concept B1-10. Specifically, each of the first and second distances according to the technological concept B1-11 is determined based on at least one of (i) a wheel of the own vehicle, (ii) an inner wheel difference of the own vehicle, (iii) an outer wheel difference of the own vehicle, (iv) a recognition error of the recognition, and (v) a motion-control error of the own vehicle.

### [Technological Concept B1-12]

The technological concept B1-12 depends from the technological concept B1-10 or B1-11. Specifically, the calculating unit according to the technological concept B1-12 is configured to change the number of the path points in accordance with the curve model.

### [Technological Concept B1-13]

The technological concept B1-13 depends from any one of the technological concepts B1-10 to B1-12. Specifically, the calculating unit according to the technological concept B1-13 is configured to increase the number of the path points upon determination that existence information on the one or more obstacles has a lower level of certainty than a predetermined reference threshold.

### [Technological Concept B1-14]

The technological concept B1-14 depends from any one of the technological concepts B1-10 to B1-13. Specifically, the collision determiner according to the technological concept B1-14 is configured to determine whether the one or more obstacles are located within a region defined between the left- and right-side collision boundary lines to accordingly determine the collision risk of the own vehicle with the one or more obstacles.

### [Technological Concept B1-15]

The technological concept B1-15 depends from any one of the technological concepts B1-10 to B1-14. Specifically, the collision determiner according to the technological concept B1-15 is configured to determine the collision risk of the own vehicle with the one or more obstacles based on a lateral position of each of the one or more obstacles in a width direction of the road and a lateral position of one of the left- and right-side collision boundary lines.

### [Technological Concept B1-16]

The technological concept B1-16 depends from any one of the technological concepts B1-10 to B1-15. Specifically, the collision boundary generator according to the technological concept B1-16 is configured to approximate a trigonometric function representing a multiple dimensional curve model as the curve model by Taylor expansion based on parameters of the multiple dimensional curve model to accordingly calculate the left- and right side collision boundary lines. The collision boundary generator according to the technological concept B1-16 is configured to establish left and right margins located outside the respective left- and right-side collision boundary lines in accordance with first error of the approximating error and/or second error of the fitting.

### [Technological Concept B1-17]

The technological concept B1-17 depends from any one of the technological concepts B1-10 to B1-16. Specifically, the collision boundary generator according to the technological concept B1-17 is configured to establish left and right margins located outside the respective left- and right-side collision boundary lines in accordance with (i) approximation error occurring in generation of the collision boundary lines and (ii) curve-fitting error occurring in generation of the collision boundary lines.

### [Technological Concept B1-18]

The technological concept B1-18 depends from any one of the technological concepts B1-10 to B1-17. Specifically, the collision determiner according to the technological concept B1-18 is configured to:
(i) calculate a distance deviation between a position of each collision boundary point and a corresponding position of a selected one of the left- and right-side collision boundary lines;
(ii) determine whether the distance deviation for each collision boundary point and the corresponding position on the selected one of the left- and right-side collision boundary lines is greater than or equal to a predetermined distance threshold;
(iii) determine that there is large fitting error in generation of at least one of the left- and right-side collision boundary lines upon determination that the distance deviation for at least one collision boundary point is greater than or equal to the predetermined distance threshold; and
(iv) determine the collision risk of the own vehicle with the one or more obstacles using an alternative collision determination method different from a collision determination threshold based on the left- and right-side collision boundary lines.

### [Technological Concept B1-19]

The technological concept B1-19 depends from any one of the technological concepts B1-10 to B1-18. Specifically, the curve model according to the technological concept B1-19 is comprised of a plurality of curve models, and the evacuation route generator according to the technological concept B1-19 is configured to generate, based on the plurality of curve models, a plurality of sections of the evacuation route, respectively. The collision boundary generator according to the technological concept B1-19 is configured to perform fitting of a plurality of curve-fitting models prepared for the respective curve models into each of the first sequence of the left-side collision boundary points to accordingly generate the left-side collision boundary line and the second sequence of the right-side collision boundary points to accordingly generate the right-side collision boundary line.

### [Technological Concept B2-1]

The technological concept B2-1 provides a method of controlling an own vehicle (V) traveling on a road. The method includes:
(i) recognizing at least one road marking line (B431) and at least a closer edge (Le) of the road located around the own vehicle, the closer edge of the road being one of edges of the road being closer to the own vehicle than the other of the edges of the road is
(ii) detecting, based on the at least one road marking line and the closer edge of the road, an evacuation space (ES) at a location of the road where the own vehicle is parkable in an extending direction of the road
(iii) determining a level of reliability that is a likelihood of an actual existence of the evacuation space
(iv) determining whether to perform limp-home control that causes the own vehicle to travel from a current location of the own vehicle to the evacuation space in accordance with the determined level of reliability.

### [Technological Concept B2-2]

The technological concept B2-2 depends from the technological concept B2-1. Specifically, the determining a level of reliability according to the technological concept B2-2 determines the level of reliability in accordance with at least one of:
(i) information on the recognized closer edge of the road;
(ii) an amount of correction of at least one of a location and a size of the evacuation space if at least one of the location and the size of the evacuation space is corrected; and
(iii) a distance of the own vehicle to the evacuation space.

### [Technological Concept B2-3]

The technological concept B2-3 depends from any one of the technological concepts B2-1 or B2-2. Specifically, the detecting according to the technological concept B2-3 detects, based on the at least one road marking line and the closer edge of the road, at least first and second evacuation spaces as the evacuation space at respective first and second locations of the road in the extending direction of the road.

The determining whether a detection result of the evacuation space is reliable according to the technological concept B2-3 determines whether a detection result of the first evacuation space is reliable.

The determining whether to perform limp-home control according to the technological concept B2-3 determines not to perform the limp-home control upon determination that the detection result of the first evacuation space is not reliable.

The method according to the technological concept B2-3 further includes determining to perform modified limp-home control that causes the own vehicle to travel from the current location of the own vehicle to the second evacuation space upon determination that the detection result of the first evacuation space is not reliable.

### [Technological Concept B2-4]

The technological concept B2-4 depends from the technological concept B2-3. Specifically, the detecting according to the technological concept B2-4 detects the at least first and second evacuation spaces as the evacuation space at the respective first and second locations of the road in the extending direction of the road when determining that an emergency parking zone (EZ) is located in a traveling course of the own vehicle in the road.

### [Technological Concept B2-5]

The technological concept B2-5 depends from any one of the technological concepts B2-1 to B2-4. Specifically, the recognizing according to the technological concept B2-5 recognizes first information on indicative of a parkable location in a shoulder (LNs) of the road and second information indicative of an existence of a blind spot from the own vehicle.

The method according to the technological concept B2-5 further includes performing one or more preparation operations for parking the own vehicle in the road shoulder.

### [Technological Concept B2-6]

The technological concept B2-6 depends from the technological concept B2-5. Specifically, the one or more preparation operations according to the technological concept B2-6 include offsetting the own vehicle in a width direction of the road.

### [Technological Concept B2-7]

The technological concept B2-7 depends from any one of the technological concepts B2-1 to B2-6. Specifically, the determining whether to perform limp-home control according to the technological concept A1-8 determines to perform the limp-home control while decelerating the own vehicle upon determination that the detection result of the evacuation space is reliable.

The method according to the technological concept B2-7 further includes changing, during the limp-home control being performed, how to decelerate the own vehicle in accordance with change of a relative distance of the evacuation space from the own vehicle.

### [Technological Concept B2-8]

The technological concept B2-8 depends from any one of the technological concepts B2-1 to B2-7. Specifically, the determining whether to perform limp-home control according to the technological concept B2-8 determines to perform the limp-home control in accordance with at least one control parameter upon determination that the detection result of the evacuation space is reliable.

The method according to the technological concept B2-8 further includes changing, during the limp-home control being performed, the at least one control parameter in accordance with at least one of a speed of the own vehicle and a location of the evacuation space relative to the own vehicle.

### [Technological Concept B2-9]

The technological concept B2-9 depends from any one of the technological concepts B2-1 to B2-8. Specifically, the method according to the technological concept B2-9 further includes determining, after it is determined that the detection result of the evacuation space is not reliable, to continue the limp-home control that causes the own vehicle to travel from the current location of the own vehicle to the evacuation space upon determination that it is difficult to detect another evacuation space.

### [Technological Concept B2-10]

The technological concept B2-10 depends from any one of the technological concepts B2-1 to B2-9. Specifically, the method according to the technological concept B2-10 further includes:
(i) generating, based on a predetermined curve model, an evacuation route (ER) from the current location of the own vehicle to the evacuation space;
(ii) calculating a path-point sequence (PpL) comprised of a plurality of path points (Pp) along the evacuation route;
(iii) generating, for each path point, a pair of left- and right-side collision boundary points (Pz), each of the left-side collision boundary points being separated leftward away from the corresponding path point by a first predetermined distance, each of the right-side collision boundary points being separated rightward away from the corresponding path point by a second predetermined distance;
(iv) performing curve fitting into each of:
   a first sequence of the left-side collision boundary points to accordingly generate a left-side collision boundary line (PzL); and
   a second sequence of the right-side collision boundary points to accordingly generate a right-side collision boundary line (PzL); and

determining a collision risk of the own vehicle with one or more obstacles (BZ) in accordance with the left- and right-side collision boundary lines.

### [Technological Concept B2-11]

The technological concept B2-11 depends from the technological concept B2-10. Specifically, each of the first and second distances according to the technological concept B2-11 is determined based on at least one of (i) a wheel of the own vehicle, (ii) an inner wheel difference of the own vehicle, (iii) an outer wheel difference of the own vehicle, (iv) a recognition error of the recognition, and (v) a motion-control error of the own vehicle.

### [Technological Concept B2-12]

The technological concept B2-12 depends from the technological concept B2-10 or B2-11. Specifically, the calculating according to the technological concept B2-12 changes the number of the path points in accordance with the curve model.

### [Technological Concept B2-13]

The technological concept B2-13 depends from any one of the technological concepts B2-10 to B2-12. Specifically, the calculating according to the technological concept B2-13 increases the number of the path points upon determination that existence information on the one or more obstacles has a lower level of certainty than a predetermined reference threshold.

### [Technological Concept B2-14]

The technological concept B2-14 depends from any one of the technological concepts B2-10 to B2-13. Specifically, the determining a collision risk according to the technological concept B2-14 determines whether the one or more obstacles are located within a region defined between the left- and right-side collision boundary lines to accordingly determine the collision risk of the own vehicle with the one or more obstacles.

### [Technological Concept B2-15]

The technological concept B2-15 depends from any one of the technological concepts B2-10 to B2-13. Specifically, the determining a collision risk according to the technological concept B2-15 determines the collision risk of the own vehicle with the one or more obstacles based on a lateral position of each of the one or more obstacles in a width direction of the road and a lateral position of one of the left- and right-side collision boundary lines.

### [Technological Concept B2-16]

The technological concept B2-16 depends from any one of the technological concepts B2-10 to B2-15. Specifically, the performing curve fitting according to the technological concept B2-16 includes:
(i) approximating a trigonometric function representing a multiple dimensional curve model as the curve model by Taylor expansion based on parameters of the multiple dimensional curve model to accordingly calculate the left- and right side collision boundary lines; and
(ii) establishing left and right margins located outside the respective left- and right-side collision boundary lines in accordance with first error of the approximating error and/or second error of the fitting.

### [Technological Concept B2-17]

The technological concept B2-17 depends from any one of the technological concepts B2-10 to B2-16. Specifically, the determining a collision risk according to the technological concept B2-17 includes:
(i) calculating a distance deviation between a position of each collision boundary point and a corresponding position of a selected one of the left- and right-side collision boundary lines;
(ii) determining whether the distance deviation for each collision boundary point and the corresponding position on the selected one of the left- and right-side collision boundary lines is greater than or equal to a predetermined distance threshold;
(iii) determining that there is large fitting error in generation of at least one of the left- and right-side collision boundary lines upon determination that the distance deviation for at least one collision boundary point is greater than or equal to the predetermined distance threshold; and
(iv) determining the collision risk of the own vehicle with the one or more obstacles using an alternative collision determination method different from a collision determination threshold based on the left- and right-side collision boundary lines.

### [Technological Concept B2-18]

The technological concept B2-18 depends from any one of the technological concepts B2-10 to B2-17. Specifically, the determining a collision risk according to the technological concept B2-18 includes:
(i) calculating a distance deviation between a position of each collision boundary point and a corresponding position of a selected one of the left- and right-side collision boundary lines;
(ii) determining whether the distance deviation for each collision boundary point and the corresponding position on the selected one of the left- and right-side collision boundary lines is greater than or equal to a predetermined distance threshold;
(iii) determining that there is large fitting error in generation of at least one of the left- and right-side collision boundary lines upon determination that the distance deviation for at least one collision boundary point is greater than or equal to the predetermined distance threshold; and
(v) determining the collision risk of the own vehicle with the one or more obstacles using an alternative collision determination method different from a collision determination threshold based on the left- and right-side collision boundary lines.

### [Technological Concept B2-19]

The technological concept B2-19 depends from any one of the technological concepts B2-10 to B2-18. Specifically, the curve model according to the technological concept B2-19 is comprised of a plurality of curve models, and the generating an evacuation route generates, based on the plurality of curve models, a plurality of sections of the evacuation route, respectively. The performing performs fitting of a plurality of curve-fitting models prepared for the respective curve models into each of the first sequence of the left-side collision boundary points to accordingly generate the left-side collision boundary line and the second sequence of the right-side collision boundary points to accordingly generate the right-side collision boundary line.

### [Technological Concept C1-1]

The technological concept C1-1 provides an apparatus (2) for controlling an own vehicle (V) traveling on a road. The apparatus includes a stop route generator (2403) configured to generate, based on a predetermined curve model, a stop route (ER) from a current location of the own vehicle to a stop space (ES) at a location of the road where the own vehicle is parkable in an extending direction of the road. The apparatus includes a calculating unit (2501) configured to calculate a path-point sequence (PpL) comprised of a plurality of path points (Pp) along the stop route, and a collision boundary generator (2502, 2503).

The collision boundary generator is configured to
(i) Generate, for each path point, a pair of left- and right-side collision boundary points (Pz), each of the left-side collision boundary points being separated leftward away from the corresponding path point by a first predetermined distance, each of the right-side collision boundary points being separated rightward away from the corresponding path point by a second predetermined distance
(ii) Perform curve fitting into each of a first sequence of the left-side collision boundary points to accordingly generate a left-side collision boundary line (PzL), and a second sequence of the right-side collision boundary points to accordingly generate a right-side collision boundary line (PzL)

The apparatus includes a collision determiner (2504) configured to determine a collision risk of the own vehicle with one or more obstacles (BZ) in accordance with the left- and right-side collision boundary lines.

### [Technological Concept C1-2]

The technological concept C1-2 depends from the technological concept C1-1. Specifically, each of the first and second distances according to the technological concept C1-2 is determined based on at least one of (i) a wheel of the own vehicle, (ii) an inner wheel difference of the own vehicle, (iii) an outer wheel difference of the own vehicle, (iv) a recognition error of the recognition, and (v) a motion-control error of the own vehicle.

### [Technological Concept C1-3]

The technological concept C1-3 depends from the technological concept C1-1 or C1-2. Specifically, the calculating unit according to the technological concept C1-3 is configured to change the number of the path points in accordance with the curve model.

### [Technological Concept C1-4]

The technological concept C1-4 depends from any one of the technological concepts C1-1 to C1-3. Specifically, the calculating unit according to the technological concept A1-14 is configured to increase the number of the path points upon determination that existence information on the one or more obstacles has a lower level of certainty than a predetermined reference threshold.

### [Technological Concept C1-5]

The technological concept C1-5 depends from any one of the technological concepts C1-1 to C1-4. Specifically, the collision determiner according to the technological concept C1-5 is configured to determine whether the one or more obstacles are located within a region defined between the left- and right-side collision boundary lines to accordingly determine the collision risk of the own vehicle with the one or more obstacles.

### [Technological Concept C1-6]

The technological concept C1-6 depends from any one of the technological concepts C1-1 to C1-4. Specifically, the collision determiner according to the technological concept C1-6 is configured to determine the collision risk of the own vehicle with the one or more obstacles based on a lateral position of each of the one or more obstacles in a width direction of the road and a lateral position of one of the left- and right-side collision boundary lines.

### [Technological Concept C1-7]

The technological concept C1-7 depends from any one of the technological concepts C1-1 to C1-6. Specifically, the collision boundary generator according to the technological concept C1-7 is configured to approximate a trigonometric function representing a multiple dimensional curve model as the curve model by Taylor expansion based on parameters of the multiple dimensional curve model to accordingly calculate the left- and right side collision boundary lines. The collision boundary generator according to the technological concept C1-7 is configured to establish left and right margins located outside the respective left- and right-side collision boundary lines in accordance with first error of the approximating error and/or second error of the fitting.

### [Technological Concept C1-8]

The technological concept C1-8 depends from any one of the technological concepts C1-1 to C1-7. Specifically, the collision boundary generator according to the technological concept C1-8 is configured to establish left and right margins located outside the respective left- and right-side collision boundary lines in accordance with (i) approximation error occurring in generation of the collision boundary lines and (ii) curve-fitting error occurring in generation of the collision boundary lines.

### [Technological Concept C1-9]

The technological concept C1-9 depends from any one of the technological concepts C1-1 to C1-8. Specifically, the collision determiner according to the technological concept C1-9 is configured to:
(i) calculate a distance deviation between a position of each collision boundary point and a corresponding position of a selected one of the left- and right-side collision boundary lines;
(ii) determine whether the distance deviation for each collision boundary point and the corresponding position on the selected one of the left- and right-side collision boundary lines is greater than or equal to a predetermined distance threshold;
(iii) determine that there is large fitting error in generation of at least one of the left- and right-side collision boundary lines upon determination that the distance deviation for at least one collision boundary point is greater than or equal to the predetermined distance threshold; and
(iv) determine the collision risk of the own vehicle with the one or more obstacles using an alternative collision determination method different from a collision determination threshold based on the left- and right-side collision boundary lines.

### [Technological Concept C1-10]

The technological concept C1-10 depends from any one of the technological concepts C1-1 to C1-9. Specifically, the curve model according to the technological concept C1-10 is comprised of a plurality of curve models, and the stop route generator according to the technological concept C1-10 is configured to generate, based on the plurality of curve models, a plurality of sections of the stop route, respectively. The collision boundary generator according to the technological concept C1-10 is configured to perform fitting of a plurality of curve-fitting models prepared for the respective curve models into each of the first sequence of the left-side collision boundary points to accordingly generate the left-side collision boundary line and the second sequence of the right-side collision boundary points to accordingly generate the right-side collision boundary line.

### [Technological Concept C2-1]

The technological concept C2-1 provides a method of controlling an own vehicle (V) traveling on a road. The method includes:
(i) generating, based on a predetermined curve model, a stop route (ER) from a current location of the own vehicle to a stop space (ES) at a location of the road where the own vehicle is parkable in an extending direction of the road;
(ii) calculating a path-point sequence (PpL) comprised of a plurality of path points (Pp) along the stop route;
(iii) generating, for each path point, a pair of left- and right-side collision boundary points (Pz), each of the left-side collision boundary points being separated leftward away from the corresponding path point by a first predetermined distance, each of the right-side collision boundary points being separated rightward away from the corresponding path point by a second predetermined distance;
(iv) performing curve fitting into each of:
   a first sequence of the left-side collision boundary points to accordingly generate a left-side collision boundary line (PzL); and
   a second sequence of the right-side collision boundary points to accordingly generate a right-side collision boundary line (PzL); and

determining a collision risk of the own vehicle with one or more obstacles (BZ) in accordance with the left- and right-side collision boundary lines.

### [Technological Concept C2-2]

The technological concept C2-2 depends from the technological concept C2-1. Specifically, each of the first and second distances according to the technological concept C2-2 is determined based on at least one of (i) a wheel of the own vehicle, (ii) an inner wheel difference of the own vehicle, (iii) an outer wheel difference of the own vehicle, (iv) a recognition error of the recognition, and (v) a motion-control error of the own vehicle.

### [Technological Concept C2-3]

The technological concept C2-3 depends from the technological concept C2-1 or C2-2. Specifically, the calculating according to the technological concept C2-3 changes the number of the path points in accordance with the curve model.

### [Technological Concept C2-4]

The technological concept C2-4 depends from any one of the technological concepts C2-1 to C2-3. Specifically, the calculating according to the technological concept C2-4 increases the number of the path points upon determination that existence information on the one or more obstacles has a lower level of certainty than a predetermined reference threshold.

### [Technological Concept C2-5]

The technological concept C2-5 depends from any one of the technological concepts C2-1 to C2-4. Specifically, the determining a collision risk according to the technological concept C2-5 determines whether the one or more obstacles are located within a region defined between the left- and right-side collision boundary lines to accordingly determine the collision risk of the own vehicle with the one or more obstacles.

### [Technological Concept C2-6]

The technological concept C2-6 depends from any one of the technological concepts C2-1 to C2-4. Specifically, the determining a collision risk according to the technological concept C2-6 determines the collision risk of the own vehicle with the one or more obstacles based on a lateral position of each of the one or more obstacles in a width direction of the road and a lateral position of one of the left- and right-side collision boundary lines.

### [Technological Concept C2-7]

The technological concept C2-7 depends from any one of the technological concepts C2-1 to C2-6. Specifically, the performing curve fitting according to the technological concept C2-7 includes:
(i) approximating a trigonometric function representing a multiple dimensional curve model as the curve model by Taylor expansion based on parameters of the multiple dimensional curve model to accordingly calculate the left- and right side collision boundary lines; and
(ii) establishing left and right margins located outside the respective left- and right-side collision boundary lines in accordance with first error of the approximating error and/or second error of the fitting.

### [Technological Concept C2-8]

The technological concept C2-8 depends from any one of the technological concepts C2-1 to C2-7. Specifically, the determining a collision risk according to the technological concept C2-8 includes:
(i) calculating a distance deviation between a position of each collision boundary point and a corresponding position of a selected one of the left- and right-side collision boundary lines;
(ii) determining whether the distance deviation for each collision boundary point and the corresponding position on the selected one of the left- and right-side collision boundary lines is greater than or equal to a predetermined distance threshold;
(iii) determining that there is large fitting error in generation of at least one of the left- and right-side collision boundary lines upon determination that the distance deviation for at least one collision boundary point is greater than or equal to the predetermined distance threshold; and
(iv) determining the collision risk of the own vehicle with the one or more obstacles using an alternative collision determination method different from a collision determination threshold based on the left- and right-side collision boundary lines.

### [Technological Concept C2-9]

The technological concept C2-9 depends from any one of the technological concepts C2-1 to C2-8. Specifically, the determining a collision risk according to the technological concept C2-9 includes:
(i) calculating a distance deviation between a position of each collision boundary point and a corresponding position of a selected one of the left- and right-side collision boundary lines;
(ii) determining whether the distance deviation for each collision boundary point and the corresponding position on the selected one of the left- and right-side collision boundary lines is greater than or equal to a predetermined distance threshold;
(iii) determining that there is large fitting error in generation of at least one of the left- and right-side collision boundary lines upon determination that the distance deviation for at least one collision boundary point is greater than or equal to the predetermined distance threshold; and
(v) determining the collision risk of the own vehicle with the one or more obstacles using an alternative collision determination method different from a collision determination threshold based on the left- and right-side collision boundary lines.

### [Technological Concept C2-10]

The technological concept C2-10 depends from any one of the technological concepts C2-1 to C2-9. Specifically, the curve model according to the technological concept C2-10 is comprised of a plurality of curve models, and the generating a stop route generates, based on the plurality of curve models, a plurality of sections of the stop route, respectively. The performing performs fitting of a plurality of curve-fitting models prepared for the respective curve models into each of the first sequence of the left-side collision boundary points to accordingly generate the left-side collision boundary line and the second sequence of the right-side collision boundary points to accordingly generate the right-side collision boundary line.

1. A method of controlling an own vehicle traveling on a road, the method comprising:
recognizing at least one road marking line and at least a closer edge of the road located around the own vehicle, the closer edge of the road being one of edges of the road being closer to the own vehicle than the other of the edges of the road is;
detecting, based on the at least one road marking line and the closer edge of the road, an evacuation space at a location of the road where the own vehicle is parkable in an extending direction of the road;
determining whether a detection result of the evacuation space is reliable; and
determining whether to perform limp-home control that causes the own vehicle to travel from a current location of the own vehicle to the evacuation space in response to determination of whether the detection result of the evacuation space is reliable.

2. The method according to claim 1, wherein:
the determining whether to perform limp-home control determines not to perform the limp-home control in response to determination that the detection result of the evacuation space is not reliable, and determines to perform the limp-home control in response to determination that the detection result of the evacuation space is reliable.

3. The method according to claim 1, wherein:
the determining whether a detection result of the evacuation space is reliable comprises determining a level of reliability for the detection result of the evacuation space, the level of reliability being a likelihood of an actual existence of the evacuation space; and
the determining whether to perform limp-home control determines whether to perform the limp-home control in accordance with the determined level of reliability.

4. The method according to claim 3, wherein:
the determining a level of reliability determines the level of reliability in accordance with at least one of:
(i) information on the recognized closer edge of the road;
(ii) an amount of correction of at least one of a location and a size of the evacuation space if at least one of the location and the size of the evacuation space is corrected; and
(iii) a distance of the own vehicle to the evacuation space.

5. The method according to claim 1, wherein:
the detecting detects, based on the at least one road marking line and the closer edge of the road, at least first and second evacuation spaces as the evacuation space at respective first and second locations of the road in the extending direction of the road;
the determining whether a detection result of the evacuation space is reliable determines whether a detection result of the first evacuation space is reliable; and
the determining whether to perform limp-home control determines not to perform the limp-home control upon determination that the detection result of the first evacuation space is not reliable,
the method further comprising:
determining to perform modified limp-home control that causes the own vehicle to travel from the current location of the own vehicle to the second evacuation space upon determination that the detection result of the first evacuation space is not reliable.

6. The method according to claim 5, wherein:
the detecting detects the at least first and second evacuation spaces as the evacuation space at the respective first and second locations of the road in the extending direction of the road when determining that an emergency parking zone is located in a traveling course of the own vehicle in the road.

7. The method according to claim 1, wherein:
the recognizing recognizes first information on indicative of a parkable location in a shoulder of the road and second information indicative of an existence of a blind spot from the own vehicle, the method further comprising:
performing one or more preparation operations for parking the own vehicle in the road shoulder.

8. The method according to claim 7, wherein:
the one or more preparation operations include offsetting the own vehicle in a width direction of the road.

9. The method according to claim 1, wherein:
the determining whether to perform limp-home control determines to perform the limp-home control while decelerating the own vehicle upon determination that the detection result of the evacuation space is reliable,
the method further comprising:
changing, during the limp-home control being performed, how to decelerate the own vehicle in accordance with change of a relative distance of the evacuation space from the own vehicle.

10. The method according to claim 1, wherein:
the determining whether to perform limp-home control determines to perform the limp-home control in accordance with at least one control parameter upon determination that the detection result of the evacuation space is reliable,
the method further comprising:
changing, during the limp-home control being performed, the at least one control parameter in accordance with at least one of a speed of the own vehicle and a location of the evacuation space relative to the own vehicle.

11. The method according to claim 1, further comprising:
determining, after it is determined that the detection result of the evacuation space is not reliable, to continue the limp-home control that causes the own vehicle to travel from the current location of the own vehicle to the evacuation space upon determination that it is difficult to detect another evacuation space.

12. The method according to claim 1, further comprising:
generating, based on a predetermined curve model, an evacuation route from the current location of the own vehicle to the evacuation space;
calculating a path-point sequence comprised of a plurality of path points along the evacuation route;
generating, for each path point, a pair of left- and right-side collision boundary points, each of the left-side collision boundary points being separated leftward away from the corresponding path point by a first predetermined distance, each of the right-side collision boundary points being separated rightward away from the corresponding path point by a second predetermined distance;
performing curve fitting into each of:
a first sequence of the left-side collision boundary points to accordingly generate a left-side collision boundary line; and
a second sequence of the right-side collision boundary points to accordingly generate a right-side collision boundary line; and
determining a collision risk of the own vehicle with one or more obstacles in accordance with the left- and right-side collision boundary lines.

13. The method according to claim 12, wherein:
each of the first and second distances is determined based on at least one of (i) a wheel of the own vehicle, (ii) an inner wheel difference of the own vehicle, (iii) an outer wheel difference of the own vehicle, (iv) a recognition error of the recognition, and (v) a motion-control error of the own vehicle.

14. The method according to claim 12, wherein:
the calculating increases the number of the path points upon determination that existence information on the one or more obstacles has a lower level of certainty than a predetermined reference threshold.

15. The method according to claim 12, wherein:
the determining a collision risk determines whether the one or more obstacles are located within a region defined between the left- and right-side collision boundary lines to accordingly determine the collision risk of the own vehicle with the one or more obstacles.

16. The method according to claim 12, wherein:
the determining a collision risk determines the collision risk of the own vehicle with the one or more obstacles based on a lateral position of each of the one or more obstacles in a width direction of the road and a lateral position of one of the left- and right-side collision boundary lines.

17. The method according to claim 12, wherein:
the performing curve fitting comprises:
approximating a trigonometric function representing a multiple dimensional curve model as the curve model by Taylor expansion based on parameters of the multiple dimensional curve model to accordingly calculate the left- and right side collision boundary lines; and
establishing left and right margins located outside the respective left- and right-side collision boundary lines in accordance with first error of the approximating error and/or second error of the fitting.

18. The method according to claim 12, wherein:
the determining a collision risk comprises:
calculating a distance deviation between a position of each collision boundary point and a corresponding position of a selected one of the left- and right-side collision boundary lines;
determining whether the distance deviation for each collision boundary point and the corresponding position on the selected one of the left- and right-side collision boundary lines is greater than or equal to a predetermined distance threshold;
determining that there is large fitting error in generation of at least one of the left- and right-side collision boundary lines upon determination that the distance deviation for at least one collision boundary point is greater than or equal to the predetermined distance threshold; and
determining the collision risk of the own vehicle with the one or more obstacles using an alternative collision determination method different from a collision determination threshold based on the left- and right-side collision boundary lines.

19. A processor program product including a non-transitory storage medium readable by a processor for controlling a vehicle traveling on a road, and control program instructions stored in the non-transitory storage medium,
the control program instructions cause the processor to:
recognize at least one road marking line and at least a closer edge of the road located around the own vehicle, the closer edge of the road being one of edges of the road being closer to the own vehicle than the other of the edges of the road is;
detect, based on the at least one road marking line and the closer edge of the road, an evacuation space at a location of the road where the own vehicle is parkable in an extending direction of the road;
determine whether a detection result of the evacuation space is reliable; and
determine whether to perform limp-home control that causes the own vehicle to travel from a current location of the own vehicle to the evacuation space in response to determination of whether the detection result of the evacuation space is reliable.

20. An apparatus for controlling a vehicle traveling on a road, the apparatus comprising:
a recognizing unit configured to recognize at least one road marking line and at least a closer edge of the road located around the own vehicle, the closer edge of the road being one of edges of the road being closer to the own vehicle than the other of the edges of the road is;
a detecting unit configured to detect, based on the at least one road marking line and the closer edge of the road, an evacuation space at a location of the road where the own vehicle is parkable in an extending direction of the road;
a first determining unit configured to determine whether a detection result of the evacuation space is reliable; and
a second determining unit configured to determine whether to perform limp-home control that causes the own vehicle to travel from a current location of the own vehicle to the evacuation space in response to determination of whether the detection result of the evacuation space is reliable.
